(19) United States
(12) Patent Application Publication
(10) Pub. No.: US 2005/0151994 A1
(43) Pub. Date: Jul. 14, 2005

(54) Print system, print request appatatus, print-equipment management apparatus, print equipment, print-equipment management program as well as print control program, and print method

(76) Inventor: Toru Takahashi, Matsumoto-shi (JP)

Correspondence Address: HARNESS, DICKEY & PIERCE, P.L.C., P.O. BOX 828, BLOOMFIELD HILLS, MI, 48303, US

(21) Appl. No.: 10/999,366

(22) Filed: Nov. 29, 2004

(30) Foreign Application Priority Data
Nov. 28, 2003 (JP) 2003-400025
Aug. 13, 2004 (JP) 2004-235901

(51) Int. Cl. G06F 15/00

(52) U.S. Cl. 358/1.15; 358/1.16

(57) ABSTRACT

A print system is provided in which, even when a plurality of print requests exist simultaneously, printings for the respective print requests are efficiently performed. A host terminal stores therein reconfigurable data for use in the configuration of a circuit which realizes a print data processing function specialized for the data processing of intermediate print data generated by the host terminal itself, and it transmits the reconfigurable data and the intermediate print data to a printer. The printer includes a hardware circuit having a rewritable hardware region, and when the printer has received the reconfigurable data and the intermediate print data, it reconfigures the hardware region based on the received reconfigurable data, and thereafter, it converts the received intermediate print data into print data so as to perform printing based on the generated print data.

### RELATED APPLICATIONS

This application claims priority to Japanese Patent Application Nos. 2003-400025 filed Nov. 28, 2003 and 2004-235901 filed Aug. 13, 2004 which are hereby expressly incorporated by reference herein in their entirety.

### BACKGROUND

1. Technical Field

The present invention relates to a system, an apparatus as well as a program, and a method in which printing is done by dynamically altering the hardware functions of print equipment, and more particularly to a print system, a print request apparatus, a print-equipment management apparatus, print equipment, a print-equipment management program as well as a print control program, and a print method in which, even when a plurality of print requests exist simultaneously, printings for the respective print requests are efficiently performed, and a memory load is relieved, and which are well suited to make a circuit scale smaller.

2. Related Art

Heretofore, techniques which dynamically alter the functions of devices have been, for example, a print system disclosed in JP-A-2001-306285, an information processing system disclosed in JP-A-2000-138288, an image processing apparatus disclosed in JP-A-2003-150949, and a hardware function varying device disclosed in “Hardware technology which is as ‘soft’ as software”.

In the invention stated in JP-A-2001-306285, a host terminal holds a plurality of programs runnable on a printer. Before starting printing, the host terminal examines resources available thereto and resources available to the printer, and it judges an optimal load distribution with the printer in the resource environment of the entire system in which the resources of both the host terminal and the printer are comprehended. Thereafter, the host terminal downloads the program necessary for the printer, in accordance with the result of the judgment.

In the invention stated in JP-A-2000-138288, the information items of a plurality of circuits to be configured in a programmable logic circuit are stored in a storage unit. An acquisition unit stores therein the information of the circuits configured in the programmable logic circuit. Also, upon accepting a notification for renewing any circuit, from a circuit information renewal unit through an edit unit, the acquisition unit discriminates if the new circuit is configured in the programmable logic circuit, with reference to the stored information of the circuits. When the new circuit is configured, the acquisition unit notifies this fact to a user through a notification unit. The user can instruct the acquisition unit to acquire the new circuit or not. When the acquisition of the new circuit has been requested, only the new part is reconfigured in the circuits configured in the programmable logic circuit.

In the invention stated in JP-A-2003-150949, the combination of a circuit module and a program module which are required for executing an image processing function to-be-applied is selected, the rewritable hardware region of a semiconductor device is reconfigured on the basis of rewrite information containing the information of the selected circuit module, thereby to form the circuit module, and the selected program module is run in the semiconductor device formed with the circuit module.

In the invention stated in “Hardware technology which is as ‘soft’ as software”, hardware resources on a DAP/DNA chip are used by changing-over functions in real time as in the virtual storage of a computer, whereby a device in which the DAP/DNA chip is installed realizes the functions of, for example, a scanner, a facsimile, a printer and a copying machine.

In the invention stated in JP-A-2001-306285, however, the program necessary for the printer is downloaded before printing is started, and hence, in a case where print requests have been simultaneously sent from a plurality of host terminals, printings for the respective host terminals might be processed by the program which has been downloaded from any of the host terminals. In that case, the optimal load distribution is established as to the printing for the host terminal from which the program has been downloaded, but there is the problem that inappropriate load distributions are established as to the printings for the other host terminals. Moreover, the plurality of programs runnable on the printer need to be held in the host terminal for the purpose of coping with those environments of the print equipment and the host terminal which change every moment, and hence, there is the problem that the memory capacity of the host terminal is oppressed in a case where this host terminal is a device having a small number of resources, such as portable telephone or PDA (Personal Digital Assistant).

Besides, in the invention stated in JP-A-2000-138288, the information processing system itself needs to hold the plurality of circuit information items, and hence, there is the problem that the memory capacity of the information processing system is oppressed. Moreover, in a case where the invention stated in JP-A-2000-138288 is applied to a printer, the same problems as in the invention stated in JP-A-2001-306285 occur. These problems are similarly posed in the invention stated in JP-A-2003-150949 and the invention stated in “Hardware technology which is as ‘soft’ as software”.

Further, in a case where document data are converted into print data via a plurality of print-data generation processes, a host terminal and a printer can share and generate the print data in such a way, for example, that 70% of the plurality of print-data generation processes are performed in the host terminal, while the remaining 30% of the processes are performed in the printer. The sharing proportion is not a fixed value, but an optimal value should desirably be adopted in accordance with the processability of the host terminal and that of the printer.

However, in a case where a plurality of host terminals of different processabilities utilize the single printer and where optimal sharing proportions are set for the individual host terminals, the forms of intermediate print data which are transmitted from the respective host terminals become different. In that case, when print data processing functions are to be realized by hardware in the printer, this printer must be equipped with circuits for realizing the print data processing functions capable of coping with the respective forms, resulting in the problem that a circuit scale enlarges.

Therefore, the present invention has been made in view of such unsolved problems involved in the prior art, and it has for an object to provide a print system, a print request apparatus, a print-equipment management apparatus, print equipment, a print-equipment management program as well as a print control program, and a print method in which, even when a plurality of print requests exist simultaneously, printings for the respective print requests are efficiently done, and a memory load is relieved, and which are well suited to make a circuit scale smaller.

### SUMMARY

In order to accomplish the object, a print system in Aspect 1 comprises:
a print system wherein a print request apparatus which makes a request for printing, and print equipment which performs the printing in compliance with the print request from the print request apparatus are connected in communicable fashion, so as to perform the printing, wherein:
the print request apparatus includes circuit-configuration-information transmission means for transmitting circuit configuration information for use in configuring a circuit which realizes a print data processing function, to the print equipment in accordance with the print request; and
the print equipment includes a circuit device which has a rewritable hardware region, circuit-configuration-information reception means for receiving the circuit configuration information, and hardware-region reconfiguration means for reconfiguring the hardware region on the basis of the circuit configuration information received by the circuit-configuration-information reception means.

With such a configuration, in the print request apparatus, the circuit configuration information is transmitted to the print equipment in accordance with the print request by the circuit-configuration-information transmission means.

In the print equipment, when the circuit configuration information has been received by the circuit-configuration-information reception means, the hardware region is reconfigured on the basis of the received circuit configuration information by the hardware-region reconfiguration means. The hardware region is reconfigured as the circuit which realizes the print data processing function.

Thus, the hardware region of the print equipment is reconfigured in accordance with the print request, so that print data processing relevant to the print request can be performed comparatively appropriately by the circuit device. Accordingly, there is attained the advantage that, as compared with the prior art, this invention can efficiently perform printings relevant to individual print requests, even when the plurality of print requests exist simultaneously.

Moreover, the print request apparatus may hold the circuit configuration information suited to the format of data to-be-print-processed which it transmits to the print equipment, and the print equipment need not hold the circuit configuration information. Therefore, there is attained the advantage that the memory capacities of the print request apparatus and the print equipment are not oppressed considerably, and that this invention can relieve a memory load as compared with the prior art.

Further, even when optimal sharing proportions are set for individual print request apparatuses in a case where the plurality of print request apparatuses of different processabilities utilize a single print equipment, the print equipment can cope with the different formats of data to-be-print-processed which are transmitted from the individual print request apparatuses, merely in such a way that the respective print request apparatuses hold circuit configuration information suited to the formats of the data to-be-print-processed which they transmit to the print equipment. Accordingly, there is attained the advantage that the circuit of the print equipment becomes smaller in scale than in case of providing a circuit device which realizes print data processing functions capable of coping with the respective formats.

Here, “to transmit the circuit configuration information in accordance with the print request” signifies to transmit the circuit configuration information so that, in the print equipment, the print data processing relevant to the print request may be performed by the circuit device whose hardware region has been reconfigured on the basis of the circuit configuration information. Insofar as this condition is satisfied, the circuit configuration information can be transmitted before or after the print request, simultaneously with the print request, or at a time independent of the print request. Hereinbelow, the same shall hold true of a print system in Aspect 16, a print request apparatus in Aspect 26, a print-equipment management apparatus in Aspect 39, print-equipment management programs in Aspects 57 and 70, and print methods in Aspects 88 and 103.

Further, a print system in Aspect 2 comprises a print system wherein a print request apparatus which makes a request for printing, and print equipment which performs the printing in compliance with the print request from the print request apparatus are connected in communicable fashion, so as to perform the printing, wherein:
the print request apparatus includes circuit-configuration-information storage means for storing therein circuit configuration information for use in configuring a circuit which realizes a print data processing function, circuit-configuration-information transmission means for transmitting the circuit configuration information of the circuit-configuration-information storage means to the print equipment in accordance with the print request, and data-to-be-print-processed transmission means for transmitting data to-be-print-processed to the print equipment in accordance with the print request; and
the print equipment includes a circuit device which has a rewritable hardware region, circuit-configuration-information reception means for receiving the circuit configuration information, hardware-region reconfiguration means for reconfiguring the hardware region on the basis of the circuit configuration information received by the circuit-configuration-information reception means, data-to-be-print-processed reception means for receiving the data to-be-print-processed, and print control means for performing the printing on the basis of print-processed data subjected to data processing by the circuit device.

With such a configuration, in the print request apparatus, the circuit configuration information of the circuit-configuration-information storage means is transmitted to the print equipment in accordance with the print request by the circuit-configuration-information transmission means, and the data to-be-print-processed are transmitted to the print equipment in accordance with the print request by the data-to-be-print-processed transmission means.

In the print equipment, when the circuit configuration information has been received by the circuit-configuration-information reception means, the hardware region is reconfigured on the basis of the received circuit configuration information by the hardware-region reconfiguration means. The hardware region is reconfigured as the circuit which realizes the print data processing function. Also, the data to-be-print-processed are received by the data-to-be-print-processed reception means. Here, when the reconfiguration by the hardware-region reconfiguration means is completed, the received data to-be-print-processed are subjected to the data processing by the circuit device, and the printing is done on the basis of the print-processed data subjected to the data processing, by the print control means.

Thus, after the hardware region of the print equipment has been reconfigured in accordance with the print request, the data to-be-print-processed relevant to the print request are subjected to the data processing by the circuit device, so that the print data processing relevant to the print request can be executed comparatively appropriately. Accordingly, there is attained the advantage that, as compared with the prior art, this invention can efficiently subject data to-be-print-processed relevant to individual print requests, to data processing even when the plurality of print requests exist simultaneously.

Moreover, the print request apparatus may hold the circuit configuration information suited to the format of the data to-be-print-processed which it transmits to the print equipment, and the print equipment need not hold the circuit configuration information. Therefore, there is attained the advantage that the memory capacities of the print request apparatus and the print equipment are not oppressed considerably, and that this invention can relieve a memory load as compared with the prior art.

Further, even when optimal sharing proportions are set for individual print request apparatuses in a case where the plurality of print request apparatuses of different processabilities utilize a single print equipment, the print equipment can cope with the different formats of data to-be-print-processed which are transmitted from the individual print request apparatuses, merely in such a way that the respective print request apparatuses hold circuit configuration information suited to the formats of the data to-be-print-processed which they transmit to the print equipment. Accordingly, there is attained the advantage that the circuit of the print equipment becomes smaller in scale than in case of providing a circuit device which realizes print data processing functions capable of coping with the respective formats.

Here, “to transmit the circuit configuration information and the data to-be-print-processed in accordance with the print request” signifies to transmit them so that, in the print equipment, the data to-be-print-processed may be subjected to the data processing by the circuit device whose hardware region has been reconfigured on the basis of the circuit configuration information. Insofar as this condition is satisfied, the circuit configuration information and the data to-be-print-processed can be transmitted before or after the print request, simultaneously with the print request, or at a time independent of the print request. Of course, the transmission times of the circuit configuration information and the data to-be-print-processed can be set at will. Hereinbelow, the same shall hold true of print systems in Aspects 3, 17 and 18, print request apparatuses in Aspects 27 and 37, a print-equipment management apparatus in Aspect 40, print-equipment management programs in Aspects 58, 68 and 71, and print methods in Aspects 89, 90, 104 and 105.

Besides, the data to-be-print-processed may be either document data or intermediate print data (generally called an “intermediate language”). Incidentally, the “document data” signify data which include an image, characters, graphics (vector graphics), or any other element to-be-edited. When only the image is included, the document data signify image data themselves; when only the characters are included, the document data signify text data themselves; and when only the vector graphics are included, the document data signify vector graphics data themselves. Hereinbelow, the same shall hold true of the print systems in Aspects 3, 17 and 18, the print request apparatuses in Aspects 27 and 37, the print-equipment management apparatus in Aspect 40, the print equipment in Aspects 46 and 47, the print-equipment management programs in Aspects 58, 68 and 71, print control programs in Aspects 77 and 78, and the print methods in Aspects 89, 90, 104 and 105.

Besides, the data to-be-print-processed may be subjected to the data processing by the circuit device after the reconfiguration has been performed by the hardware-region reconfiguration means, and they may be received either before or after the reconfiguration by the hardware-region reconfiguration means. Hereinbelow, the same shall hold true of the print systems in Aspects 3, 17 and 18, the print request apparatuses in Aspects 27 and 37, the print-equipment management apparatus in Aspect 40, the print equipment in Aspects 46 and 47, the print-equipment management programs in Aspects 58, 68 and 71, the print control programs in Aspects 77 and 78, and the print methods in Aspects 89, 90, 104 and 105.

Besides, considered as the data processing by the circuit device is that the data to-be-print-processed which include, for example, image data with a gradation, such as bitmap or JPEG (Joint Photographic coding Experts Group), text data, or vector graphics data are subjected to rendering, a color conversion process or a binarization process. Also included is a process for separately printing different dot sizes, or a process for making stripes unobtrusive, the stripes being principally ascribable to the deviation of the nozzles of print heads. Hereinbelow, the same shall hold true of the print systems in Aspects 3, 17 and 18, the print request apparatuses in Aspects 27 and 37, the print-equipment management apparatus in Aspect 40, the print equipment in Aspects 46 and 47, the print-equipment management programs in Aspects 58, 68 and 71, the print control programs in Aspects 77 and 78, and the print methods in Aspects 89, 90, 104 and 105.

Besides, the circuit-configuration-information storage means is means for storing the circuit configuration information by any expedient and at any time therein. It may store the circuit configuration information therein either beforehand or by external inputting or the like during the operation of the system without storing the circuit configuration information beforehand. Hereinbelow, the same shall hold true of the print systems in Aspects 3, 17 and 18, the print request apparatus in Aspect 27, and the print-equipment management apparatus in Aspect 40.

Besides, the print request apparatus may be incarnated either as the single apparatus or as a network system in which a plurality of apparatuses are connected in communicable fashion. In the latter case, as long as the constituents are connected so as to be communicable with one another, they may belong to any of the plurality of apparatuses. In a case, for example, where a print request apparatus is configured by connecting two apparatuses so as to be communicable with each other, a configuration is considered in which the circuit-configuration-information storage means is disposed in the first print request apparatus, while the circuit-configuration-information transmission means is disposed in the second print request apparatus. Hereinbelow, the same shall hold true of the print system in Aspect 3, and the print request apparatus in Aspect 27.

Further, a print system in Aspect 3 comprises a print system wherein a print request apparatus which makes a request for printing, and print equipment which performs the printing in compliance with the print request from the print request apparatus are connected in communicable fashion, so as to perform the printing, wherein:
the print request apparatus includes circuit-configuration-information storage means for storing therein circuit configuration information for use in configuring a circuit which realizes a print data processing function, circuit-configuration-information transmission means for transmitting the circuit configuration information of the circuit-configuration-information storage means to the print equipment in accordance with the print request, and data-to-be-print-processed transmission means for transmitting data to-be-print-processed to the print equipment in accordance with the print request;
the print equipment includes a circuit device which has a rewritable hardware region, circuit-configuration-information reception means for receiving the circuit configuration information, hardware-region reconfiguration means for reconfiguring the hardware region on the basis of the circuit configuration information received by the circuit-configuration-information reception means, data-to-be-print-processed reception means for receiving the data to-be-print-processed, and print control means for performing the printing on the basis of print-processed data subjected to data processing by the circuit device; and
the print control means subjects the data to-be-print-processed received by the data-to-be-print-processed reception means, to the data processing by the circuit device after the reconfiguration by the hardware-region reconfiguration means has been performed.

With such a configuration, an operation and advantages equivalent to those of the print system in Aspect 2 are attained.

Further, a print system in Aspect 4 comprises the print system in either of Aspects 2 and 3, wherein:
the hardware-region reconfiguration means transmits a predetermined notification to the print request apparatus when the reconfiguration of the hardware region has been completed; and
the data-to-be-print-processed transmission means transmits the data to-be-print-processed to the print equipment when the predetermined notification has been received.

With such a configuration, in the print equipment, when the reconfiguration of the hardware region has been completed, the predetermined notification is transmitted to the print request apparatus by the hardware-region reconfiguration means.

In the print request apparatus, when the predetermined notification has been received, the data to-be-print-processed are transmitted to the print equipment by the data-to-be-print-processed transmission means.

Thus, the data to-be-print-processed are subjected to the data processing by the circuit device after waiting for the completion of the reconfiguration of the hardware region, and hence, there is attained the advantage that the print data processing relevant to the print request can be executed comparatively reliably.

Further, a print system in Aspect 5 comprises the print system in either of Aspects 2 and 3, wherein:
the print equipment further includes data-to-be-print-processed holding means for holding therein the data to-be-print-processed received by the data-to-be-print-processed reception means, and that it subjects the data to-be-print-processed held in the data-to-be-print-processed holding means, to the data processing by the circuit device when the reconfiguration by the hardware-region reconfiguration means has been completed.

With such a configuration, in the print equipment, the received data to-be-print-processed are held by the data-to-be-print-processed holding means. Besides, when the reconfiguration of the hardware region has been completed, the held data to-be-print-processed are subjected to the data processing by the circuit device, and the printing is performed on the basis of the print-processed data subjected to the data processing, by the print control means.

Thus, the data to-be-print-processed are subjected to the data processing by the circuit device after waiting for the completion of the reconfiguration of the hardware region, and hence, there is attained the advantage that the print data processing relevant to the print request can be executed comparatively reliably.

Further, a print system in Aspect 6 comprises the print system in any of Aspects 2 through 5, wherein:
the circuit-configuration-information transmission means transmits the circuit configuration information of the circuit-configuration-information storage means to the print equipment when a request for printing has been inputted by an input interface.

With such a configuration, in the print request apparatus, when the request for printing has been inputted by the input interface, the circuit configuration information of the circuit-configuration-information storage means is transmitted to the print equipment by the circuit-configuration-information transmission means.

Thus, the hardware region of the print equipment is reconfigured at a time at which a user has made the request for printing, and hence, there is attained the advantage that data to-be-print-processed relevant to individual print requests can be efficiently subjected to data processing even when the plurality of print requests exist simultaneously.

Further, a print system in Aspect 7 comprises the print system in any of Aspects 2 through 5, wherein:
the circuit-configuration-information transmission means transmits the circuit configuration information of the circuit-configuration-information storage means to the print equipment when settings concerning printing have been performed by an input interface.

With such a configuration, in the print request apparatus, when the settings concerning printing have been performed by the input interface, the circuit configuration information of the circuit-configuration-information storage means is transmitted to the print equipment by the circuit-configuration-information transmission means.

Thus, the hardware region of the print equipment is reconfigured at a time at which a user has performed the settings concerning printing, and hence, there is attained the advantage that data to-be-print-processed relevant to individual print requests can be efficiently subjected to data processing even when the plurality of print requests exist simultaneously.

Further, a print system in Aspect 8 comprises the print system in any of Aspects 2 through 7, wherein:
the circuit configuration information contains information for use in configuring a circuit which realizes a print data processing function specialized for subjecting the data to-be-print-processed to data processing.

With such a configuration, in the print equipment, when the circuit configuration information has been received by the circuit-configuration-information reception means, the hardware region is reconfigured on the basis of the received circuit configuration information by the hardware-region reconfiguration means. The hardware region is reconfigured as the circuit which realizes the print data processing function which is specialized for subjecting the data to-be-print-processed to the data processing.

Thus, the data to-be-print-processed are subjected to the print data processing specialized therefore, and hence, there is attained the advantage that the print data processing relevant to the print request can be performed more appropriately.

Here, the “print data processing function specialized for the data processing” signifies a print data processing function which is suited to the image sort, resolution or print settings of the data to-be-print-processed. Hereinbelow, the same shall hold true of a print system in Aspect 23, a print request apparatus in Aspect 30, a print-equipment management apparatus in Aspect 42, print equipment in Aspect 50, print-equipment management programs in Aspects 61 and 73, a print control program in Aspect 81, and print methods in Aspects 95 and 110.

Further, a print system in Aspect 9 comprises the print system in any of Aspects 2 through 7, wherein:
the circuit configuration information contains information for use in configuring a circuit which realizes a print data processing function that sets a degree of parallelism in a case where a plurality of sets of such data to-be-print-processed are subjected to data processing in parallel, or where parallel-processable parts of a single set of such data to-be-print-processed are subjected to data processing in parallel.

With such a configuration, in the print equipment, when the circuit configuration information has been received by the circuit-configuration-information reception means, the hardware region is reconfigured on the basis of the received circuit configuration information by the hardware-region reconfiguration means. The hardware region is reconfigured as the circuit which realizes the print data processing function that sets the degree of parallelism in the case where the plurality of sets of data to-be-print-processed are subjected to the data processing in parallel, or where the parallel-processable parts of the single set of data to-be-print-processed are subjected to the data processing in parallel.

Thus, the degree of parallelism of the print equipment can be adjusted in the print request apparatus, and hence, there is attained the advantage that the data to-be-print-processed can be subjected to the data processing more efficiently.

Further, a print system in Aspect 10 comprises the print system in Aspect 9, wherein:
the print request apparatus further includes status-information acquisition means for acquiring status information which indicates a scale of the hardware region, and circuit-configuration-information updating means for setting the degree of parallelism of the circuit configuration information on the basis of the status information acquired by the status-information acquisition means; and
the circuit-configuration-information transmission means transmits the circuit configuration information updated by the circuit-configuration-information updating means, to the print equipment.

With such a configuration, in the print request apparatus, the status information indicating the scale of the hardware region is acquired by the status-information acquisition means, and the degree of parallelism of the circuit configuration information is set on the basis of the acquired status information by the circuit-configuration-information updating means. Besides, the updated circuit configuration information is transmitted to the print equipment by the circuit-configuration-information transmission means.

Thus, the degree of parallelism is set in accordance with the scale of the hardware region of the print equipment, and hence, there is attained the advantage that the data to-be-print-processed can be subjected to the data processing more efficiently.

Here, the status-information acquisition means may have any configuration as long as it is adapted to acquire the status information. By way of example, it may calculate, detect or estimate the status information or may well acquire the status information from the print request apparatus, the print equipment or any other device. Hereinbelow, the same shall hold true of a print system in Aspect 12, and print request apparatuses in Aspects 32 and 34.

Further, a print system in Aspect 11 comprises the print system in any of Aspects 2 through 7, wherein:
the circuit configuration information contains information for use in configuring a circuit which realizes a print data processing function that is to be borne by the print equipment in a case where the print equipment and another device share the data processing of the data to-be-print-processed.

With such a configuration, in the print equipment, when the circuit configuration information has been received by the circuit-configuration-information reception means, the hardware region is reconfigured on the basis of the received circuit configuration information by the hardware-region reconfiguration means. The hardware region is reconfigured as the circuit which realizes the print data processing function that is to be borne by the print equipment in the case where the print equipment and the other device share the data processing of the data to-be-print-processed.

Thus, the print data processing function suited to the sharing proportion of the print equipment can be configured in the print request apparatus, and hence, there is attained the advantage that the data to-be-print-processed can be subjected to the data processing more efficiently.

Here, as the “other device”, it is possible to utilize the print request apparatus, another print equipment or any other device. Hereinbelow, the same shall hold true of a print request apparatus in Aspect 33, print equipment in Aspect 52, a print-equipment management program in Aspect 64, a print control program in Aspect 83, and a print method in Aspect 98.

Further, a print system in Aspect 12 comprises the print system in Aspect 11, wherein:
the print request apparatus further includes status-information acquisition means for acquiring status information which indicates a processing load of the print equipment, and status information which indicates a processing load of the other device, and circuit-configuration-information updating means for updating the circuit configuration information on the basis of the status information items acquired by the status-information acquisition means; and
the circuit-configuration-information transmission means transmits the circuit configuration information updated by the circuit-configuration-information updating means, to the print equipment.

With such a configuration, in the print request apparatus, the status information indicating the processing load of the print equipment, and the status information indicating the processing load of the other device are acquired by the status-information acquisition means, and the circuit configuration information is updated on the basis of the acquired status information items by the circuit-configuration-information updating means. Besides, the updated circuit configuration information is transmitted to the print equipment by the circuit-configuration-information transmission means.

Thus, the print data processing functions are configured in accordance with the processing loads of the print equipment and the other device, and hence, there is attained the advantage that the data to-be-print-processed can be subjected to the data processing more efficiently.

Further, a print system in Aspect 13 comprises the print system in any of Aspects 2 through 12, wherein:
the print request apparatus further includes transmission-history-information registration means for registering transmission history information which indicates a transmission history of the circuit configuration information transmitted to the print equipment, in transmission-history-information storage means;
the circuit-configuration-information transmission means transmits a reconfiguration instruction containing identification information of the corresponding circuit configuration information, to the print equipment when the print request apparatus has decided that the same circuit configuration information as that to be transmitted to the print equipment has already been transmitted to the print equipment, on the basis of the transmission history information of the transmission-history-information storage means;
the print equipment further includes circuit-configuration-information registration means for registering the circuit configuration information received by the circuit-configuration-information reception means, in second circuit-configuration-information storage means, reconfiguration-instruction reception means for receiving the reconfiguration instruction, and circuit-configuration-information search means for searching the second circuit-configuration-information storage means for the corresponding circuit configuration information on the basis of the identification information which is contained in the reconfiguration instruction received by the reconfiguration-instruction reception means; and
the hardware-region reconfiguration means reconfigures the hardware region on the basis of the circuit configuration information received by the circuit-configuration-information reception means, or the circuit configuration information searched out by the circuit-configuration-information search means.

With such a configuration, in the print request apparatus, when the circuit configuration information has been transmitted, the transmission history information is registered in the transmission-history-information storage means by the transmission-history-information registration means. Besides, when it has been decided on the basis of the transmission history information of the transmission-history-information storage means that the same circuit configuration information as that to be transmitted to the print equipment has already been transmitted to the print equipment, the reconfiguration instruction which contains the identification information of the corresponding circuit configuration information is transmitted to the print equipment by the circuit-configuration-information transmission means.

In the print equipment, when the circuit configuration information has been received by the circuit-configuration-information reception means, the received circuit configuration information is registered in the second circuit-configuration-information storage means by the circuit-configuration-information registration means. Besides, when the reconfiguration instruction has been received by the reconfiguration-instruction reception means, the second circuit-configuration-information storage means is searched for the corresponding circuit configuration information on the basis of the identification information contained in the received reconfiguration instruction, by the circuit-configuration-information search means. When the corresponding circuit configuration information has been searched out as the result, the hardware region is reconfigured on the basis of the searched-out circuit configuration information by the hardware-region reconfiguration means.

Thus, in the print request apparatus, the same circuit configuration information is not repeatedly transmitted to the print equipment, and hence, there is attained the advantage that the communication traffic between the print request apparatus and the print equipment can be reduced. Besides, in the print equipment, in the case where the reconfiguration instruction has been received, the hardware region is reconfigured on the basis of the circuit configuration information of the second circuit-configuration-information storage means, and hence, there is attained the advantage that the data processing of the data to-be-print-processed can be quickly started, and that a first printout time period can be shortened.

Here, the “same circuit configuration information” includes, not only perfectly the same circuit configuration information, but also circuit configuration information which has different data contents, but which produces the same processed result. Hereinbelow, the same shall hold true of a print system in Aspect 14, print request apparatuses in Aspects 35 and 36, the print equipment in Aspects 53 and 54, print-equipment management programs in Aspects 66 and 67, print control programs in Aspects 84 and 85, and print methods in Aspects 100 and 101.

Besides, the “reconfiguration instruction” signifies an instruction which has identification information identifying circuit configuration information, as an argument. More specifically, the instruction indicates which of circuit configuration information items is used for reconfiguring a circuit. In a case where a circuit a configured by circuit configuration information a transmitted to the print equipment has been reconfigured to another circuit b by other circuit configuration information b, the instruction serves to reconfigure the circuit a without transmitting the circuit configuration information a again from the print request apparatus. Hereinbelow, the same shall hold true of the print system in Aspect 14, print request apparatuses in Aspects 35 and 36, the print equipment in Aspects 53 and 54, print-equipment management programs in Aspects 66 and 67, print control programs in Aspects 84 and 85, and print methods in Aspects 100 and 101.

Further, a print system in Aspect 14 comprises the print system in any of Aspects 2 through 12, wherein:
the print request apparatus further includes circuit-configuration-information inquiry means for inquiring of the print equipment about the circuit configuration information which the print equipment holds;
the circuit-configuration-information transmission means transmits a reconfiguration instruction containing identification information of the corresponding circuit configuration information, to the print equipment when the print request apparatus has decided that the same circuit configuration information as that to be transmitted to the print equipment has already been transmitted to the print equipment, on the basis of a result of the inquiry of the circuit-configuration-information inquiry means;
the print equipment further includes circuit-configuration-information registration means for registering the circuit configuration information received by the circuit-configuration-information reception means, in second circuit-configuration-information storage means, reconfiguration-instruction reception means for receiving the reconfiguration instruction, circuit-configuration-information search means for searching the second circuit-configuration-information storage means for the corresponding circuit configuration information on the basis of the identification information which is contained in the reconfiguration instruction received by the reconfiguration-instruction reception means, and circuit-configuration-information reply means for replying presence or absence of the circuit configuration information to the inquiry from the print request apparatus, on the basis of registered contents of the second circuit-configuration-information storage means; and
the hardware-region reconfiguration means reconfigures the hardware region on the basis of the circuit configuration information received by the circuit-configuration-information reception means, or the circuit configuration information searched out by the circuit-configuration-information search means.

With such a configuration, in the print request apparatus, the inquiry is made of the print equipment about the circuit configuration information which the print equipment holds, by the circuit-configuration-information inquiry means.

In the print equipment, when the inquiry from the print request apparatus has been received, the presence or absence of the circuit configuration information is replied to the inquiry on the basis of the registered contents of the second circuit-configuration-information storage means by the circuit-configuration-information reply means.

In the print request apparatus, when it has been decided on the basis of the result of the inquiry of the circuit-configuration-information inquiry means that the same circuit configuration information as that to be transmitted to the print equipment has already been transmitted to the print equipment, the reconfiguration instruction which contains the identification information of the corresponding circuit configuration information is transmitted to the print equipment by the circuit-configuration-information transmission means.

In the print equipment, when the circuit configuration information has been received by the circuit-configuration-information reception means, the received circuit configuration information is registered in the second circuit-configuration-information storage means by the circuit-configuration-information registration means. Besides, when the reconfiguration instruction has been received by the reconfiguration-instruction reception means, the second circuit-configuration-information storage means is searched for the corresponding circuit configuration information on the basis of the identification information contained in the received reconfiguration instruction, by the circuit-configuration-information search means. When the corresponding circuit configuration information has been searched out as the result, the hardware region is reconfigured on the basis of the searched-out circuit configuration information by the hardware-region reconfiguration means.

Thus, an advantage equivalent to that of the print system in Aspect 13 is attained. Further, there is attained the advantage that the transmission history information need not be held in the print request apparatus.

Further, a print system in Aspect 15 comprises the print system in any of Aspects 2 through 14, wherein:
the circuit configuration information contains information for use in configuring the circuit which realizes the print data processing function, and information for use in configuring a circuit which realizes a print management function; and
the hardware-region reconfiguration means reconfigures part or the entire hardware region on the basis of the circuit configuration information.

With such a configuration, in the print equipment, the entire hardware region is reconfigured on the basis of the circuit configuration information for use in configuring the circuit which realizes the print data processing function, by the hardware-region reconfiguration means. Besides, part of the hardware region is reconfigured on the basis of the circuit configuration information for use in configuring the circuit which realizes the print management function.

Thus, it is permitted to rewrite only the necessary part of the hardware region. That is, there is attained the advantage that, if necessary, the idle hardware region can be caused to function as a new print-data processing region or as a print-equipment management region.

Further, a print system in Aspect 16 comprises:
a print system wherein a print request apparatus which makes a request for printing, print equipment which performs the printing in compliance with the print request from the print request apparatus, and a print-equipment management apparatus which manages a print data processing function are connected in communicable fashion, so as to perform the printing, wherein:
the print-equipment management apparatus includes circuit-configuration-information transmission means for transmitting circuit configuration information for use in configuring a circuit which realizes the print data processing function, to the print equipment in accordance with the print request; and
the print equipment includes a circuit device which has a rewritable hardware region, circuit-configuration-information reception means for receiving the circuit configuration information, and hardware-region reconfiguration means for reconfiguring the hardware region on the basis of the circuit configuration information received by the circuit-configuration-information reception means.

With such a configuration, in the print-equipment management apparatus, the circuit configuration information is transmitted to the print equipment in accordance with the print request from the print request apparatus, by the circuit-configuration-information transmission means.

In the print equipment, when the circuit configuration information has been received by the circuit-configuration-information reception means, the hardware region is reconfigured on the basis of the received circuit configuration information by the hardware-region reconfiguration means. The hardware region is reconfigured as the circuit which realizes the print data processing function.

Thus, the hardware region of the print equipment is reconfigured in accordance with the print request, so that print data processing relevant to the print request can be performed comparatively appropriately by the circuit device. Accordingly, there is attained the advantage that, as compared with the prior art, this invention can efficiently perform printings relevant to individual print requests, even when the plurality of print requests exist simultaneously.

Moreover, the print request apparatus and the print equipment need not hold the circuit configuration information. Therefore, there is attained the advantage that the memory capacities of the print request apparatus and the print equipment are not oppressed considerably, and that this invention can relieve a memory load as compared with the prior art.

Further, even when optimal sharing proportions are set for individual print request apparatuses in a case where the plurality of print request apparatuses of different processabilities utilize a single print equipment, the print equipment can cope with the different formats of data to-be-print-processed which are transmitted from the individual print request apparatuses, merely in such a way that a plurality of circuit configuration information items suited to the different formats of the data to-be-print-processed which the print request apparatuses transmit to the print equipment are held in the print-equipment management apparatus. Accordingly, there is attained the advantage that the circuit of the print equipment becomes smaller in scale than in case of providing a circuit device which realizes print data processing functions capable of coping with the respective formats.

Further, a print system in Aspect 17 comprises:
a print system wherein a print request apparatus which makes a request for printing, print equipment which performs the printing in compliance with the print request from the print request apparatus, and a print-equipment management apparatus which manages a print data processing function are connected in communicable fashion, so as to perform the printing, wherein:
the print-equipment management apparatus includes circuit-configuration-information storage means for storing therein circuit configuration information for use in configuring a circuit which realizes the print data processing function, and circuit-configuration-information transmission means for transmitting the circuit configuration information of the circuit-configuration-information storage means to the print equipment in accordance with the print request;
the print request apparatus includes data-to-be-print-processed transmission means for transmitting data to-be-print-processed to the print equipment in accordance with the print request; and
the print equipment includes a circuit device which has a rewritable hardware region, circuit-configuration-information reception means for receiving the circuit configuration information, hardware-region reconfiguration means for reconfiguring the hardware region on the basis of the circuit configuration information received by the circuit-configuration-information reception means, data-to-be-print-processed reception means for receiving the data to-be-print-processed, and print control means for performing the printing on the basis of print-processed data subjected to data processing by the circuit device, wherein the data to-be-print-processed received by the data-to-be-print-processed reception means are subjected to the data processing by the circuit device after the reconfiguration by the hardware-region reconfiguration means has been performed.

With such a configuration, in the print-equipment management apparatus, the circuit configuration information of the circuit-configuration-information storage means is transmitted to the print equipment in accordance with the print request from the print request apparatus by the circuit-configuration-information transmission means.

Besides, in the print request apparatus, the data to-be-print-processed are transmitted to the print equipment in accordance with the print request by the data-to-be-print-processed transmission means.

In the print equipment, when the circuit configuration information has been received by the circuit-configuration-information reception means, the hardware region is reconfigured on the basis of the received circuit configuration information by the hardware-region reconfiguration means. The hardware region is reconfigured as the circuit which realizes the print data processing function. Also, the data to-be-print-processed are received by the data-to-be-print-processed reception means. Here, when the reconfiguration by the hardware-region reconfiguration means is completed, the received data to-be-print-processed are subjected to the data processing by the circuit device, and the printing is done on the basis of the print-processed data subjected to the data processing, by the print control means.

Thus, after the hardware region of the print equipment has been reconfigured in accordance with the print request, the data to-be-print-processed relevant to the print request are subjected to the data processing by the circuit device, so that the print data processing relevant to the print request can be executed comparatively appropriately. Accordingly, there is attained the advantage that, as compared with the prior art, this invention can efficiently subject data to-be-print-processed relevant to individual print requests, to data processing even when the plurality of print requests exist simultaneously.

Moreover, the print request apparatus and the print equipment need not hold the circuit configuration information. Therefore, there is attained the advantage that the memory capacities of the print request apparatus and the print equipment are not oppressed considerably, and that this invention can relieve a memory load as compared with the prior art.

Further, even when optimal sharing proportions are set for individual print request apparatuses in a case where the plurality of print request apparatuses of different processabilities utilize a single print equipment, the print equipment can cope with the different formats of data to-be-print-processed which are transmitted from the individual print request apparatuses, merely in such a way that a plurality of circuit configuration information items suited to the different formats of the data to-be-print-processed which the print request apparatuses transmit to the print equipment are held in the print-equipment management apparatus. Accordingly, there is attained the advantage that the circuit of the print equipment becomes smaller in scale than in case of providing a circuit device which realizes print data processing functions capable of coping with the respective formats.

Here, the print-equipment management apparatus may be incarnated either as the single apparatus or as a network system in which a plurality of apparatuses are connected in communicable fashion. In the latter case, as long as the constituents are connected so as to be communicable with one another, they may belong to any of the plurality of apparatuses. In a case, for example, where a print-equipment management apparatus is configured by connecting two apparatuses so as to be communicable with each other, a configuration is considered in which the circuit-configuration-information storage means is disposed in the first print-equipment management apparatus, while the circuit-configuration-information transmission means is disposed in the second print-equipment management apparatus. Hereinbelow, the same shall hold true of a print system in Aspect 18, and the print-equipment management apparatus in Aspect 40.

Further, a print system in Aspect 18 comprises:
a print system wherein a print request apparatus which makes a request for printing, print equipment which performs the printing in compliance with the print request from the print request apparatus, and a print-equipment management apparatus which manages a print data processing function are connected in communicable fashion, so as to perform the printing, wherein:
the print-equipment management apparatus includes circuit-configuration-information storage means for storing therein circuit configuration information for use in configuring a circuit which realizes the print data processing function, and circuit-configuration-information transmission means for transmitting the circuit configuration information of the circuit-configuration-information storage means to the print equipment in accordance with the print request;
the print request apparatus includes data-to-be-print-processed transmission means for transmitting data to-be-print-processed to the print equipment in accordance with the print request;
the print equipment includes a circuit device which has a rewritable hardware region, circuit-configuration-information reception means for receiving the circuit configuration information, hardware-region reconfiguration means for reconfiguring the hardware region on the basis of the circuit configuration information received by the circuit-configuration-information reception means, data-to-be-print-processed reception means for receiving the data to-be-print-processed, and print control means for performing the printing on the basis of print-processed data subjected to data processing by the circuit device; and
the print control means subjects the data to-be-print-processed received by the data-to-be-print-processed reception means, to the data processing by the circuit device after the reconfiguration by the hardware-region reconfiguration means has been performed.

With such a configuration, an operation and advantages equivalent to those of the print system in Aspect 17 are attained.

Further, a print system in Aspect 19 comprises the print system in either of Aspects 17 and 18, wherein:
the print request apparatus further includes reconfiguration-instruction transmission means for transmitting a reconfiguration instruction which contains identification information of the circuit configuration information, to the print-equipment management apparatus in accordance with the print request;
the print-equipment management apparatus further includes reconfiguration-instruction reception means for receiving the reconfiguration instruction, and circuit-configuration-information search means for searching the circuit-configuration-information storage means for the corresponding circuit configuration information on the basis of the identification information which is contained in the reconfiguration instruction received by the reconfiguration-instruction reception means; and
the circuit-configuration-information transmission means transmits the circuit configuration information searched out by the circuit-configuration-information search means, to the print equipment.

With such a configuration, in the print request apparatus, the reconfiguration instruction containing the identification information of the circuit configuration information is transmitted to the print-equipment management apparatus in accordance with the print request by the reconfiguration-instruction transmission means.

In the print-equipment management apparatus, when the reconfiguration instruction has been received by the reconfiguration-instruction reception means, the circuit-configuration-information storage means is searched for the corresponding circuit configuration information on the basis of the identification information contained in the received reconfiguration instruction, by the circuit-configuration-information search means. When the corresponding circuit configuration information has been searched out as the result, the searched-out circuit configuration information is transmitted to the print equipment by the circuit-configuration-information transmission means.

Further, a print system in Aspect 20 comprises the print system in either of Aspects 17 and 18, wherein:
the data-to-be-print-processed transmission means transmits the identification information of the circuit configuration information as is contained in the data to-be-print-processed, to the print equipment;
the print equipment further includes reconfiguration-instruction transmission means for transmitting to the print-equipment management apparatus the reconfiguration instruction which contains the identification information acquired from the data to-be-print-processed received by the data-to-be-print-processed reception means;
the print-equipment management apparatus further includes reconfiguration-instruction reception means for receiving the reconfiguration instruction, and circuit-configuration-information search means for searching the circuit-configuration-information storage means for the corresponding circuit configuration information on the basis of the identification information which is contained in the reconfiguration instruction received by the reconfiguration-instruction reception means; and
the circuit-configuration-information transmission means transmits the circuit configuration information searched out by the circuit-configuration-information search means, to the print equipment.

With such a configuration, in the print request apparatus, the identification information of the circuit configuration information as is contained in the data to-be-print-processed is transmitted to the print equipment by the data-to-be-print-processed transmission means.

In the print equipment, when the data to-be-print-processed have been received by the data-to-be-print-processed reception means, the reconfiguration instruction which contains the identification information acquired from the received data to-be-print-processed is transmitted to the print-equipment management apparatus by the reconfiguration-instruction transmission means.

In the print-equipment management apparatus, when the reconfiguration instruction has been received by the reconfiguration-instruction reception means, the circuit-configuration-information storage means is searched for the corresponding circuit configuration information on the basis of the identification information contained in the received reconfiguration instruction, by the circuit-configuration-information search means. When the corresponding circuit configuration information has been searched out as the result, the searched-out circuit configuration information is transmitted to the print equipment by the circuit-configuration-information transmission means.

Further, a print system in Aspect 21 comprises the print system in any of Aspects 17 through 20, wherein:
the hardware-region reconfiguration means transmits a predetermined notification to the print request apparatus when the reconfiguration of the hardware region has been completed; and
the data-to-be-print-processed transmission means transmits the data to-be-print-processed to the print equipment when the predetermined notification has been received.

With such a configuration, in the print equipment, when the reconfiguration of the hardware region has been completed, the predetermined notification is transmitted to the print request apparatus by the hardware-region reconfiguration means.

In the print request apparatus, when the predetermined notification has been received, the data to-be-print-processed are transmitted to the print equipment by the data-to-be-print-processed transmission means.

Thus, the data to-be-print-processed are subjected to the data processing by the circuit device after waiting for the completion of the reconfiguration of the hardware region, and hence, there is attained the advantage that the print data processing relevant to the print request can be executed comparatively reliably.

Further, a print system in Aspect 22 comprises the print system in any of Aspects 17 through 20, wherein:
the print equipment further includes data-to-be-print-processed holding means for holding therein the data to-be-print-processed received by the data-to-be-print-processed reception means, and that it subjects the data to-be-print-processed held in the data-to-be-print-processed holding means, to the data processing by the circuit device when the reconfiguration by the hardware-region reconfiguration means has been completed.

With such a configuration, in the print equipment, the received data to-be-print-processed are held by the data-to-be-print-processed holding means. Besides, when the reconfiguration of the hardware region has been completed, the held data to-be-print-processed are subjected to the data processing by the circuit device, and the printing is performed on the basis of the print-processed data subjected to the data processing, by the print control means.

Thus, the data to-be-print-processed are subjected to the data processing by the circuit device after waiting for the completion of the reconfiguration of the hardware region, and hence, there is attained the advantage that the print data processing relevant to the print request can be executed comparatively reliably.

Further, a print system in Aspect 23 comprises the print system in any of Aspects 17 through 22, wherein:
the circuit configuration information contains information for use in configuring a circuit which realizes a print data processing function specialized for subjecting the data to-be-print-processed to data processing.

With such a configuration, in the print equipment, when the circuit configuration information has been received by the circuit-configuration-information reception means, the hardware region is reconfigured on the basis of the received circuit configuration information by the hardware-region reconfiguration means. The hardware region is reconfigured as the circuit which realizes the print data processing function specialized for subjecting the data to-be-print-processed to the data processing.

Thus, the data to-be-print-processed are subjected to the print data processing specialized therefore, and hence, there is attained the advantage that the print data processing relevant to the print request can be performed more appropriately.

Further, a print system in Aspect 24 comprises the print system in any of Aspects 17 through 22, wherein:
the circuit configuration information contains information for use in configuring a circuit which realizes a print data processing function that sets a degree of parallelism in a case where a plurality of sets of such data to-be-print-processed are subjected to data processing in parallel, or where parallel-processable parts of a single set of such data to-be-print-processed are subjected to data processing in parallel.

With such a configuration, in the print equipment, when the circuit configuration information has been received by the circuit-configuration-information reception means, the hardware region is reconfigured on the basis of the received circuit configuration information by the hardware-region reconfiguration means. The hardware region is reconfigured as the circuit which realizes the print data processing function that sets the degree of parallelism in the case where the plurality of sets of data to-be-print-processed are subjected to the data processing in parallel, or where the parallel-processable parts of the single set of data to-be-print-processed are subjected to the data processing in parallel.

Thus, the degree of parallelism of the print equipment can be adjusted in the print request apparatus, and hence, there is attained the advantage that the data to-be-print-processed can be subjected to the data processing more efficiently.

Further, a print system in Aspect 25 comprises the print system in any of Aspects 17 through 22, wherein:
the circuit configuration information contains information for use in configuring a circuit which realizes a print data processing function that is to be borne by the print equipment in a case where the print equipment and another device share the data processing of the data to-be-print-processed.

With such a configuration, in the print equipment, when the circuit configuration information has been received by the circuit-configuration-information reception means, the hardware region is reconfigured on the basis of the received circuit configuration information by the hardware-region reconfiguration means. The hardware region is reconfigured as the circuit which realizes the print data processing function that is to be borne by the print equipment in the case where the print equipment and other device share the data processing of the data to-be-print-processed.

Thus, the print data processing function suited to the sharing proportion of the print equipment can be configured in the print request apparatus, and hence, there is attained the advantage that the data to-be-print-processed can be subjected to the data processing more efficiently.

Here, as the other device, it is possible to utilize the print request apparatus, another print equipment, the print-equipment management apparatus or any other device. Hereinbelow, the same shall hold true of a print-equipment management apparatus in Aspect 44, a print-equipment management program in Aspect 75, and a print method in Aspect 112.

Meanwhile, in order to accomplish the object, a print request apparatus in Aspect 26 comprises a print request apparatus which is communicably connected with print equipment that performs printing in compliance with a print request, comprising:
circuit-configuration-information transmission means for transmitting circuit configuration information for use in configuring a circuit which realizes a print data processing function, to the print equipment in accordance with the print request.

With such a configuration, an operation equivalent to that of the print request apparatus in the print system in Aspect 1 is attained. Accordingly, advantages equivalent to those of the print system in Aspect 1 are attained.

Further, a print request apparatus in Aspect 27 comprises a print request apparatus which is communicably connected with print equipment that performs printing in compliance with a print request, comprising:
circuit-configuration-information storage means for storing therein circuit configuration information for use in configuring a circuit which realizes a print data processing function, circuit-configuration-information transmission means for transmitting the circuit configuration information of the circuit-configuration-information storage means to the print equipment in accordance with the print request, and data-to-be-print-processed transmission means for transmitting data to-be-print-processed to the print equipment in accordance with the print request.

With such a configuration, an operation equivalent to that of the print request apparatus in the print system in Aspect 2 is attained. Accordingly, advantages equivalent to those of the print system in Aspect 2 are attained.

Further, a print request apparatus in Aspect 28 comprises the print request apparatus in Aspect 27, wherein:
the circuit-configuration-information transmission means transmits the circuit configuration information of the circuit-configuration-information storage means to the print equipment when a request for printing has been inputted by an input interface.

With such a configuration, an operation equivalent to that of the print request apparatus in the print system in Aspect 6 is attained. Accordingly, advantages equivalent to those of the print system in Aspect 6 are attained.

Further, a print request apparatus in Aspect 29 comprises the print request apparatus in Aspect 27, wherein:
the circuit-configuration-information transmission means transmits the circuit configuration information of the circuit-configuration-information storage means to the print equipment when settings concerning printing have been performed by an input interface.

With such a configuration, an operation equivalent to that of the print request apparatus in the print system in Aspect 7 is attained. Accordingly, advantages equivalent to those of the print system in Aspect 7 are attained.

Further, a print request apparatus in Aspect 30 comprises the print request apparatus in any of Aspects 27 through 29, wherein:
the circuit configuration information contains information for use in configuring a circuit which realizes a print data processing function specialized for subjecting the data to-be-print-processed to data processing.

With such a configuration, an operation equivalent to that of the print request apparatus in the print system in Aspect 8 is attained. Accordingly, advantages equivalent to those of the print system in Aspect 8 are attained.

Further, a print request apparatus in Aspect 31 comprises the print request apparatus in any of Aspects 27 through 29, wherein:
the circuit configuration information contains information for use in configuring a circuit which realizes a print data processing function that sets a degree of parallelism in a case where a plurality of sets of such data to-be-print-processed are subjected to data processing in parallel, or where parallel-processable parts of a single set of such data to-be-print-processed are subjected to data processing in parallel.

With such a configuration, an operation equivalent to that of the print request apparatus in the print system in Aspect 9 is attained. Accordingly, advantages equivalent to those of the print system in Aspect 9 are attained.

Further, a print request apparatus in Aspect 32 comprises the print request apparatus in Aspect 31, further comprising:
status-information acquisition means for acquiring status information which indicates a scale of the hardware region of the print equipment, and circuit-configuration-information updating means for setting the degree of parallelism of the circuit configuration information on the basis of the status information acquired by the status-information acquisition means;
the circuit-configuration-information transmission means transmitting the circuit configuration information updated by the circuit-configuration-information updating means, to the print equipment.

With such a configuration, an operation equivalent to that of the print request apparatus in the print system in Aspect 10 is attained. Accordingly, advantages equivalent to those of the print system in Aspect 10 are attained.

Further, a print request apparatus in Aspect 33 comprises the print request apparatus in any of Aspects 27 through 29, wherein:
the circuit configuration information contains information for use in configuring a circuit which realizes a print data processing function that is to be borne by the print equipment in a case where the print equipment and another device share the data processing of the data to-be-print-processed.

With such a configuration, an operation equivalent to that of the print request apparatus in the print system in Aspect 11 is attained. Accordingly, advantages equivalent to those of the print system in Aspect 11 are attained.

Further, a print request apparatus in Aspect 34 comprises the print request apparatus in Aspect 33, further comprising:
status-information acquisition means for acquiring status information which indicates a processing load of the print equipment, and status information which indicates a processing load of the other device, and circuit-configuration-information updating means for updating the circuit configuration information on the basis of the status information items acquired by the status-information acquisition means;
the circuit-configuration-information transmission means transmitting the circuit configuration information updated by the circuit-configuration-information updating means, to the print equipment.

With such a configuration, an operation equivalent to that of the print request apparatus in the print system in Aspect 12 is attained. Accordingly, advantages equivalent to those of the print system in Aspect 12 are attained.

Further, a print request apparatus in Aspect 35 comprises the print request apparatus in any of Aspects 27 through 34, further comprising.
transmission-history-information registration means for registering transmission history information which indicates a transmission history of the circuit configuration information transmitted to the print equipment, in transmission-history-information storage means;
the circuit-configuration-information transmission means transmitting a reconfiguration instruction which contains identification information of the corresponding circuit configuration information, to the print equipment when the print request apparatus has decided that the same circuit configuration information as that to be transmitted to the print equipment has already been transmitted to the print equipment, on the basis of the transmission history information of the transmission-history-information storage means.

With such a configuration, an operation equivalent to that of the print request apparatus in the print system in Aspect 13 is attained. Accordingly, advantages equivalent to those of the print system in Aspect 13 are attained.

Further, a print request apparatus in Aspect 36 comprises the print request apparatus in any of Aspects 27 through 34, further comprising:
circuit-configuration-information inquiry means for inquiring of the print equipment as to the circuit configuration information which the print equipment holds;
the circuit-configuration-information transmission means transmitting a reconfiguration instruction which contains identification information of the corresponding circuit configuration information, to the print equipment when the print request apparatus has decided that the same circuit configuration information as that to be transmitted to the print equipment has already been transmitted to the print equipment, on the basis of a result of the inquiry of the circuit-configuration-information inquiry means.

With such a configuration, an operation equivalent to that of the print request apparatus in the print system in Aspect 14 is attained. Accordingly, advantages equivalent to those of the print system in Aspect 14 are attained.

Further, a print request apparatus in Aspect 37 comprises a print request apparatus which is communicably connected with print equipment that performs printing in compliance with a print request, and a print-equipment management apparatus that manages a print data processing function, comprising:
data-to-be-print-processed transmission means for transmitting data to-be-print-processed to the print equipment in accordance with the print request.

With such a configuration, an operation equivalent to that of the print request apparatus in the print system in Aspect 17 is attained. Accordingly, advantages equivalent to those of the print system in Aspect 17 are attained.

Further, a print request apparatus in Aspect 38 comprises the print request apparatus in Aspect 37, further comprising:
reconfiguration-instruction transmission means for transmitting a reconfiguration instruction which contains identification information of the circuit configuration information, to the print-equipment management apparatus in accordance with the print request.

With such a configuration, an operation equivalent to that of the print request apparatus in the print system in Aspect 19 is attained. Accordingly, advantages equivalent to those of the print system in Aspect 19 are attained.

Meanwhile, in order to accomplish the object, a print-equipment management apparatus in Aspect 39 comprises a print-equipment management apparatus which is communicably connected with print equipment that performs printing in compliance with a print request from a print request apparatus, comprising:
circuit-configuration-information transmission means for transmitting circuit configuration information for use in configuring a circuit which realizes a print data processing function, to the print equipment in accordance with the print request.

With such a configuration, an operation equivalent to that of the print-equipment management apparatus in the print system in Aspect 16 is attained. Accordingly, advantages equivalent to those of the print system in Aspect 16 are attained.

Further, a print-equipment management apparatus in Aspect 40 comprises a print-equipment management apparatus which is communicably connected with print equipment that performs printing in compliance with a print request from a print request apparatus, comprising:
circuit-configuration-information storage means for storing therein circuit configuration information for use in configuring a circuit which realizes a print data processing function, and circuit-configuration-information transmission means for transmitting the circuit configuration information of the circuit-configuration-information storage means to the print equipment in accordance with the print request.

With such a configuration, an operation equivalent to that of the print-equipment management apparatus in the print system in Aspect 17 is attained. Accordingly, advantages equivalent to those of the print system in Aspect 17 are attained.

Further, a print-equipment management apparatus in Aspect 41 comprises the print-equipment management apparatus in Aspect 40, further comprising:
reconfiguration-instruction reception means for receiving the reconfiguration instruction which contains identification information of the circuit configuration information, and circuit-configuration-information search means for searching the circuit-configuration-information storage means for the corresponding circuit configuration information on the basis of the identification information which is contained in the reconfiguration instruction received by the reconfiguration-instruction reception means;
the circuit-configuration-information transmission means transmitting the circuit configuration information searched out by the circuit-configuration-information search means, to the print equipment.

With such a configuration, an operation equivalent to that of the print-equipment management apparatus in the print system in Aspect 19 or 20 is attained. Accordingly, advantages equivalent to those of the print system in Aspect 19 or 20 are attained.

Further, a print-equipment management apparatus in Aspect 42 comprises a print-equipment management apparatus in either of Aspects 40 and 41, wherein:
the circuit configuration information contains information for use in configuring a circuit which realizes a print data processing function specialized for subjecting the data to-be-print-processed to data processing.

With such a configuration, an operation equivalent to that of the print-equipment management apparatus in the print system in Aspect 23 is attained. Accordingly, advantages equivalent to those of the print system in Aspect 23 are attained.

Further, a print-equipment management apparatus in Aspect 43 comprises the print-equipment management apparatus in either of Aspects 40 and 41, wherein:
the circuit configuration information contains information for use in configuring a circuit which realizes a print data processing function that sets a degree of parallelism in a case where a plurality of sets of such data to-be-print-processed are subjected to data processing in parallel, or where parallel-processable parts of a single set of such data to-be-print-processed are subjected to data processing in parallel.

With such a configuration, an operation equivalent to that of the print-equipment management apparatus in the print system in Aspect 24 is attained. Accordingly, advantages equivalent to those of the print system in Aspect 24 are attained.

Further, a print-equipment management apparatus in Aspect 44 comprises the print-equipment management apparatus in either of Aspects 40 and 41, wherein:
the circuit configuration information contains information for use in configuring a circuit which realizes a print data processing function that is to be borne by the print equipment in a case where the print equipment and another device share the data processing of the data to-be-print-processed.

With such a configuration, an operation equivalent to that of the print-equipment management apparatus in the print system in Aspect 25 is attained. Accordingly, advantages equivalent to those of the print system in Aspect 25 are attained.

Meanwhile, in order to accomplish the object, print equipment in Aspect 45 comprises print equipment which is communicably connected with a print request apparatus that makes a request for printing, comprising:
a circuit device which has a rewritable hardware region, circuit-configuration-information reception means for receiving circuit configuration information for use in configuring a circuit which realizes a print data processing function, and hardware-region reconfiguration means for reconfiguring the hardware region on the basis of the circuit configuration information received by the circuit-configuration-information reception means.

With such a configuration, an operation equivalent to that of the print equipment in the print system in Aspect 1 is attained. Accordingly, advantages equivalent to those of the print system in Aspect 1 are attained.

Further, print equipment in Aspect 46 comprises print equipment which is communicably connected with a print request apparatus that makes a request for printing, comprising:
a circuit device which has a rewritable hardware region, circuit-configuration-information reception means for receiving circuit configuration information for use in configuring a circuit which realizes a print data processing function, hardware-region reconfiguration means for reconfiguring the hardware region on the basis of the circuit configuration information received by the circuit-configuration-information reception means, data-to-be-print-processed reception means for receiving data to-be-print-processed, and print control means for performing the printing on the basis of print-processed data subjected to data processing by the circuit device.

With such a configuration, an operation equivalent to that of the print equipment in the print system in Aspect 2 is attained. Accordingly, advantages equivalent to those of the print system in Aspect 2 are attained.

Further, print equipment in Aspect 47 comprises print equipment which is communicably connected with a print request apparatus that makes a request for printing, comprising:
a circuit device which has a rewritable hardware region, circuit-configuration-information reception means for receiving circuit configuration information for use in configuring a circuit which realizes a print data processing function, hardware-region reconfiguration means for reconfiguring the hardware region on the basis of the circuit configuration information received by the circuit-configuration-information reception means, data-to-be-print-processed reception means for receiving data to-be-print-processed, and print control means for performing the printing on the basis of print-processed data subjected to data processing by the circuit device;
the print control means subjecting the data to-be-print-processed received by the data-to-be-print-processed reception means, to the data processing by the circuit device after the reconfiguration by the hardware-region reconfiguration means has been performed.

With such a configuration, an operation equivalent to that of the print equipment in the print system in Aspect 3 is attained. Accordingly, advantages equivalent to those of the print system in Aspect 3 are attained.

Further, print equipment in Aspect 48 comprises the print equipment in either of Aspects 46 and 47, wherein:
the hardware-region reconfiguration means transmits a predetermined notification to the print request apparatus when the reconfiguration of the hardware region has been completed.

With such a configuration, an operation equivalent to that of the print equipment in the print system in Aspect 4 is attained. Accordingly, advantages equivalent to those of the print system in Aspect 4 are attained.

Further, print equipment in Aspect 49 comprises the print equipment in either of Aspects 46 and 47, further comprising:
data-to-be-print-processed holding means for holding therein the data to-be-print-processed received by the data-to-be-print-processed reception means;
the print equipment subjecting the data to-be-print-processed held in the data-to-be-print-processed holding means, to the data processing by the circuit device when the reconfiguration by the hardware-region reconfiguration means has been completed.

With such a configuration, an operation equivalent to that of the print equipment in the print system in Aspect 5 is attained. Accordingly, advantages equivalent to those of the print system in Aspect 5 are attained.

Further, print equipment in Aspect 50 comprises the print equipment in any of Aspects 46 through 49, wherein:
the circuit configuration information contains information for use in configuring a circuit which realizes a print data processing function specialized for subjecting the data to-be-print-processed to data processing.

With such a configuration, an operation equivalent to that of the print equipment in the print system in Aspect 8 is attained. Accordingly, advantages equivalent to those of the print system in Aspect 8 are attained.

Further, print equipment in Aspect 51 comprises the print equipment in any of Aspects 46 through 49, wherein:
the circuit configuration information contains information for use in configuring a circuit which realizes a print data processing function that sets a degree of parallelism in a case where a plurality of sets of such data to-be-print-processed are subjected to data processing in parallel, or where parallel-processable parts of a single set of such data to-be-print-processed are subjected to data processing in parallel.

With such a configuration, an operation equivalent to that of the print equipment in the print system in Aspect 9 is attained. Accordingly, advantages equivalent to those of the print system in Aspect 9 are attained.

Further, print equipment in Aspect 52 comprises the print equipment in any of Aspects 46 through 49, wherein:
the circuit configuration information contains information for use in configuring a circuit which realizes a print data processing function that is to be borne by the print equipment in a case where the print equipment and another device share the data processing of the data to-be-print-processed.

With such a configuration, an operation equivalent to that of the print equipment in the print system in Aspect 11 is attained. Accordingly, advantages equivalent to those of the print system in Aspect 11 are attained.

Further, print equipment in Aspect 53 comprises the print equipment in any of Aspects 46 through 52, further comprising:
circuit-configuration-information registration means for registering the circuit configuration information received by the circuit-configuration-information reception means, in second circuit-configuration-information storage means, reconfiguration-instruction reception means for receiving the reconfiguration instruction which contains identification information of the circuit configuration information, and circuit-configuration-information search means for searching the second circuit-configuration-information storage means for the corresponding circuit configuration information on the basis of the identification information which is contained in the reconfiguration instruction received by the reconfiguration-instruction reception means;
the hardware-region reconfiguration means reconfiguring the hardware region on the basis of the circuit configuration information received by the circuit-configuration-information reception means, or the circuit configuration information searched out by the circuit-configuration-information search means.

With such a configuration, an operation equivalent to that of the print equipment in the print system in Aspect 13 is attained. Accordingly, advantages equivalent to those of the print system in Aspect 13 are attained.

Further, the print equipment in Aspect 54 comprises the print equipment in any of Aspects 46 through 52, further comprising:
circuit-configuration-information registration means for registering the circuit configuration information received by the circuit-configuration-information reception means, in second circuit-configuration-information storage means, reconfiguration-instruction reception means for receiving the reconfiguration instruction which contains identification information of the circuit configuration information, circuit-configuration-information search means for searching the second circuit-configuration-information storage means for the corresponding circuit configuration information on the basis of the identification information which is contained in the reconfiguration instruction received by the reconfiguration-instruction reception means, and circuit-configuration-information reply means for replying presence or absence of the circuit configuration information to the inquiry from the print request apparatus, on the basis of registered contents of the second circuit configuration-information storage means;
the hardware-region reconfiguration means reconfiguring the hardware region on the basis of the circuit configuration information received by the circuit-configuration-information reception means, or the circuit configuration information searched out by the circuit-configuration-information search means.

With such a configuration, an operation equivalent to that of the print equipment in the print system in Aspect 14 is attained. Accordingly, advantages equivalent to those of the print system in Aspect 14 are attained.

Further, print equipment in Aspect 55 comprises the print equipment in any of Aspects 46 and 54, wherein:
the circuit configuration information contains information for use in configuring the circuit which realizes the print data processing function, and information for use in configuring a circuit which realizes a print management function;
the hardware-region reconfiguration means reconfiguring part or the entire hardware region on the basis of the circuit configuration information.

With such a configuration, an operation equivalent to that of the print equipment in the print system in Aspect 15 is attained. Accordingly, advantages equivalent to those of the print system in Aspect 15 are attained.

Further, print equipment in Aspect 56 comprises the print equipment in Aspect 46, wherein:
the print equipment is further communicably connected with a print-equipment management apparatus which manages a print data processing function; and
the print equipment further comprises reconfiguration-instruction transmission means for transmitting to the print-equipment management apparatus the reconfiguration instruction which contains the identification information acquired from the data to-be-print-processed received by the data-to-be-print-processed reception means.

With such a configuration, an operation equivalent to that of the print equipment in the print system in Aspect 20 is attained. Accordingly, advantages equivalent to those of the print system in Aspect 20 are attained.

Meanwhile, in order to accomplish the object, a print-equipment management program in Aspect 57 comprises a print-equipment management program which is run by a computer that is communicably connected with print equipment for performing printing in compliance with a print request, and that operates as a print request apparatus, comprising:
a program for causing the computer to execute processing which includes a circuit-configuration-information transmission step of transmitting circuit configuration information for use in configuring a circuit that realizes a print data processing function, to the print equipment in accordance with the print request.

With such a configuration, in a case where the program has been read by the computer and where the computer has executed the processing in accordance with the read program, an operation and advantages equivalent to those of the print request apparatus in Aspect 26 are attained.

Further, a print-equipment management program in Aspect 58 comprises a print-equipment management program which is run by a computer that is communicably connected with print equipment for performing printing in compliance with a print request, that includes circuit-configuration-information storage means for storing therein circuit configuration information for use in configuring a circuit for realizing a print data processing function, and that operates as a print request apparatus, comprising:
a program for causing the computer to execute processing which includes a circuit-configuration-information transmission step of transmitting the circuit configuration information of the circuit-configuration-information storage means to the print equipment in accordance with the print request, and a data-to-be-print-processed transmission step of transmitting data to-be-print-processed to the print equipment in accordance with the print request.

With such a configuration, in a case where the program has been read by the computer and where the computer has executed the processing in accordance with the read program, an operation and advantages equivalent to those of the print request apparatus in Aspect 27 are attained.

Further, a print-equipment management program in Aspect 59 comprises the print-equipment management program in Aspect 58, wherein:
the circuit-configuration-information transmission step transmits the circuit configuration information of the circuit-configuration-information storage means to the print equipment when a request for printing has been inputted by an input interface.

With such a configuration, in a case where the program has been read by the computer and where the computer has executed the processing in accordance with the read program, an operation and advantages equivalent to those of the print request apparatus in Aspect 28 are attained.

Further, a print-equipment management program in Aspect 60 comprises the print-equipment management program in Aspect 58, wherein:
the circuit-configuration-information transmission step transmits the circuit configuration information of the circuit-configuration-information storage means to the print equipment when settings concerning printing have been performed by an input interface.

With such a configuration, in a case where the program has been read by the computer and where the computer has executed the processing in accordance with the read program, an operation and advantages equivalent to those of the print request apparatus in Aspect 29 are attained.

Further, a print-equipment management program in Aspect 61 comprises the print-equipment management program in any of Aspects 58 through 60, wherein:
the circuit configuration information contains information for use in configuring a circuit which realizes a print data processing function specialized for subjecting the data to-be-print-processed to data processing.

With such a configuration, in a case where the program has been read by the computer and where the computer has executed the processing in accordance with the read program, an operation and advantages equivalent to those of the print request apparatus in Aspect 30 are attained.

Further, a print-equipment management program in Aspect 62 comprises the print-equipment management program in any of Aspects 58 through 60, wherein:
the circuit configuration information contains information for use in configuring a circuit which realizes a print data processing function that sets a degree of parallelism in a case where a plurality of sets of such data to-be-print-processed are subjected to data processing in parallel, or where parallel-processable parts of a single set of such data to-be-print-processed are subjected to data processing in parallel.

With such a configuration, in a case where the program has been read by the computer and where the computer has executed the processing in accordance with the read program, an operation and advantages equivalent to those of the print request apparatus in Aspect 31 are attained.

Further, a print-equipment management program in Aspect 63 comprises the print-equipment management program in Aspect 62, further comprising:
a program for causing the computer to execute processing which includes a status-information acquisition step of acquiring status information that indicates a scale of a hardware region of the print equipment, and a circuit-configuration-information updating step of setting the degree of parallelism of the circuit configuration information on the basis of the status information acquired at the status-information acquisition step;
the circuit-configuration-information transmission step transmitting the circuit configuration information updated at the circuit-configuration-information updating step, to the print equipment.

With such a configuration, in a case where the program has been read by the computer and where the computer has executed the processing in accordance with the read program, an operation and advantages equivalent to those of the print request apparatus in Aspect 32 are attained.

Here, the status-information acquisition step may be in any form as long as the status information is acquired. By way of example, the status information may be calculated, detected or estimated, or it may well be acquired from the print request apparatus, the print equipment or any other device. Hereinbelow, the same shall hold true of a print-equipment management program in Aspect 65, and print methods in Aspects 97 and 99.

Further, a print-equipment management program in Aspect 64 comprises the print-equipment management program in any of Aspects 58 through 60, wherein:
the circuit configuration information contains information for use in configuring a circuit which realizes a print data processing function that is to be borne by the print equipment in a case where the print equipment and another device share the data processing of the data to-be-print-processed.

With such a configuration, in a case where the program has been read by the computer and where the computer has executed the processing in accordance with the read program, an operation and advantages equivalent to those of the print request apparatus in Aspect 33 are attained.

Further, a print-equipment management program in Aspect 65 comprises the print-equipment management program in Aspect 64, further comprising:
a program for causing the computer to execute processing which includes a status-information acquisition step of acquiring status information that indicates a processing load of the print equipment, and status information that indicates a processing load of the other device, and a circuit-configuration-information updating step of updating the circuit configuration information on the basis of the status information items acquired at the status-information acquisition step;
the circuit-configuration-information transmission step transmitting the circuit configuration information updated at the circuit-configuration-information updating step, to the print equipment.

With such a configuration, in a case where the program has been read by the computer and where the computer has executed the processing in accordance with the read program, an operation and advantages equivalent to those of the print request apparatus in Aspect 34 are attained.

Further, a print-equipment management program in Aspect 66 comprises the print-equipment management program in any of Aspects 58 through 65, further comprising:
a program for causing the computer to execute processing which includes a transmission-history-information registration step of registering transmission history information that indicates a transmission history of the circuit configuration information transmitted to the print equipment, in transmission-history-information storage means;
the circuit-configuration-information transmission step transmitting a reconfiguration instruction which contains identification information of the corresponding circuit configuration information, to the print equipment when it has been decided that the same circuit configuration information as that to be transmitted to the print equipment has already been transmitted to the print equipment, on the basis of the transmission history information of the transmission-history-information storage means.

With such a configuration, in a case where the program has been read by the computer and where the computer has executed the processing in accordance with the read program, an operation and advantages equivalent to those of the print request apparatus in Aspect 35 are attained.

Further, a print-equipment management program in Aspect 67 comprises the print-equipment management program in any of Aspects 58 through 65, further comprising:
a program for causing the computer to execute processing which includes a circuit-configuration-information inquiry step of inquiring of the print equipment as to the circuit configuration information which the print equipment holds;
the circuit-configuration-information transmission step transmitting a reconfiguration instruction which contains identification information of the corresponding circuit configuration information, to the print equipment when it has been decided that the same circuit configuration information as that to be transmitted to the print equipment has already been transmitted to the print equipment, on the basis of a result of the inquiry of the circuit-configuration-information inquiry step.

With such a configuration, in a case where the program has been read by the computer and where the computer has executed the processing in accordance with the read program, an operation and advantages equivalent to those of the print request apparatus in Aspect 36 are attained.

Further, a print-equipment management program in Aspect 68 comprises a print-equipment management program which is run by a computer that is communicably connected with print equipment for performing printing in compliance with a print request, and a print-equipment management apparatus for managing a print data processing function, and that operates as a print request apparatus, comprising:
a program for causing the computer to execute processing which includes a data-to-be-print-processed transmission step of transmitting data to-be-print-processed to the print equipment in accordance with the print request.

With such a configuration, in a case where the program has been read by the computer and where the computer has executed the processing in accordance with the read program, an operation and advantages equivalent to those of the print request apparatus in Aspect 37 are attained.

Further, a print-equipment management program in Aspect 69 comprises the print-equipment management program in Aspect 68, further comprising:
a program for causing the computer to execute processing which includes a reconfiguration-instruction transmission step of transmitting a reconfiguration instruction which contains identification information of the circuit configuration information, to the print-equipment management apparatus in accordance with the print request.

With such a configuration, in a case where the program has been read by the computer and where the computer has executed the processing in accordance with the read program, an operation and advantages equivalent to those of the print request apparatus in Aspect 38 are attained.

Further, a print-equipment management program in Aspect 70 comprises a print-equipment management program which is run by a computer that is communicably connected with print equipment for performing printing in compliance with a print request from a print request apparatus, and that operates as a print-equipment management apparatus, comprising:
a program for causing the computer to execute processing which includes a circuit-configuration-information transmission step of transmitting circuit configuration information for use in configuring a circuit which realizes a print data processing function, to the print equipment in accordance with the print request.

With such a configuration, in a case where the program has been read by the computer and where the computer has executed the processing in accordance with the read program, an operation and advantages equivalent to those of the print-equipment management apparatus in Aspect 39 are attained.

Further, a print-equipment management program in Aspect 71 comprises a print-equipment management program which is run by a computer that is communicably connected with print equipment for performing printing in compliance with a print request from a print request apparatus, that includes circuit-configuration-information storage means for storing therein circuit configuration information for use in configuring a circuit for realizing a print data processing function, and that operates as a print-equipment management apparatus, comprising:
a program for causing the computer to execute processing which includes a circuit-configuration-information transmission step of transmitting the circuit configuration information of the circuit-configuration-information storage means to the print equipment in accordance with the print request.

With such a configuration, in a case where the program has been read by the computer and where the computer has executed the processing in accordance with the read program, an operation and advantages equivalent to those of the print-equipment management apparatus in Aspect 40 are attained.

Further, a print-equipment management program in Aspect 72 comprises the print-equipment management program in Aspect 71, further comprising:
a program for causing the computer to execute processing which includes a reconfiguration-instruction reception step of receiving the reconfiguration instruction which contains identification information of the circuit configuration information, and circuit-configuration-information search step of searching the circuit-configuration-information storage means for the corresponding circuit configuration information on the basis of the identification information which is contained in the reconfiguration instruction received at the reconfiguration-instruction reception step;
the circuit-configuration-information transmission step transmitting the circuit configuration information searched out at the circuit-configuration-information search step, to the print equipment.

With such a configuration, in a case where the program has been read by the computer and where the computer has executed the processing in accordance with the read program, an operation and advantages equivalent to those of the print-equipment management apparatus in Aspect 41 are attained.

Further, a print-equipment management program in Aspect 73 comprises the print-equipment management program in either of Aspects 71 and 72, wherein:
the circuit configuration information contains information for use in configuring a circuit which realizes a print data processing function specialized for subjecting the data to-be-print-processed to data processing.

With such a configuration, in a case where the program has been read by the computer and where the computer has executed the processing in accordance with the read program, an operation and advantages equivalent to those of the print-equipment management apparatus in Aspect 42 are attained.

Further, a print-equipment management program in Aspect 74 comprises the print-equipment management program in either of Aspects 71 and 72, wherein:
the circuit configuration information contains information for use in configuring a circuit which realizes a print data processing function that sets a degree of parallelism in a case where a plurality of sets of such data to-be-print-processed are subjected to data processing in parallel, or where parallel-processable parts of a single set of such data to-be-print-processed are subjected to data processing in parallel.

With such a configuration, in a case where the program has been read by the computer and where the computer has executed the processing in accordance with the read program, an operation and advantages equivalent to those of the print-equipment management apparatus in Aspect 43 are attained.

Further, a print-equipment management program in Aspect 75 comprises the print-equipment management program in either of Aspects 71 and 72, wherein:
the circuit configuration information contains information for use in configuring a circuit which realizes a print data processing function that is to be borne by the print equipment in a case where the print equipment and another device share the data processing of the data to-be-print-processed.

With such a configuration, in a case where the program has been read by the computer and where the computer has executed the processing in accordance with the read program, an operation and advantages equivalent to those of the print-equipment management apparatus in Aspect 44 are attained.

Meanwhile, in order to accomplish the object, a print control program in Aspect 76 comprises a print control program which is run by a computer that is communicably connected with a print request apparatus for making a print request, that includes a circuit device having a rewritable hardware region, and that operates as print equipment, comprising:
a program for causing the computer to execute processing which includes a circuit-configuration-information reception step of receiving circuit configuration information for use in configuring a circuit that realizes a print data processing function, and a hardware-region reconfiguration step of reconfiguring the hardware region on the basis of the circuit configuration information received at the circuit-configuration-information reception step.

With such a configuration, in a case where the program has been read by the computer and where the computer has executed the processing in accordance with the read program, an operation and advantages equivalent to those of the print equipment in Aspect 45 are attained.

Further, a print control program in Aspect 77 comprises a print control program which is run by a computer that is communicably-connected with a print request apparatus for making a print request, that includes a circuit device having a rewritable hardware region, and that operates as print equipment, comprising.
a program for causing the computer to execute processing which includes a circuit-configuration-information reception step of receiving circuit configuration information for use in configuring a circuit that realizes a print data processing function, a hardware-region reconfiguration step of reconfiguring the hardware region on the basis of the circuit configuration information received at the circuit-configuration-information reception step, a data-to-be-print-processed reception step of receiving data to-be-print-processed, and a print control step of performing the printing on the basis of print-processed data subjected to data processing by the circuit device.

With such a configuration, in a case where the program has been read by the computer and where the computer has executed the processing in accordance with the read program, an operation and advantages equivalent to those of the print equipment in Aspect 46 are attained.

Further, a print control program in Aspect 78 comprises a print control program which is run by a computer that is communicably connected with a print request apparatus for making a print request, that includes a circuit device having a rewritable hardware region, and that operates as print equipment, comprising:
a program for causing the computer to execute processing which includes a circuit-configuration-information reception step of receiving circuit configuration information for use in configuring a circuit that realizes a print data processing function, a hardware-region reconfiguration step of reconfiguring the hardware region on the basis of the circuit configuration information received at the circuit-configuration-information reception step, a data-to-be-print-processed reception step of receiving data to-be-print-processed, and a print control step of performing the printing on the basis of print-processed data subjected to data processing by the circuit device;
the print control step subjecting the data to-be-print-processed received at the data-to-be-print-processed reception step, to the data processing by the circuit device after the reconfiguration at the hardware-region reconfiguration step has been performed.

With such a configuration, in a case where the program has been read by the computer and where the computer has executed the processing in accordance with the read program, an operation and advantages equivalent to those of the print equipment in Aspect 47 are attained.

Further, a print control program in Aspect 79 comprises the print control program in either of Aspects 77 and 78, wherein:
the hardware-region reconfiguration step transmits a predetermined notification to the print request apparatus when the reconfiguration of the hardware region has been completed.

With such a configuration, in a case where the program has been read by the computer and where the computer has executed the processing in accordance with the read program, an operation and advantages equivalent to those of the print equipment in Aspect 48 are attained.

Further, a print control program in Aspect 80 comprises the print control program in either of Aspects 77 and 78, further comprising:
a program for causing the computer to execute processing which includes a data-to-be-print-processed holding step of holding the data to-be-print-processed received at the data-to-be-print-processed reception step;
the print equipment subjecting the data to-be-print-processed held at the data-to-be-print-processed holding step, to the data processing by the circuit device when the reconfiguration at the hardware-region reconfiguration step has been completed.

With such a configuration, in a case where the program has been read by the computer and where the computer has executed the processing in accordance with the read program, an operation and advantages equivalent to those of the print equipment in Aspect 49 are attained.

Further, a print control program in Aspect 81 comprises the print control program in any of Aspects 77 through 80, wherein:
the circuit configuration information contains information for use in configuring a circuit which realizes a print data processing function specialized for subjecting the data to-be-print-processed to data processing.

With such a configuration, in a case where the program has been read by the computer and where the computer has executed the processing in accordance with the read program, an operation and advantages equivalent to those of the print equipment in Aspect 50 are attained.

Further, a print control program in Aspect 82 comprises the print control program in any of Aspects 77 through 80, wherein:
the circuit configuration information contains information for use in configuring a circuit which realizes a print data processing function that sets a degree of parallelism in a case where a plurality of sets of such data to-be-print-processed are subjected to data processing in parallel, or where parallel-processable parts of a single set of such data to-be-print-processed are subjected to data processing in parallel.

With such a configuration, in a case where the program has been read by the computer and where the computer has executed the processing in accordance with the read program, an operation and advantages equivalent to those of the print equipment in Aspect 51 are attained.

Further, a print control program in Aspect 83 comprises the print control program in any of Aspects 77 through 80, wherein:
the circuit configuration information contains information for use in configuring a circuit which realizes a print data processing function that is to be borne by the print equipment in a case where the print equipment and another device share the data processing of the data to-be-print-processed.

With such a configuration, in a case where the program has been read by the computer and where the computer has executed the processing in accordance with the read program, an operation and advantages equivalent to those of the print equipment in Aspect 52 are attained.

Further, a print control program in Aspect 84 comprises the print control program in any of Aspects 77 through 83, further comprising:
a program for causing the computer to execute processing which includes a circuit-configuration-information registration step of registering the circuit configuration information received at the circuit-configuration-information reception step, in second circuit-configuration-information storage means, a reconfiguration-instruction reception step of receiving the reconfiguration instruction which contains identification information of the circuit configuration information, and a circuit-configuration-information search step of searching the second circuit-configuration-information storage means for the corresponding circuit configuration information on the basis of the identification information which is contained in the reconfiguration instruction received at the reconfiguration-instruction reception step;
the hardware-region reconfiguration step reconfiguring the hardware region on the basis of the circuit configuration information received at the circuit-configuration-information reception step, or the circuit configuration information searched out by the circuit-configuration-information search step.

With such a configuration, in a case where the program has been read by the computer and where the computer has executed the processing in accordance with the read program, an operation and advantages equivalent to those of the print equipment in Aspect 53 are attained.

Further, a print control program in Aspect 85 comprises the print control program in any of Aspects 77 through 83, further comprising:
a program for causing the computer to execute processing which includes a circuit-configuration-information registration step of registering the circuit configuration information received at the circuit-configuration-information reception step, in second circuit-configuration-information storage means, a reconfiguration-instruction reception step of receiving the reconfiguration instruction that contains identification information of the circuit configuration information, a circuit-configuration-information search step of searching the second circuit-configuration-information storage means for the corresponding circuit configuration information on the basis of the identification information that is contained in the reconfiguration instruction received at the reconfiguration-instruction reception step, and a circuit-configuration-information reply step of replying presence or absence of the circuit configuration information to the inquiry from the print request apparatus, on the basis of registered contents of the second circuit-configuration-information storage means;
the hardware-region reconfiguration step reconfiguring the hardware region on the basis of the circuit configuration information received at the circuit-configuration-information reception step, or the circuit configuration information searched out at the circuit-configuration-information search step.

With such a configuration, in a case where the program has been read by the computer and where the computer has executed the processing in accordance with the read program, an operation and advantages equivalent to those of the print equipment in Aspect 54 are attained.

Further, a print control program in Aspect 86 comprises the print control program in any of Aspects 77 through 85, wherein:
the circuit configuration information contains information for use in configuring the circuit which realizes the print data processing function, and information for use in configuring a circuit which realizes a print management function;
the hardware-region reconfiguration step reconfiguring part or the entire hardware region on the basis of the circuit configuration information.

With such a configuration, in a case where the program has been read by the computer and where the computer has executed the processing in accordance with the read program, an operation and advantages equivalent to those of the print equipment in Aspect 55 are attained.

Further, a print control program in Aspect 87 comprises the print control program in Aspect 77, wherein:
the print control program further comprises a program for causing the computer to connect with a print-equipment management apparatus which manages a print data processing function and to execute processing which includes a reconfiguration-instruction transmission step of transmitting to the print-equipment management apparatus the reconfiguration instruction that contains the identification information acquired from the data to-be-print-processed received at the data-to-be-print-processed reception step.

With such a configuration, in a case where the program has been read by the computer and where the computer has executed the processing in accordance with the read program, an operation and advantages equivalent to those of the print equipment in Aspect 56 are attained.

Meanwhile, in order to accomplish the object, a print method in Aspect 88 comprises a print method wherein a print request apparatus which makes a request for printing, and print equipment which includes a circuit device having a rewritable hardware region and which performs the printing in compliance with the print request from the print request apparatus are connected in communicable fashion, so as to perform the printing, comprising:
a circuit-configuration-information transmission step of transmitting circuit configuration information for use in configuring a circuit which realizes a print data processing function, to the print equipment in accordance with the print request, the circuit-configuration-information transmission step being implemented by the print request apparatus; and
a circuit-configuration-information reception step of receiving the circuit configuration information, and a hardware-region reconfiguration step of reconfiguring the hardware region on the basis of the circuit configuration information received at the circuit-configuration-information reception step, the circuit-configuration-information reception step and the hardware-region reconfiguration step being implemented by the print equipment.

Thus, advantages equivalent to those of the print system in Aspect 1 are attained.

Further, a print method in Aspect 89 comprises a print method wherein a print request apparatus which includes circuit-configuration-information storage means for storing therein circuit configuration information for use in configuring a circuit that realizes a print data processing function and which makes a request for printing, and print equipment which includes a circuit device having a rewritable hardware region and which performs the printing in compliance with the print request from the print request apparatus are connected in communicable fashion, so as to perform the printing, comprising:
a circuit-configuration-information transmission step of transmitting the circuit configuration information of the circuit-configuration-information storage means to the print equipment in accordance with the print request, and a data-to-be-print-processed transmission step of transmitting data to-be-print-processed to the print equipment in accordance with the print request, the circuit-configuration-information transmission step and the data-to-be-print-processed transmission step being implemented by the print request apparatus; and
a circuit-configuration-information reception step of receiving the circuit configuration information, a hardware-region reconfiguration step of reconfiguring the hardware region on the basis of the circuit configuration information received at the circuit-configuration-information reception step, a data-to-be-print-processed reception step of receiving the data to-be-print-processed, and a print control step of performing the printing on the basis of print-processed data subjected to data processing by the circuit device, the circuit-configuration-information reception step, the hardware-region reconfiguration step, the data-to-be-print-processed reception step and the print control step being implemented by the print equipment.

Thus, advantages equivalent to those of the print system in Aspect 2 are attained.

Further, a print method in Aspect 90 comprises a print method wherein a print request apparatus which includes circuit-configuration-information storage means for storing therein circuit configuration information for use in configuring a circuit that realizes a print data processing function and which makes a request for printing, and print equipment which includes a circuit device having a rewritable hardware region and which performs the printing in compliance with the print request from the print request apparatus are connected in communicable fashion, so as to perform the printing, comprising:
a circuit-configuration-information transmission step of transmitting the circuit configuration information of the circuit-configuration-information storage means to the print equipment in accordance with the print request, and a data-to-be-print-processed transmission step of transmitting data to-be-print-processed to the print equipment in accordance with the print request, the circuit-configuration-information transmission step and the data-to-be-print-processed transmission step being implemented by the print request apparatus; and
a circuit-configuration-information reception step of receiving the circuit configuration information, a hardware-region reconfiguration step of reconfiguring the hardware region on the basis of the circuit configuration information received at the circuit-configuration-information reception step, a data-to-be-print-processed reception step of receiving the data to-be-print-processed, and a print control step of performing the printing on the basis of print-processed data subjected to data processing by the circuit device, the circuit-configuration-information reception step, the hardware-region reconfiguration step, the data-to-be-print-processed reception step and the print control step being implemented by the print equipment;
the print control step subjecting the data to-be-print-processed received at the data-to-be-print-processed reception step, to the data processing by the circuit device after the reconfiguration at the hardware-region reconfiguration step has been performed.

Thus, advantages equivalent to those of the print system in Aspect 3 are attained.

Further, a print method in Aspect 91 comprises the print method in either of Aspects 89 and 90, wherein:
the hardware-region reconfiguration step transmits a predetermined notification to the print request apparatus when the reconfiguration of the hardware region has been completed; and
the data-to-be-print-processed transmission step transmits the data to-be-print-processed to the print equipment when the predetermined notification has been received.

Thus, advantages equivalent to those of the print system in Aspect 4 are attained.

Further, a print method in Aspect 92
comprises the print method in either of Aspects 89 and 90, further comprising:
a data-to-be-print-processed holding step of holding the data to-be-print-processed received at the data-to-be-print-processed reception step, the data-to-be-print-processed holding step being implemented by the print equipment, wherein the data to-be-print-processed held at the data-to-be-print-processed holding step are subjected to the data processing by the circuit device when the reconfiguration at the hardware-region reconfiguration step has been completed.

Thus, advantages equivalent to those of the print system in Aspect 5 are attained.

Further, a print method in Aspect 93 comprises the print method in any of Aspects 89 through 92, wherein:
the circuit-configuration-information transmission step transmits the circuit configuration information of the circuit-configuration-information storage means to the print equipment when a request for printing has been inputted by an input interface.

Thus, advantages equivalent to those of the print system in Aspect 6 are attained.

Further, a print method in Aspect 94 comprises the print method in any of Aspects 89 through 92, wherein:
the circuit-configuration-information transmission step transmits the circuit configuration information of the circuit-configuration-information storage means to the print equipment when settings concerning printing have been performed by an input interface.

Thus, advantages equivalent to those of the print system in Aspect 7 are attained.

Further, a print method in Aspect 95 comprises the print method in any of Aspects 89 through 94, wherein:
the circuit configuration information contains information for use in configuring a circuit which realizes a print data processing function specialized for subjecting the data to-be-print-processed to data processing.

Thus, advantages equivalent to those of the print system in Aspect 8 are attained.

Further, a print method in Aspect 96 comprises the print method in any of Aspects 89 through 94, wherein:
the circuit configuration information contains information for use in configuring a circuit which realizes a print data processing function that sets a degree of parallelism in a case where a plurality of sets of such data to-be-print-processed are subjected to data processing in parallel, or where parallel-processable parts of a single set of such data to-be-print-processed are subjected to data processing in parallel.

Thus, advantages equivalent to those of the print system in Aspect 9 are attained.

Further, a print method in Aspect 97 comprises the print method in Aspect 96, further comprising:
a status-information acquisition step of acquiring status information which indicates a scale of the hardware region, and a circuit-configuration-information updating step of setting the degree of parallelism of the circuit configuration information on the basis of the status information acquired at the status-information acquisition step, the status-information acquisition step and the circuit-configuration-information updating step being implemented by the print request apparatus;
the circuit-configuration-information transmission step transmitting the circuit configuration information updated at the circuit-configuration-information updating step, to the print equipment.

Thus, advantages equivalent to those of the print system in Aspect 10 are attained.

Further, a print method in Aspect 98 comprises the print method in any of Aspects 89 through 94, wherein:
the circuit configuration information contains information for use in configuring a circuit which realizes a print data processing function that is to be borne by the print equipment in a case where the print equipment and another device share the data processing of the data to-be-print-processed.

Thus, advantages equivalent to those of the print system in Aspect 11 are attained.

Further, a print method in Aspect 99 comprises the print method in Aspect 98, further comprising:
a status-information acquisition step of acquiring status information which indicates a processing load of the print equipment, and status information which indicates a processing load of the other device, and a circuit-configuration-information updating step of updating the circuit configuration information on the basis of the status information items acquired at the status-information acquisition step, the status-information acquisition step and the circuit-configuration-information updating step being implemented by the print request apparatus;
the circuit-configuration-information transmission step transmitting the circuit configuration information updated at the circuit-configuration-information updating step, to the print equipment.

Thus, advantages equivalent to those of the print system in Aspect 12 are attained.

Further, a print method in Aspect 100 comprises the print method in any of Aspects 89 through 99, further comprising:
a transmission-history-information registration step of registering transmission history information which indicates a transmission history of the circuit configuration information transmitted to the print equipment, in transmission-history-information storage means, the transmission-history-information registration step being implemented by the print request apparatus;
the circuit-configuration-information transmission step transmitting a reconfiguration instruction containing identification information of the corresponding circuit configuration information, to the print equipment when it has been decided that the same circuit configuration information as that to be transmitted to the print equipment has already been transmitted to the print equipment, on the basis of the transmission history information of the transmission-history-information storage means; and
a circuit-configuration-information registration step of registering the circuit configuration information received at the circuit-configuration-information reception step, in second circuit-configuration-information storage means, a reconfiguration-instruction reception step of receiving the reconfiguration instruction, and a circuit-configuration-information search step of searching the second circuit-configuration-information storage means for the corresponding circuit configuration information on the basis of the identification information which is contained in the reconfiguration instruction received at the reconfiguration-instruction reception step, the circuit-configuration-information registration step, the reconfiguration-instruction reception step and the circuit-configuration-information search step being implemented by the print equipment;
the hardware-region reconfiguration-step reconfiguring the hardware region on the basis of the circuit configuration information received at the circuit-configuration-information reception step, or the circuit configuration information searched out at the circuit-configuration-information search step.

Thus, advantages equivalent to those of the print system in Aspect 13 are attained.

Further, a print method in Aspect 101 comprises the print method in any of Aspects 89 through 99, further comprising:
a circuit-configuration-information inquiry step of inquiring of the print equipment about the circuit configuration information which the print equipment holds, the circuit-configuration-information inquiry step being implemented by the print request apparatus;
the circuit-configuration-information transmission step transmitting a reconfiguration instruction containing identification information of the corresponding circuit configuration information, to the print equipment when it has been decided that the same circuit configuration information as that to be transmitted to the print equipment has already been transmitted to the print equipment, on the basis of a result of the inquiry at the circuit-configuration-information inquiry step; and
a circuit-configuration-information registration step of registering the circuit configuration information received at the circuit-configuration-information reception step, in second circuit-configuration-information storage means, a reconfiguration-instruction reception step of receiving the reconfiguration instruction, a circuit-configuration-information search step of searching the second circuit-configuration-information storage means for the corresponding circuit configuration information on the basis of the identification information which is contained in the reconfiguration instruction received at the reconfiguration-instruction reception step, and a circuit-configuration-information reply step of replying presence or absence of the circuit configuration information to the inquiry from the print request apparatus, on the basis of registered contents of the second circuit-configuration-information storage means, the circuit-configuration-information registration step, the reconfiguration-instruction reception step, the circuit-configuration-information search step and the circuit-configuration-information reply step being implemented by the print equipment;
the hardware-region reconfiguration step reconfiguring the hardware region on the basis of the circuit configuration information received at the circuit-configuration-information reception step, or the circuit configuration information searched out at the circuit-configuration-information search step.

Thus, advantages equivalent to those of the print system in Aspect 14 are attained.

Further, a print method in Aspect 102 comprises the print method in any of Aspects 89 through 101, wherein:
the circuit configuration information contains information for use in configuring the circuit which realizes the print data processing function, and information for use in configuring a circuit which realizes a print management function; and
the hardware-region reconfiguration step reconfigures part or the entire hardware region on the basis of the circuit configuration information.

Thus, advantages equivalent to those of the print system in Aspect 15 are attained.

Further, a print method in Aspect 103 comprises a print method wherein a print request apparatus which makes a request for printing, print equipment which includes a circuit device having a rewritable hardware region and which performs the printing in compliance with the print request from the print request apparatus, and a print-equipment management apparatus which manages a print data processing function are connected in communicable fashion, so as to perform the printing, comprising:
a circuit-configuration-information transmission step of transmitting circuit configuration information for use in configuring a circuit which realizes the print data processing function, to the print equipment in accordance with the print request, the circuit-configuration-information transmission step being implemented by the print-equipment management apparatus; and
a circuit-configuration-information reception step of receiving the circuit configuration information, and a hardware-region reconfiguration step of reconfiguring the hardware region on the basis of the circuit configuration information received at the circuit-configuration-information reception step, the circuit-configuration-information reception step and the hardware-region reconfiguration step being implemented by the print equipment.

Thus, advantages equivalent to those of the print system in Aspect 16 are attained.

Further, a print method in Aspect 104 comprises a print method wherein a print request apparatus which includes circuit-configuration-information storage means for storing therein circuit configuration information for use in configuring a circuit that realizes a print data processing function and which makes a request for printing, print equipment which includes a circuit device having a rewritable hardware region and which performs the printing in compliance with the print request from the print request apparatus, and a print-equipment management apparatus which manages the print data processing function are connected in communicable fashion, so as to perform the printing, comprising:
a circuit-configuration-information transmission step of transmitting the circuit configuration information of the circuit-configuration-information storage means to the print equipment in accordance with the print request, the circuit-configuration-information transmission step being implemented by the print-equipment management apparatus;
a data-to-be-print-processed transmission step of transmitting data to-be-print-processed to the print equipment in accordance with the print request, the data-to-be-print-processed transmission step being implemented by the print request apparatus; and
a circuit-configuration-information reception step of receiving the circuit configuration information, a hardware-region reconfiguration step of reconfiguring the hardware region on the basis of the circuit configuration information received at the circuit-configuration-information reception step, a data-to-be-print-processed reception step of receiving the data to-be-print-processed, and a print control step of performing the printing on the basis of print-processed data subjected to data processing by the circuit device, the circuit-configuration-information reception step, the hardware-region reconfiguration step, the data-to-be-print-processed reception step and the print control step being implemented by the print equipment, wherein the data to-be-print-processed received at the data-to-be-print-processed reception step are subjected to the data processing by the circuit device after the reconfiguration at the hardware-region reconfiguration step has been performed.

Thus, advantages equivalent to those of the print system in Aspect 17 are attained.

Further, a print method in Aspect 105 comprises a print method wherein a print request apparatus which includes circuit-configuration-information storage means for storing therein circuit configuration information for use in configuring a circuit that realizes a print data processing function and which makes a request for printing, print equipment which includes a circuit device having a rewritable hardware region and which performs the printing in compliance with the print request from the print request apparatus, and a print-equipment management apparatus which manages the print data processing function are connected in communicable fashion, so as to perform the printing, comprising:
a circuit-configuration-information transmission step of transmitting the circuit configuration information of the circuit-configuration-information storage means to the print equipment in accordance with the print request, the circuit-configuration-information transmission step being implemented by the print-equipment management apparatus;
a data-to-be-print-processed transmission step of transmitting data to-be-print-processed to the print equipment in accordance with the print request, the data-to-be-print-processed transmission step being implemented by the print request apparatus; and
a circuit-configuration-information reception step of receiving the circuit configuration information, a hardware-region reconfiguration step of reconfiguring the hardware region on the basis of the circuit configuration information received at the circuit-configuration-information reception step, a data-to-be-print-processed reception step of receiving the data to-be-print-processed, and a print control step of performing the printing on the basis of print-processed data subjected to data processing by the circuit device, the circuit-configuration-information reception step, the hardware-region reconfiguration step, the data-to-be-print-processed reception step and the print control step being implemented by the print equipment;
the print control step subjecting the data to-be-print-processed received at the data-to-be-print-processed reception step, to the data processing by the circuit device after the reconfiguration at the hardware-region reconfiguration step has been performed.

Thus, advantages equivalent to those of the print system in Aspect 18 are attained.

Further, a print method in Aspect 106 comprises the print method in either of Aspects 104 and 105, further comprising:
a reconfiguration-instruction transmission step of transmitting a reconfiguration instruction which contains identification information of the circuit configuration information, to the print-equipment management apparatus in accordance with the print request, the reconfiguration-instruction transmission step being implemented by the print request apparatus; and
a reconfiguration-instruction reception step of receiving the reconfiguration instruction, and a circuit-configuration-information search step of searching the circuit-configuration-information storage means for the corresponding circuit configuration information on the basis of the identification information which is contained in the reconfiguration instruction received at the reconfiguration-instruction reception step, the reconfiguration-instruction reception step and the circuit-configuration-information search step being implemented by the print-equipment management apparatus;
the circuit-configuration-information transmission step transmitting the circuit configuration information searched out at the circuit-configuration-information search step, to the print equipment.

Thus, advantages equivalent to those of the print system in Aspect 19 are attained.

Further, a print method in Aspect 107 comprises the print method in either of Aspects 104 and 105, wherein:
the data-to-be-print-processed transmission step transmits the identification information of the circuit configuration information as is contained in the data to-be-print-processed, to the print equipment;
the print equipment further implements a reconfiguration-instruction transmission step of transmitting to the print-equipment management apparatus the reconfiguration instruction which contains the identification information acquired from the data to-be-print-processed received at the data-to-be-print-processed reception step;
the print-equipment management apparatus further implements a reconfiguration-instruction reception step of receiving the reconfiguration instruction, and a circuit-configuration-information search step of searching the circuit-configuration-information storage means for the corresponding circuit configuration information on the basis of the identification information which is contained in the reconfiguration instruction received at the reconfiguration-instruction reception step; and
the circuit-configuration-information transmission step transmits the circuit configuration information searched out at the circuit-configuration-information search step, to the print equipment.

Thus, advantages equivalent to those of the print system in Aspect 20 are attained.

Further, a print method in Aspect 108 comprises the print method in any of Aspects 104 through 107, wherein:
the hardware-region reconfiguration step transmits a predetermined notification to the print request apparatus when the reconfiguration of the hardware region has been completed; and
the data-to-be-print-processed transmission step transmits the data to-be-print-processed to the print equipment when the predetermined notification has been received.

Thus, advantages equivalent to those of the print system in Aspect 21 are attained.

Further, a print method in Aspect 109 comprises the print method in any of Aspects 104 through 107, further comprising:
a data-to-be-print-processed holding step of holding the data to-be-print-processed received at the data-to-be-print-processed reception step, the data- to-be-print-processed holding step being implemented by the print equipment, wherein the data to-be-print-processed held at the data-to-be-print-processed holding step are subjected to the data processing by the circuit device when the reconfiguration at the hardware-region reconfiguration step has been completed.

Thus, advantages equivalent to those of the print system in Aspect 22 are attained.

Further, a print method in Aspect 110 comprises the print method in any of Aspects 104 through 109, wherein:
the circuit configuration information contains information for use in configuring a circuit which realizes a print data processing function specialized for subjecting the data to-be-print-processed to data processing.

Thus, advantages equivalent to those of the print system in Aspect 23 are attained.

Further, a print method in Aspect 111 comprises the print method in any of Aspects 104 through 109, wherein:
the circuit configuration information contains information for use in configuring a circuit which realizes a print data processing function that sets a degree of parallelism in a case where a plurality of sets of such data to-be-print-processed are subjected to data processing in parallel, or where parallel-processable parts of a single set of such data to-be-print-processed are subjected to data processing in parallel.

Thus, advantages equivalent to those of the print system in Aspect 24 are attained.

Further, a print method in Aspect 112 comprises the print method in any of Aspects 104 through 109, wherein:
the circuit configuration information contains information for use in configuring a circuit which realizes a print data processing function that is to be borne by the print equipment in a case where the print equipment and another device share the data processing of the data to-be-print-processed.

Thus, advantages equivalent to those of the print system in Aspect 25 are attained.

### BRIEF DESCRIPTION OF THE DRAWINGS

FIG. 1 is a functional block diagram showing the outline of the functions of a network system to which the present invention is to be applied.

FIG. 2 is a diagram showing the contents of intermediate print data and those of reconfigurable data.

FIG. 3 is a block diagram showing the hardware architecture of a host terminal 100.

FIG. 4 is a diagram showing the data structure of transmission history information.

FIG. 5 is a flow chart showing a print request process.

FIG. 6 is a diagram showing the data structure of a reconfigurable instruction.

FIG. 7 is a block diagram showing the hardware architecture of a printer 200.

FIG. 8 is a flow chart showing a printer control process.

FIG. 9 is a diagram for explaining the operation of an embodiment.

FIG. 10 is a functional block diagram showing the outline of the functions of a network system to which the invention is to be applied.

FIG. 11 is a flow chart showing a print request process.

FIG. 12 is a flow chart showing a printer control process.

FIG. 13 is a block diagram showing the hardware architecture of a printer management server 300.

FIG. 14 is a flow chart showing a reconfigurable-data offer process.

FIG. 15 is a diagram for explaining the operation of an embodiment.

FIG. 16 is a flow chart showing a reconfigurable-data transmission process.

FIG. 17 is a flow chart showing a reconfigurable-data transmission process.

FIG. 18 is a flow chart showing a reconfigurable-data existence reply process.

FIG. 19 is a diagram showing a case where a host terminal 100 transmits a reconfigurable instruction to a printer management server 300.

FIGS. 20(a) and 20(b) are diagrams showing the data structures of a data set.

FIG. 21 is a diagram showing a storage medium and its data structures.

FIG. 22 is a diagram showing a storage medium and its data structures.

### DETAILED DESCRIPTION

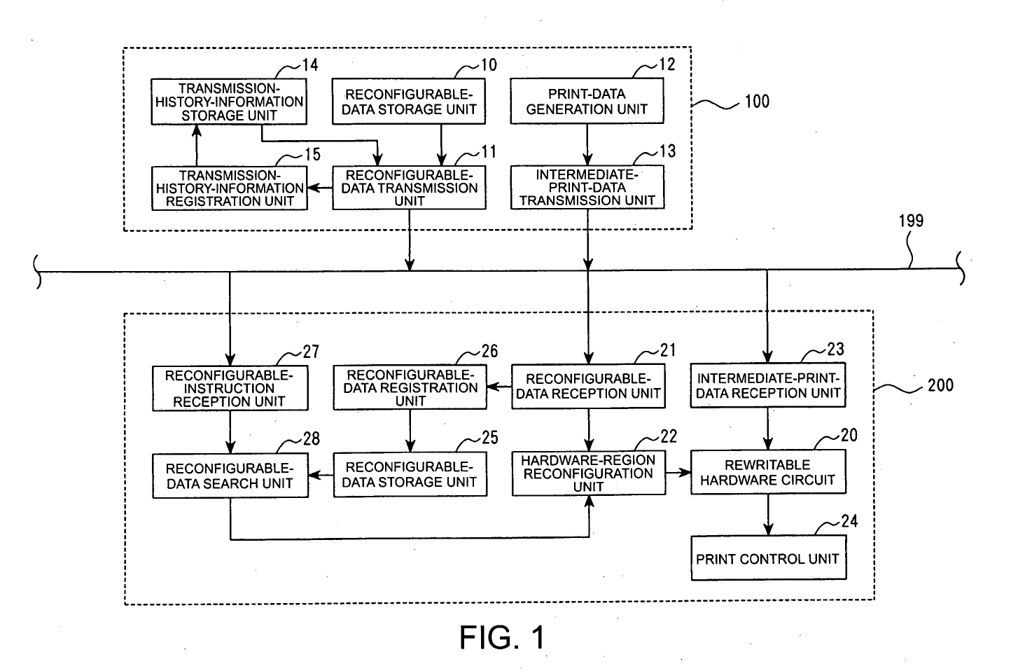

Now, the first embodiment of the present invention will be described with reference to the drawings. FIGS. 1 through 9 are diagrams showing the first embodiment of each of a print system, a print request apparatus, a print-equipment management apparatus, print equipment, a print-equipment management program as well as a print control program, and a print method according to the invention.

This embodiment is such that each of the print system, print request apparatus, print-equipment management apparatus, print equipment, print-equipment management program as well as print control program, and print method according to the invention is applied to a case where, as shown in FIG. 1, printing is done by dynamically altering the hardware functions of a printer 200 in compliance with a print request from a host terminal 100.

First, the outline of the functions of a network system to which the invention is to be applied will be described with reference to FIG. 1.

FIG. 1 is a functional block diagram showing the outline of the functions of the network system to which the invention is to be applied.

As shown in FIG. 1, the host terminal 100 which is placed for use by a user, and the printer 200 which performs printing in compliance with a print request from the host terminal 100 are connected to a network 199. Incidentally, only one host terminal 100 is illustrated in order to facilitate understanding of the invention, but in actuality, a large number of host terminals 100 are connected to the network 199.

The host terminal 100 is configured having a reconfigurable-data storage unit 10 which stores therein reconfigurable data for use in the configuration of a circuit for realizing a print data processing function, a reconfigurable-data transmission unit 11 which transmits the reconfigurable data of the reconfigurable-data storage unit 10 to the printer 200 in accordance with the print request, a print-data generation unit 12 which generates intermediate print data on the basis of document data, an intermediate-print-data transmission unit 13 which transmits the intermediate print data generated by the print-data generation unit 12, to the printer 200 in accordance with the print request, a transmission-history-information storage unit 14, and a transmission-history-information registration unit 15 which registers transmission history information indicating the transmission history of the reconfigurable data, in the transmission-history-information storage unit 14.

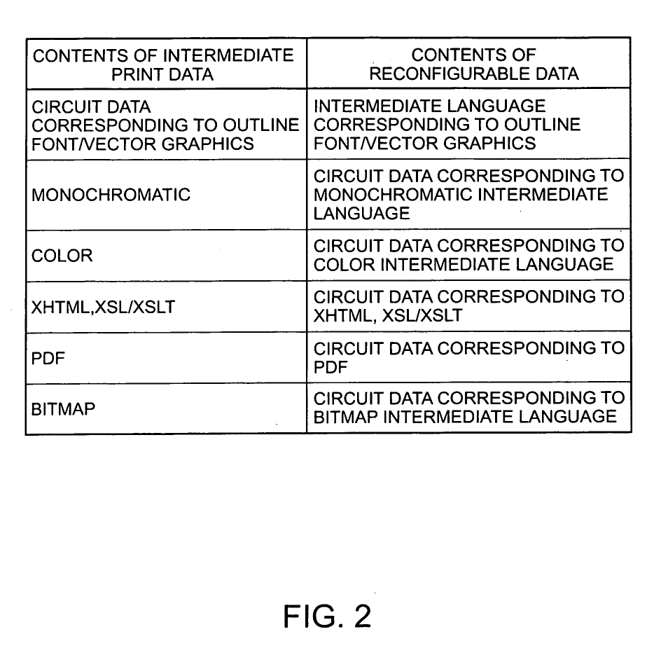

FIG. 2 is a diagram showing the contents of the intermediate print data and those of the reconfigurable data.

The reconfigurable-data storage unit 10 stores therein the reconfigurable data which are employed for the configuration of the circuit for realizing the print data processing function as is specialized for the data processing of the intermediate print data generated by the print-data generation unit 12. In the example of FIG. 2, the reconfigurable data to be stored are employed for the configuration of the circuit according to which, in a case where the intermediate print data generated by the print data generation unit 12 are described by outline font/vector graphics, they are interpreted, whereupon print data printable by the printer 200 (hereinbelow, simply termed “print data”) are generated on the basis of an interpreted result. Likewise, the reconfigurable data to be stored are employed for the configuration of the circuit according to which, in a case where the intermediate print data generated by the print data generation unit 12 are described by a monochromatic intermediate language, a color intermediate language, the XHTML (Xml-based Hyper Text Markup Language), the XML (extensible Markup Language)/XSLT (extensible Stylesheet Language Transformations), the PDF (Portable Document Format), or a bitmap intermediate language, the corresponding intermediate language is interpreted, whereupon print data are generated on the basis of an interpreted result. Here, the “circuit for realizing the print data processing function” is intended to mean a circuit in which the intermediate print data including image data with a gradation, such as bitmap or JPEG, text data, vector graphics data, or the like data are subjected to rendering, a color conversion process or a binarization process. Also included is a circuit which performs a process for separately printing different dot sizes, or a process for making stripes unobtrusive, the stripes being principally ascribable to the deviation of the nozzles of print heads.

The reconfigurable-data transmission unit 11 decides whether or not reconfigurable data identical to those to be transmitted to the printer 200 have already been transmitted to the printer 200, on the basis of the transmission history information of the transmission-history-information storage unit 14. Upon deciding that the identical reconfigurable data are transmitted for the first time, the transmission unit 11 transmits the reconfigurable data of the reconfigurable-data storage unit 10 to the printer 200. On the other hand, upon deciding that the identical reconfigurable data have already been transmitted, the transmission unit 11 transmits to the printer 200 a reconfigurable instruction which contains a reconfigurable data ID for identifying the reconfigurable data.

As shown in FIG. 1, the printer 200 is configured having a hardware circuit 20 which has a rewritable hardware region, a reconfigurable-data reception unit 21 which receives the reconfigurable data, a hardware-region reconfiguration unit 22 which reconfigures the hardware region of the hardware circuit 20 on the basis of the reconfigurable data received by the reconfigurable-data reception unit 21, an intermediate-print-data reception unit 23 which receives the intermediate print data, and a print control unit 24 which performs printing on the basis of the print data subjected to the data processing in the hardware circuit 20.

The printer 200 is configured further having a reconfigurable-data storage unit 25, a reconfigurable-data registration unit 26 which registers the reconfigurable data received by the reconfigurable-data reception unit 21, in the reconfigurable-data storage unit 25, a reconfigurable-instruction reception unit 27 which receives the reconfigurable instruction, and a reconfigurable-data search unit 28 which searches the reconfigurable-data storage unit 25 for the corresponding reconfigurable data on the basis of the reconfigurable data ID that is contained in the reconfigurable instruction received by the reconfigurable-instruction reception unit 27.

The hardware-region reconfiguration unit 22 reconfigures part or the entire hardware region of the hardware circuit 20 on the basis of the reconfigurable data received by the reconfigurable-data reception unit 21, or the reconfigurable data searched out by the reconfigurable-data search unit 28.

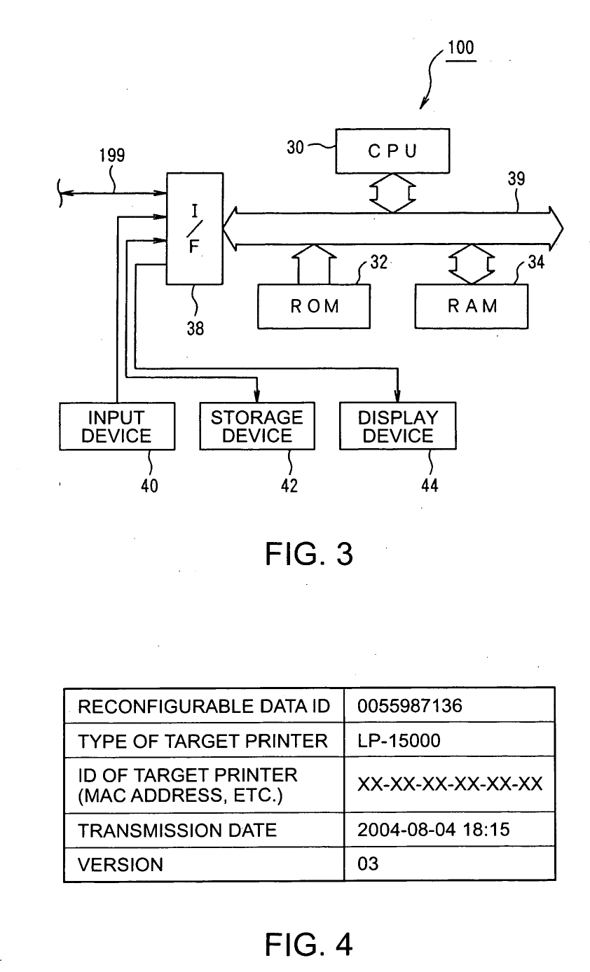

Next, the configuration of the host terminal 100 will be described in detail with reference to FIGS. 3 through 6.

FIG. 3 is a block diagram showing the hardware architecture of the host terminal 100.

As shown in FIG. 3, the host terminal 100 is configured of a CPU 30 which controls arithmetics and the entire system on the basis of a control program, a ROM 32 in which the control program of the CPU 30, etc. are stored in predetermined areas beforehand, a RAM 34 which serves to store therein data read out of the ROM 32, etc. and arithmetic results required in the arithmetic processes of the CPU 30, and an I/F 38 through which data are inputted from and outputted to external devices. These constituents are connected to one another and in a manner to be capable of transferring data, by a bus 39 which is composed of signal lines for transferring the data.

Connected to the I/F 38 are the external devices being an input device 40 which includes a keyboard, a mouse, etc. capable of inputting data as human interfaces, a storage device 42 in which data, tables, etc. are stored as files, and a display device 44 which displays a screen on the basis of an image signal, and also a signal line which serves to connect the host terminal 100 to the network 199.

The storage device 42 is configured as the reconfigurable-data storage unit 10. The reconfigurable data are stored in association with their reconfigurable data IDs.

FIG. 4 is a diagram showing the data structure of the transmission history information.

The storage device 42 is configured as the transmission-history-information storage unit 14. As shown in FIG. 4, the transmission history information is formed of information items which contain the reconfigurable data ID, the type of the printer 200 for applying the reconfigurable data thereto, the ID (MAC address) of the printer 200 for applying the reconfigurable data thereto, a transmission date and hour at which the reconfigurable data were transmitted, and the version of the reconfigurable data.

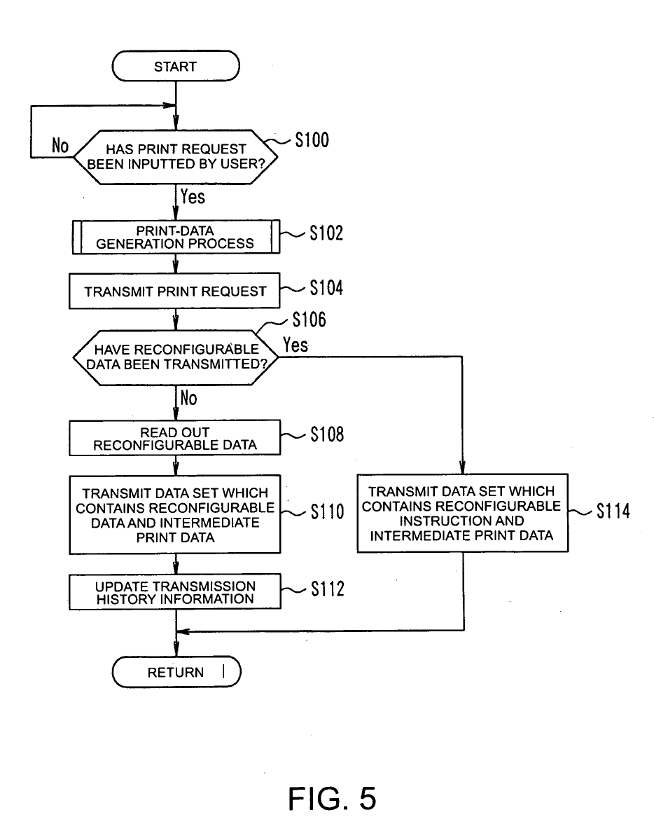

The CPU 30 is configured of a microprocessing unit (MPU) or the like. It activates a predetermined program stored in the predetermined area of the ROM 32, so as to execute a print request process shown in the flow chart of FIG. 5, in accordance with the program.

FIG. 5 is the flow chart showing the print request process.

The print request process is a process which is incarnated as the reconfigurable-data transmission unit 11, print-data generation unit 12, intermediate-print-data transmission unit 13 and transmission-history-information registration unit 15. When this process is executed in the CPU 30, it first proceeds to step S100 as shown in FIG. 5.

At step S100, it is decided whether or not a request for printing has been inputted from the input device 40 by the user. Subject to the decision that the request for printing has been inputted by the user (“Yes”), the routine proceeds to step S102, but in the other case (“No”), the routine stands-by at step S100 until the request for printing is inputted by the user.

At step S102, a print-data generation process in which document data edited by a document editing application are converted into intermediate print data of predetermined format is executed, whereupon the routine proceeds to step S104 at which the print request is transmitted to the printer 200, followed by step S106.

At step S106, whether or not reconfigurable data identical to those to be transmitted to the printer 200 have already been transmitted to the printer 200 is decided on the basis of the transmission history information of the storage device 42. Subject to the decision that the identical reconfigurable data are transmitted for the first time (“No”), the routine proceeds to step S108 at which the reconfigurable data are read out of the storage device 42, followed by step S110.

At step S110, a data set which contains the reconfigurable data read out at step S108 and the intermediate print data generated at step S102 is transmitted to the printer 200, whereupon the routine proceeds to step S112 at which the transmission history information of the storage device 42 is updated. Then, the series of processing steps are ended, and the original process is returned to.

On the other hand, when it has been decided at step S106 that the identical reconfigurable data have already been transmitted (“Yes”), the routine proceeds to step S114 at which a data set that contains a reconfigurable instruction containing a reconfigurable data ID, and the intermediate print data generated at step S102 is transmitted to the printer 200.

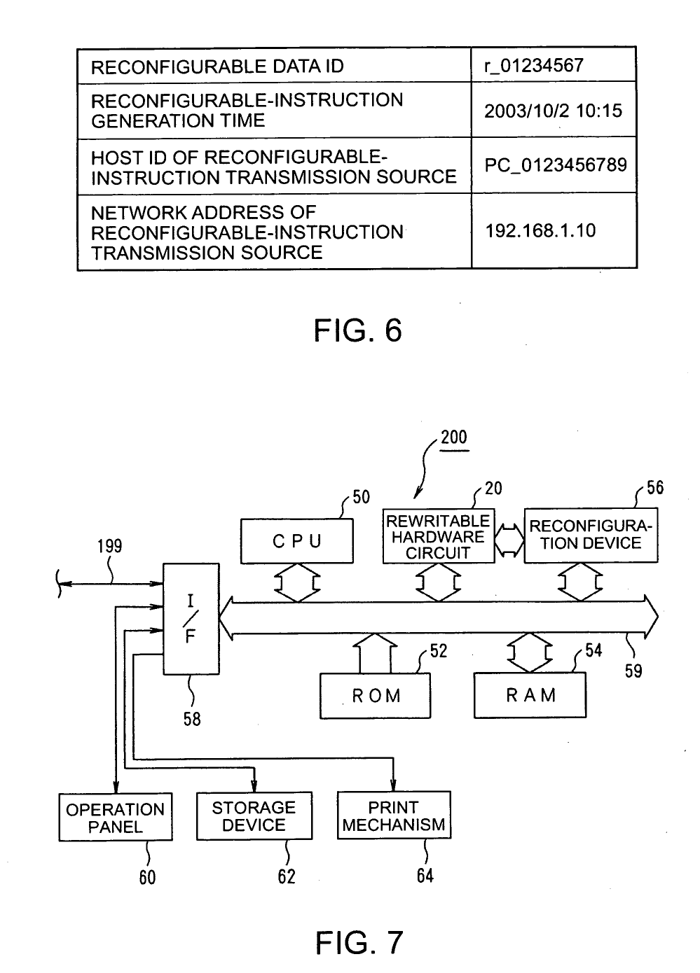

FIG. 6 is a diagram showing the data structure of the reconfigurable instruction.

As shown in FIG. 6, the reconfigurable instruction is formed containing the reconfigurable data ID for identifying the reconfigurable data, a time at which the reconfigurable instruction was generated, the host ID of the host terminal 100 which transmits the reconfigurable instruction, and the network address of the host terminal 100 which transmits the reconfigurable instruction. In the example of FIG. 6, the reconfigurable instruction is formed containing “r_{—}01234567” as the reconfigurable data ID, “2003/10/2 10:15” as the reconfigurable-instruction generation time, “PC_{—}0123456789” as the host ID, and “192.168.1.10” as the network address.

When the transmission of the data set has been completed at step S114, the series of processing steps are ended, and the original process is returned to.

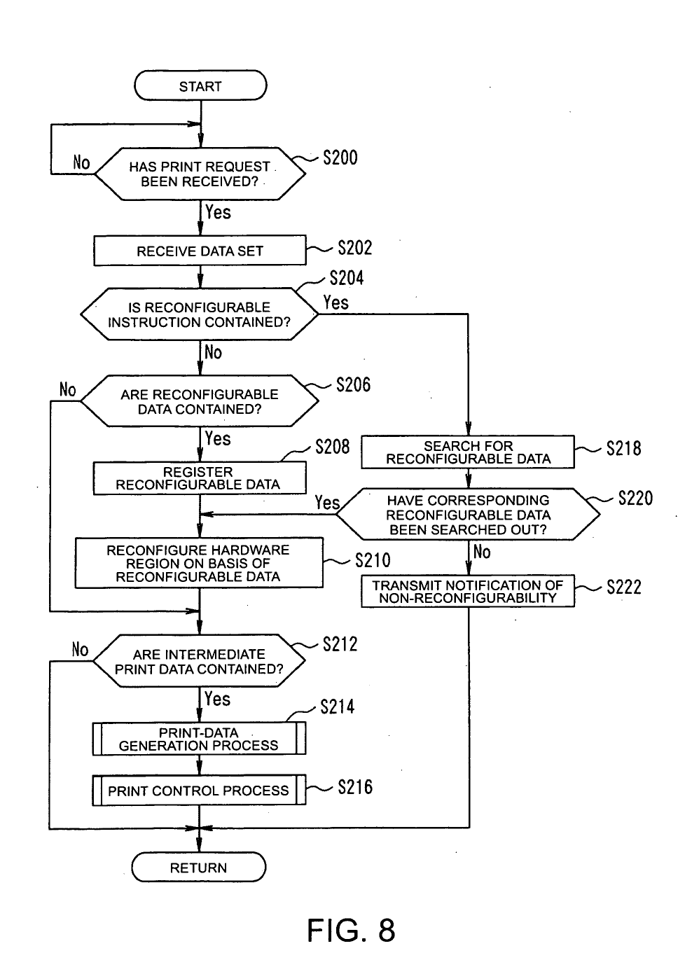

Next, the configuration of the printer 200 will be described in detail with reference to FIGS. 7 and 8.

FIG. 7 is a block diagram showing the hardware architecture of the printer 200.

As shown in FIG. 7, the printer 200 is configured of a CPU 50 which controls arithmetics and the entire system on the basis of a control program, a ROM 52 in which the control program of the CPU 50, etc. are stored in predetermined areas beforehand, a RAM 54 which serves to store therein data read out of the ROM 52, etc. and arithmetic results required in the arithmetic processes of the CPU 50, the hardware circuit 20, a reconfiguration device 56 which rewrites the hardware region of the hardware circuit 20, and an I/F 58 through which data are inputted from and outputted to external devices. These constituents are connected to one another and in a manner to be capable of transferring data, by a bus 59 which is composed of signal lines for transferring the data.

Connected to the I/F 58 are the external devices being an operation panel 60 which is capable of inputting data as a human interface, a storage device 62 in which data, tables, etc. are stored as files, and a print mechanism 64 which includes a head drive unit and other mechanisms necessary for printing, and also a signal line which serves to connect the printer 200 to the network 199.

The storage device 62 is configured as the reconfigurable-data storage unit 25. The reconfigurable data are registered in association with their reconfigurable data IDs.

The CPU 50 is configured of a microprocessing unit (MPU) or the like. It activates a predetermined program stored in the predetermined area of the ROM 52, so as to execute a printer control process shown in the flow chart of FIG. 8, in accordance with the program.

FIG. 8 is the flow chart showing the printer control process.

The printer control process is a process which is incarnated as the reconfigurable-data reception unit 21, hardware-region reconfiguration unit 22, intermediate-print-data reception unit 23, print control unit 24, reconfigurable-data registration unit 26, reconfigurable-instruction reception unit 27 and reconfigurable-data search unit 28. When this process is executed in the CPU 50, it first proceeds to step S200 as shown in FIG. 8.

At step S200, whether or not a print request has been received is decided. Subject to the decision that the print request has been received (“Yes”), the routine proceeds to step S202, but in the other case (“No”), the routine stands-by at step S200 until the print request is received.

At step S202, a data set is received, whereupon the routine proceeds to step S204 at which whether or not a reconfigurable instruction is contained in the received data set is decided. Subject to the decision that the reconfigurable instruction is not contained (“Yes”), the routine proceeds to step S206.

At step S206, whether or not reconfigurable data are contained in the received data set is decided. Subject to the decision that the reconfigurable data are contained (“Yes”), the routine proceeds to step S208 at which the received reconfigurable data are registered in the storage device 62 in association with their reconfigurable data ID. The routine proceeds to step S210 at which part or the entire hardware region of the hardware circuit 20 is reconfigured by the reconfiguration device 56 on the basis of the reconfigurable data received or searched out, followed by step S212.

At step S212, whether or not intermediate print data are contained in the received data set is decided. Subject to the decision that the intermediate print data are contained (“Yes”), the routine proceeds to step S214 at which a print-data generation process for converting the received intermediate print data into print data by the hardware circuit 20 is executed. The routine proceeds to step S216 at which a print control process for performing printing by the print mechanism 64 on the basis of the print data subjected to the data processing in the hardware circuit 20 is executed. Then, the series of processing steps are ended, and the original process is returned to.

On the other hand, when it has been decided at step S212 that the intermediate print data are not contained in the received data set (“No”), the series of processing steps are ended, and the original process is returned to.

Also, when it has been decided at step S206 that the reconfigurable data are not contained in the received data set (“No”), the routine proceeds to step S212.

Further, when it has been decided at step S204 that the reconfigurable instruction is contained in the received data set (“Yes”), the routine proceeds to step S218 at which the storage device 62 is searched for the corresponding reconfigurable data on the basis of a reconfigurable data ID contained in the received reconfigurable instruction. The routine proceeds to step S220 at which whether or not the corresponding reconfigurable data have been searched out is decided. Subject to the decision that the corresponding reconfigurable data have been searched out (“Yes”), the routine proceeds to step S210.

On the other hand, when it has been decided at step S220 that the corresponding reconfigurable data have not been searched out (“No”), the routine proceeds to step S222 at which the notification of non-reconfigurability indicating that the reconfiguration of the hardware circuit 20 is impossible is transmitted to the host terminal 100. Then, the series of processing steps are ended, and the original process is returned to.

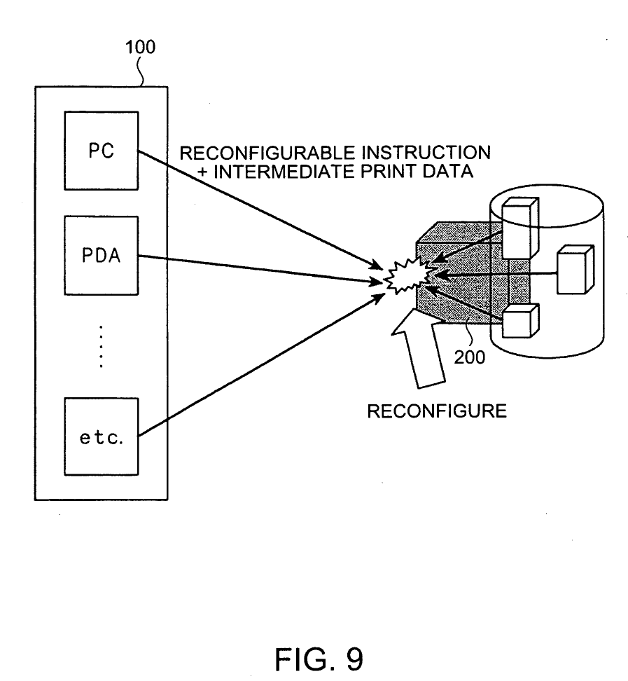

Next, the operation of this embodiment will be described with reference to FIG. 9.

FIG. 9 is a diagram for explaining the operation of this embodiment.

First, there will be described a case where the printer 200 performs printing for the first time.

In the host terminal 100, as shown in FIG. 9, when a request for the printing has been inputted by the user, document data are converted into intermediate print data, and a print request is transmitted to the printer 200, via steps S102 and S104. Subsequently, whether or not reconfigurable data identical to those to be transmitted to the printer 200 have already been transmitted to the printer 200 is decided on the basis of the transmission history information of the storage device 42, via step S106. As a result, it is decided that the identical reconfigurable data are transmitted for the first time, because of the first printing. Via steps S108 and S110, therefore, the reconfigurable data are read out, and a data set which contains the read-out reconfigurable data and the generated intermediate print data is transmitted to the printer 200. Besides, the transmission history information of the storage device 42 is updated via step S112.

In the printer 200, when the print request has been received, the data set is received via step S202. Since the reconfigurable data are contained in the received data set, the received reconfigurable data are registered, and part or the entire hardware region of the hardware circuit 20 is reconfigured by the reconfiguration device 56 on the basis of the received reconfigurable data, via steps S208 and S210. Besides, the received intermediate print data are converted into print data by the hardware circuit 20, and the printing is done by the print mechanism 64 on the basis of the print data subjected to the data processing by the hardware circuit 20, via steps S214 and S216.

Secondly, there will be described a case where the printer 200 performs second printing.

In the host terminal 100, as shown in FIG. 9, when a request for the printing has been inputted by the user, document data are converted into intermediate print data, and a print request is transmitted to the printer 200, via steps S102 and S104. Subsequently, whether or not reconfigurable data identical to those to be transmitted to the printer 200 have already been transmitted to the printer 200 is decided on the basis of the transmission history information of the storage device 42, via step S106. As a result, it is decided that the identical reconfigurable data have already been transmitted, because of the second printing. Via step S114, therefore, a data set which contains a reconfigurable instruction containing a reconfigurable data ID, and the generated intermediate print data is transmitted to the printer 200.

In the printer 200, when the print request has been received, the data set is received via step S202. Since the reconfigurable instruction is contained in the received data set, the storage device 62 is searched for the corresponding reconfigurable data on the basis of the reconfigurable data ID contained in the received configurable instruction, via step S218. When the corresponding reconfigurable data have been searched out as the result, part or the entire hardware region of the hardware circuit 20 is reconfigured by the reconfiguration device 56 on the basis of the searched-out reconfigurable data via step S210. Besides, the received intermediate print data are converted into print data by the hardware circuit 20, and the printing is done by the print mechanism 64 on the basis of the print data subjected to the data processing by the hardware circuit 20, via steps S214 and S216.

By the way, in a case where the corresponding reconfigurable data have failed to be searched out, the printer 200 transmits the notification of non-reconfigurability to the host terminal 100 via step S222.

In the host terminal 100, when the notification of non-reconfigurability has been received, a data set containing the reconfigurable data is transmitted to the printer 200 as in case of, for example, performing printing for the first time.

In this way, in this embodiment, the host terminal 100 transmits the reconfigurable data of the storage device 42 and the generated intermediate print data to the printer 200 in accordance with the print request. Upon receiving the reconfigurable data and the intermediate print data, the printer 200 reconfigures the hardware region of the hardware circuit 20 on the basis of the received reconfigurable data, and it converts the received intermediate print data into the print data by the hardware circuit 20, so as to perform the printing on the basis of the print data subjected to the data processing by the hardware circuit 20.

Thus, after the hardware region of the hardware circuit 20 of the printer 200 has been reconfigured in accordance with the print request, the intermediate print data relevant to the print request are subjected to the data processing by the hardware circuit 20, and hence, the print data processing relevant to the print request can be executed comparatively appropriately. As compared with the prior art, accordingly, this embodiment can efficiently subject intermediate print data relevant to individual print requests, to data processing even when the plurality of print requests exist simultaneously.

Moreover, the host terminal 100 may hold the reconfigurable data suited to the format of the intermediate print data which it transmits to the printer 200, and the printer 200 need not hold the reconfigurable data. Therefore, the memory capacities of the host terminal 100 and printer 200 are not oppressed considerably, and this embodiment can relieve a memory load as compared with the prior art.

Further, even when optimal sharing proportions are set for individual host terminals 100 in a case where the plurality of host terminals 100 of different processabilities utilize a single printer 200, the printer 200 can cope with the different formats of intermediate print data which are transmitted from the individual host terminals 100, merely in such a way that the respective host terminals 100 hold reconfigurable data suited to the formats of the intermediate print data which they transmit to the printer 200. Accordingly, the circuit of the printer 200 becomes smaller in scale than in case of providing a hardware circuit 20 which realizes print data processing functions capable of coping with the respective formats.

Still further, in this embodiment, the host terminal 100 transmits the reconfigurable data of the storage device 42 to the printer 200 when the request for printing has been inputted by the user.

Thus, the hardware region of the hardware circuit 20 of the printer 200 is reconfigured at a time at which the user has made the request for printing, so that intermediate print data relevant to individual print requests can be efficiently subjected to data processing even when the plurality of print requests exist simultaneously.

Further, in this embodiment, the host terminal 100 registers the transmission history information indicating the transmission history of reconfigurable data, in the storage device 42, and when it has decided on the basis of the transmission history information of the storage device 42 that the reconfigurable data identical to those to be transmitted to the printer 200 have already been transmitted to the printer 200, it transmits the reconfigurable instruction containing the reconfigurable data ID, to the printer 200. On the other hand, the printer 200 registers the received reconfigurable data in the storage device 62, and when it has received the reconfigurable instruction, it searches the storage device 62 for the corresponding reconfigurable data on the basis of the reconfigurable data ID contained in the received reconfigurable instruction, and it reconfigures the hardware region of the hardware circuit 20 on the basis of the reconfigurable data searched out.

Thus, in the host terminal 100, the identical reconfigurable data are not repeatedly transmitted to the printer 200, so that the communication traffic between the host terminal 100 and the printer 200 can be reduced. Besides, in the printer 200, in the case where the reconfigurable instruction has been received, the hardware region of the hardware circuit 20 is reconfigured on the basis of the reconfigurable data of the storage device 62, so that the data processing of the intermediate print data can be quickly started, and a first printout time period can be shortened.

Further, in this embodiment, the host terminal 100 reconfigures part or the entire hardware region of the hardware circuit 20 on the basis of the reconfigurable data.

Thus, it is permitted to rewrite only the necessary part of the hardware region of the hardware circuit 20. That is, if necessary, the idle hardware region of the hardware circuit 20 can be caused to function as a new print-data processing region or as a printer management region.

Further, in this embodiment, the reconfigurable data contain information which is used for configuring the circuit that realizes the print data processing function specialized for the data processing of the intermediate print data.

Thus, the intermediate print data are subjected to the print data processing specialized therefore, so that the print data processing relevant to the corresponding print request can be executed more appropriately.

In the first embodiment, the host terminal 100 corresponds to a print request apparatus in Aspect/Aspects 1 through 3, 13, 26 through 28, 30, 35, 45 through 47, 57, 58, 76 through 78, 88 through 90, or 100, while the reconfigurable-data storage unit 10 and the storage device 42 correspond to circuit-configuration-information storage means in Aspect 2, 3, 6, 13, 27, 28, 53, 58, 59, 84, 89, 90, 93, or 100. Besides, the transmission-history-information storage unit 14 and the storage device 42 corresponds to transmission-history-information storage means in Aspect 13, 35, 66, or 100, while the reconfigurable-data transmission unit 11, the I/F 38 and steps S106, S110 and S114 correspond to circuit-configuration-information transmission means in Aspect/Aspects 1 through 3, 6, 13, 26 through 28, or 35.

Besides, in the first embodiment, steps S106, S110 and S114 correspond to a circuit-configuration-information transmission step in Aspect/Aspects 57 through 59, 66, 88 through 90, 93, or 100, while the intermediate-print-data transmission unit 13, the I/F 38 and steps S110 and S114 correspond to data-to-be-print-processed transmission means in Aspect 2, 3, or 27. Also, steps S110 and S114 correspond to a data-to-be-print-processed transmission step in Aspect 58, 89, or 90, the transmission-history-information registration unit 15 and step S112 correspond to transmission-history-information registration means in Aspect 13, or 35, and step S112 corresponds to a transmission-history-information registration step in Aspect 66, or 100.

Besides, in the first embodiment, the reconfigurable data correspond to circuit configuration information in Aspect/Aspects 1 through 3, 6, 8, 13, 15, 26 through 28, 30, 35, 45 through 47, 50, 53, 55, 57 through 59, 61, 66, 76 through 78, 81, 84, 86, 88 through 90, 93, 95, 100, or 102. Also, the intermediate print data correspond to data to-be-print-processed in Aspect 2, 3, 8, 27, 30, 46, 47, 50, 58, 61, 77, 78, 81, 89, 90, or 95, while the print data correspond to print-processed data in Aspect 2, 3, 46, 47, 77, 78, 89, or 90.

Besides, in the first embodiment, the reconfigurable data ID corresponds to identification information in Aspect 13, 35, 53, 66, 84, or 100, while the reconfigurable instruction corresponds to a reconfiguration instruction in Aspect 13, 35, 53, 66, 84, or 100.

In the first embodiment, the printer 200 corresponds to print equipment in Aspect/Aspects 1 through 3, 6, 13, 26 through 28, 35, 45 through 47, 50, 53, 55, 57 through 59, 66, 76 through 78, 88 through 90, 93, or 100, while the hardware circuit 20 corresponds to a circuit device in Aspects 1 through 3, 45 through 47, 76 through 78, or 88 through 90. Also, the reconfigurable-data storage unit 25 corresponds to second circuit-configuration-information storage means in Aspect 13, 53, 84, or 100, while the reconfigurable-data reception unit 21, the I/F 58 and step S202 correspond to circuit-configuration-information reception means in Aspect/Aspects 1 through 3, 13, 45 through 47, or 53.

Besides, in the first embodiment, step S202 corresponds to a circuit-configuration-information reception step in Aspect/Aspects 76 through 78, 84, 88 through 90, or 100, while the hardware-region reconfiguration unit 22 and step S210 correspond to hardware-region reconfiguration means in Aspect/Aspects 1 through 3, 13, 15, 45 through 47, 53, or 55. Also, step S210 corresponds to a hardware-region reconfiguration step in Aspect/Aspects 76 through 78, 84, 86, 88 through 90, 100, or 102, while the intermediate-print-data reception unit 23, the I/F 58 and step S202 correspond to data-to-be-print-processed reception means in Aspect 2, 3, 46, or 47.

Besides, in the first embodiment, step S202 corresponds to a data-to-be-print-processed reception step in Aspect 77, 78, 89, or 90, the print control unit 24 and step S216 correspond to print control means in Aspect 2, 3, 46, or 47, and step S216 corresponds to a print control step in Aspect 77, 78, 89, or 90. Also, the reconfigurable-data registration unit 26 and step S208 correspond to circuit-configuration-information registration means in Aspect 13, or 53, step S208 corresponds to a circuit-configuration-information registration step in Aspect 84, or 100, and the reconfigurable-instruction reception unit 27, the I/F 58 and step S202 correspond to reconfiguration-instruction reception means in Aspect 13, or 53.

Besides, in the first embodiment, step S202 corresponds to a reconfiguration-instruction reception step in Aspect 84, or 100, the reconfigurable-data search unit 28 and step S218 correspond to circuit-configuration-information search means in Aspect 13, or 53, and step S218 corresponds to a circuit-configuration-information search step in Aspect 84, or 100.

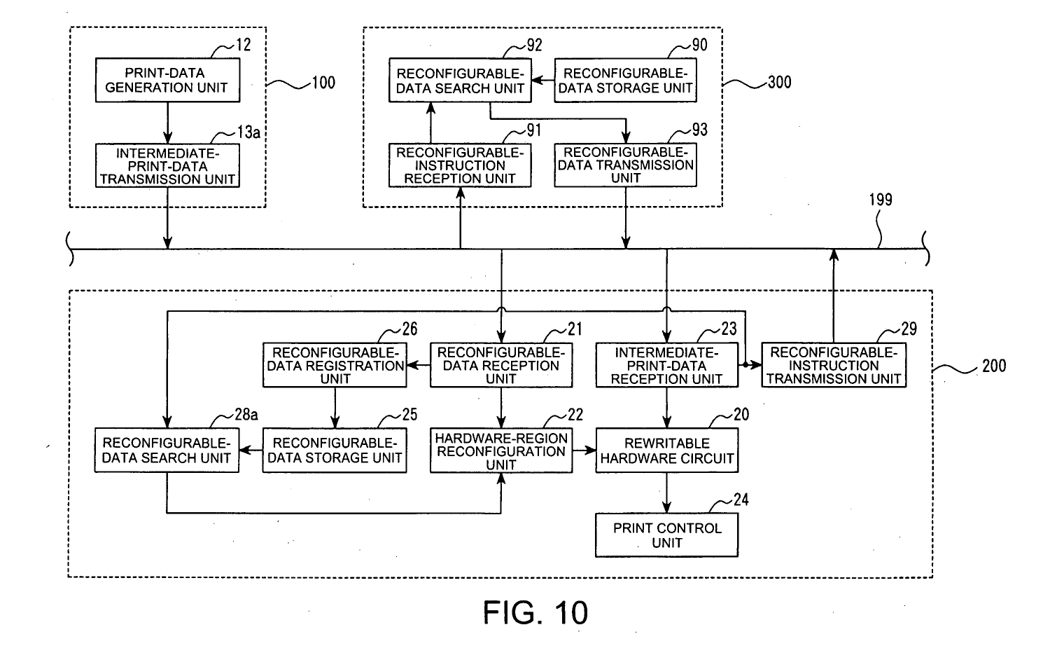

Next, the second embodiment of the invention will be described with reference to the drawings. FIGS. 10 through 15 are diagrams showing the second embodiment of each of a print system, a print request apparatus, a print-equipment management apparatus, print equipment, a print-equipment management program as well as a print control program, and a print method according to the invention.

This embodiment is such that each of the print system, print request apparatus, print-equipment management apparatus, print equipment, print-equipment management program as well as print control program, and print method according to the invention is applied to a case where, as shown in FIG. 10, printing is done by dynamically altering the hardware functions of a printer 200 in compliance with a print request from a host terminal 100. Different from the first embodiment is the point that a printer management server 300 offers reconfigurable data. By the way, hereinbelow, only parts different from those of the first embodiment will be described, and parts overlapping with those of the first embodiment will have the same signs assigned thereto and shall be omitted from description.

First, the outline of the functions of a network system to which the invention is to be applied will be described with reference to FIG. 10.

FIG. 10 is a functional block diagram showing the outline of the functions of the network system to which the invention is to be applied.

As shown in FIG. 10, the host terminal 100, the printer 200 and the printer management server 300 for managing the printer 200 are connected to a network 199. Incidentally, only one host terminal 100 is illustrated in order to facilitate understanding of the invention, but in actuality, a large number of host terminals 100 are connected to the network 199.

The host terminal 100 is configured having a print-data generation unit 12, and an intermediate-print-data transmission unit 13a which transmits intermediate print data generated by the print-data generation unit 12, to the printer 200 in accordance with a print request.

The intermediate-print-data transmission unit 13a transmits the intermediate print data containing a reconfigurable data ID, to the printer 200.

The printer 200 is configured having a hardware circuit 20, a reconfigurable-data reception unit 21, a hardware-region reconfiguration unit 22, an intermediate-print-data reception unit 23, a print control unit 24, and a reconfigurable-instruction transmission unit 29 which transmits to the printer management server 300 a reconfigurable instruction that contains the reconfigurable data ID acquired from the intermediate print data received by the intermediate-print-data reception unit 23.

The printer 200 is configured further having a reconfigurable-data storage unit 25, a reconfigurable-data registration unit 26, and a reconfigurable-data search unit 28 which searches the reconfigurable-data storage unit 25 for the corresponding reconfigurable data on the basis of the reconfigurable data ID acquired from the intermediate print data received by the intermediate-print-data reception unit 23.

The printer management server 300 is configured having a reconfigurable-data storage unit 90 which stores a plurality of sets of reconfigurable data therein, a reconfigurable-instruction reception unit 91 which receives the reconfigurable instruction, a reconfigurable-data search unit 92 which searches the reconfigurable-data storage unit 90 for the corresponding reconfigurable data on the basis of the reconfigurable data ID contained in the reconfigurable instruction received by the reconfigurable-instruction reception unit 91, and a reconfigurable-data transmission unit 93 which transmits to the printer 200 the reconfigurable data that have been searched out by the reconfigurable-data search unit 92.

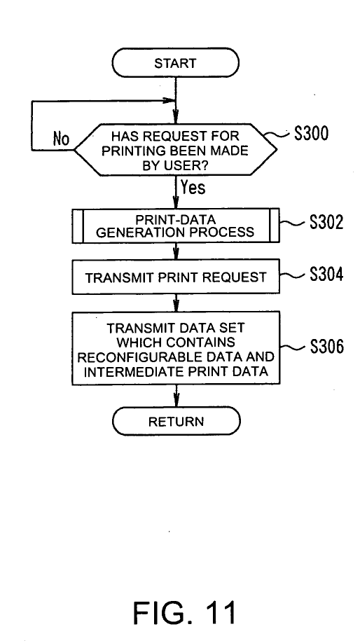

Next, the configuration of the host terminal 100 will be described in detail with reference to FIG. 11.

A CPU 30 activates a predetermined program stored in the predetermined area of a ROM 32, thereby to execute a print request process shown in the flow chart of FIG. 11, instead of the print request process shown in the flow chart of FIG. 5.

FIG. 11 is the flow chart showing the print request process.

The print request process is a process which is incarnated as the print-data generation unit 12 and intermediate-print-data transmission unit 13a. When this process is executed in the CPU 30, it first proceeds to step S300 as shown in FIG. 11.

At step S300, it is decided whether or not a request for printing has been inputted from an input device 40 by a user. Subject to the decision that the request for printing has been inputted by the user (“Yes”), the routine proceeds to step S302, but in the other case (“No”), the routine stands-by at step S300 until the request for printing is inputted by the user.

At step S302, a print-data generation process in which document data edited by a document editing application are converted into intermediate print data of predetermined format is executed, whereupon the routine proceeds to step S304 at which the print request is transmitted to the printer 200, followed by step S306.

At step S306, a data set which contains a reconfigurable instruction containing a reconfigurable data ID, and the intermediate print data generated at step S302 is transmitted to the printer 200. Then, the series of processing steps are ended, and the original process is returned to.

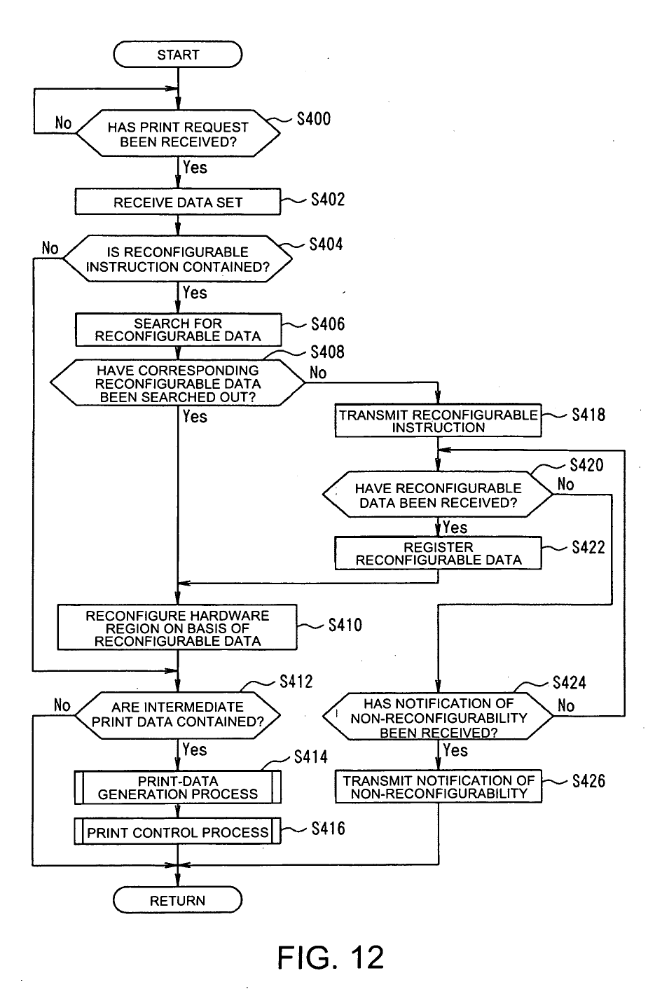

Next, the configuration of the printer 200 will be described in detail with reference to FIG. 12.

A CPU 50 activates a predetermined program stored in the predetermined area of a ROM 52, thereby to execute a printer control process shown in the flow chart of FIG. 12, instead of the printer control process shown in the flow chart of FIG. 8.

FIG. 12 is the flow chart showing the printer control process.

The printer control process is a process which is incarnated as the reconfigurable-data reception unit 21, hardware-region reconfiguration unit 22, intermediate-print-data reception unit 23, print control unit 24, reconfigurable-data registration unit 26, reconfigurable-data search unit 28 and reconfigurable-instruction transmission unit 29. When this process is executed in the CPU 50, it first proceeds to step S400 as shown in FIG. 12.

At step S400, whether or not a print request has been received is decided. Subject to the decision that the print request has been received (“Yes”), the routine proceeds to step S402, but in the other case (“No”), the routine stands-by at step S400 until the print request is received.

At step S402, a data set is received, whereupon the routine proceeds to step S404 at which whether or not a reconfigurable instruction is contained in the received data set is decided. Subject to the decision that the reconfigurable instruction is contained (“Yes”), the routine proceeds to step S406.

At step S406, a storage device 62 is searched for the corresponding reconfigurable data on the basis of a reconfigurable data ID contained in the received reconfigurable instruction. The routine proceeds to step S408 at which whether or not the corresponding reconfigurable data have been searched out is decided. Subject to the decision that the corresponding reconfigurable data have been searched out (“Yes”), the routine proceeds to step S410.

At step S410, part or the entire hardware region of the hardware circuit 20 is reconfigured by a reconfiguration device 56 on the basis of the reconfigurable data received or searched out, whereupon the routine proceeds to step S412.

At step S412, whether or not intermediate print data are contained in the received data set is decided. Subject to the decision that the intermediate print data are contained (“Yes”), the routine proceeds to step S414 at which a print-data generation process for converting the received intermediate print data into print data by the hardware circuit 20 is executed. The routine proceeds to step S416 at which a print control process for performing printing by a print mechanism 64 on the basis of the print data subjected to the data processing in the hardware circuit 20 is executed. Then, the series of processing steps are ended, and the original process is returned to.

On the other hand, when it has been decided at step S412 that the intermediate print data are not contained in the received data set (“No”), the series of processing steps are ended, and the original process is returned to.

Also, when it has been decided at step S408 that the corresponding reconfigurable data have not been searched out (“No”), the routine proceeds to step S418 at which the received reconfigurable instruction is transmitted to the printer management server 300, followed by step S420.

At step S420, whether or not reconfigurable data have been received is decided. Subject to the decision that the reconfigurable data have been received (“Yes”), the routine proceeds to step S422 at which the received reconfigurable data are registered in the storage device 62 in association with their reconfigurable data ID, followed by step S410.

On the other hand, when it has been decided at step S420 that the reconfigurable data have not been received (“No”), the routine proceeds to step S424 at which whether or not the notification of non-reconfigurability has been received is decided. Subject to the decision that the notification of non-reconfigurability has been received (“Yes”), the routine proceeds to step S426 at which the notification of non-reconfigurability is transmitted to the host terminal 100. Then, the series of processing steps are ended, and the original process is returned to.

Also, when it has been decided at step S424 that the notification of non-reconfigurability has not been received (“No”), the routine proceeds to step S420.

Further, when it has been decided at step S404 that the reconfigurable instruction is not contained in the received data set (“No”), the routine proceeds to step S412.

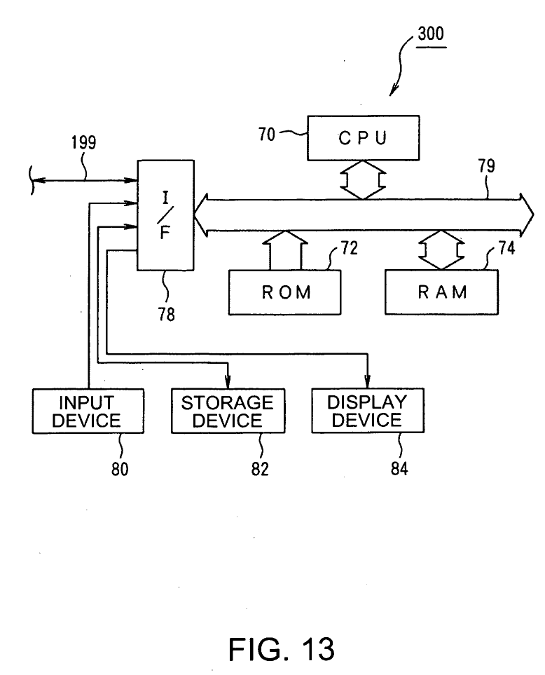

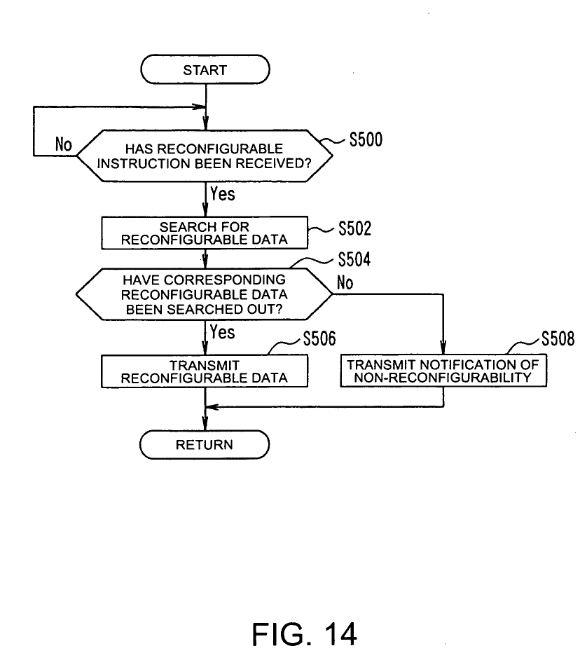

Next, the configuration of the printer management server 300 will be described in detail with reference to FIGS. 13 and 14.

FIG. 13 is a block diagram showing the hardware architecture of the printer management server 300.

As shown in FIG. 13, the printer management server 300 is configured of a CPU 70 which controls arithmetics and the entire system on the basis of a control program, a ROM 72 in which the control program of the CPU 70, etc. are stored in predetermined areas beforehand, a RAM 74 which serves to store therein data read out of the ROM 72, etc. and arithmetic results required in the arithmetic processes of the CPU 70, and an I/F 78 through which data are inputted from and outputted to external devices. These constituents are connected to one another and in a manner to be capable of transferring data, by a bus 79 which is composed of signal lines for transferring the data.

Connected to the I/F 78 are the external devices being an input device 80 which includes a keyboard, a mouse, etc. capable of inputting data as human interfaces, a storage device 82 in which data, tables, etc. are stored as files, and a display device 84 which displays a screen on the basis of an image signal, and also a signal line which serves to connect the printer management server 300 to the network 199.

The storage device 82 is configured as the reconfigurable-data storage unit 90. The reconfigurable data are stored in association with their reconfigurable data IDs.

The CPU 70 is configured of a microprocessing unit (MPU) or the like. It activates a predetermined program stored in the predetermined area of the ROM 72, so as to execute a reconfigurable-data offer process shown in the flow chart of FIG. 14, in accordance with the program.

FIG. 14 is the flow chart showing the reconfigurable-data offer process.

The reconfigurable-data offer process is a process which is incarnated as the reconfigurable-instruction reception unit 91, reconfigurable-data search unit 92 and reconfigurable-data transmission unit 93. When this process is executed in the CPU 70, it first proceeds to step S500 as shown in FIG. 14.

At step S500, whether or not a reconfigurable instruction has been received is decided. Subject to the decision that the reconfigurable instruction has been received (“Yes”), the routine proceeds to step S502, but in the other case (“No”), the routine stands-by at step S500 until the reconfigurable instruction is received.

At step S502, the storage device 82 is searched for the corresponding reconfigurable data on the basis of a reconfigurable data ID contained in the received reconfigurable instruction. The routine proceeds to step S504 at which whether or not the corresponding reconfigurable data have been searched out is decided. Subject to the decision that the corresponding reconfigurable data have been searched out (“Yes”), the routine proceeds to step S506.

At step S506, the searched-out reconfigurable data are transmitted to the printer 200. Then, the series of processing steps are ended, and the original process is returned to.

On the other hand, when it has been decided at step S504 that the corresponding reconfigurable data have not been searched out (“No”), the routine proceeds to step S508 at which the notification of non-reconfigurability is transmitted to the printer 200. Then, the series of processing steps are ended, and the original process is returned to.

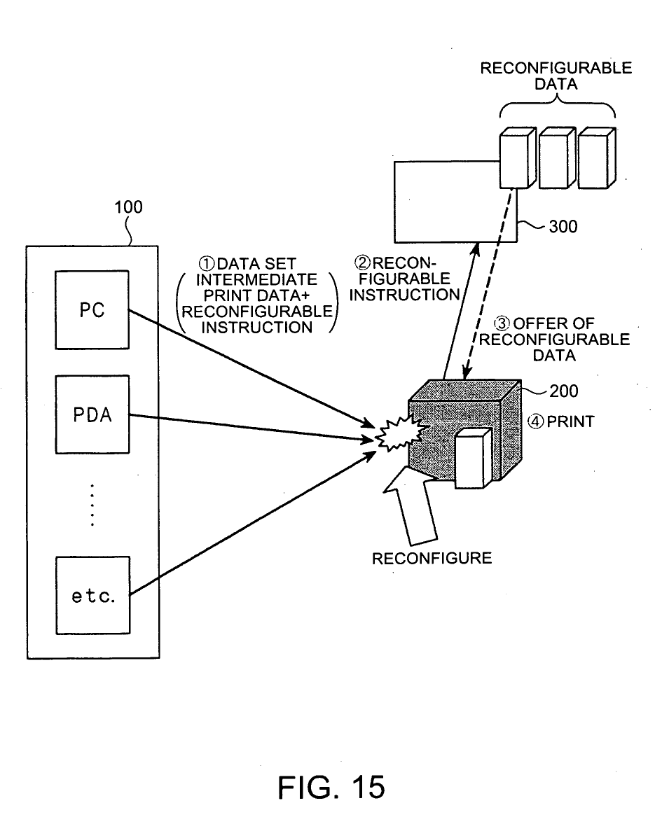

Next, the operation of this embodiment will be described with reference to FIG. 15.

FIG. 15 is a diagram for explaining the operation of the embodiment.

First, there will be described a case where the printer 200 performs printing for the first time.

In the host terminal 100, as shown in FIG. 15, when a request for the printing has been inputted by the user, document data are converted into intermediate print data, and a print request is transmitted to the printer 200, via steps S302 and S304. Subsequently, a data set which contains a reconfigurable instruction containing a reconfigurable data ID, and the generated intermediate print data is transmitted to the printer 200 via step S306.

In the printer 200, when the print request has been received, the data set is received via step S402. Since the reconfigurable instruction is contained in the received data set, the storage device 62 is searched for the corresponding reconfigurable data on the basis of the reconfigurable data ID contained in the received reconfigurable instruction, via step S406. As a result, the corresponding reconfigurable data are not stored in the storage device 62, because of the first printing, so that the received reconfigurable instruction is transmitted to the printer management server 300 via step S418.

In the printer management server 300, when the reconfigurable instruction has been received, the storage device 82 is searched for the corresponding reconfigurable data on the basis of the reconfigurable data ID contained in the received reconfigurable instruction, via step S502. When the corresponding reconfigurable data have been searched out as the result, the searched-out reconfigurable data are transmitted to the printer 200 via step S506.

In the printer 200, when the reconfigurable data have been received, the received reconfigurable data are registered, and part or the entire hardware region of the hardware circuit 20 is reconfigured by the reconfiguration device 56 on the basis of the received reconfigurable data, via steps S422 and S410. Besides, the received intermediate print data are converted into print data by the hardware circuit 20, and the printing is done by the print mechanism 64 on the basis of the print data subjected to the data processing by the hardware circuit 20, via steps S414 and S416.

Secondly, there will be described a case where the printer 200 performs second printing.

In the host terminal 100, as shown in FIG. 15, when a request for the printing has been inputted by the user, document data are converted into intermediate print data, and a print request is transmitted to the printer 200, via steps S302 and S304. Subsequently, a data set which contains a reconfigurable instruction containing a reconfigurable data ID, and the generated intermediate print data is transmitted to the printer 200 via step S306.

In the printer 200, when the print request has been received, the data set is received via step S402. Since the reconfigurable instruction is contained in the received data set, the storage device 62 is searched for the corresponding reconfigurable data on the basis of the reconfigurable data ID contained in the received reconfigurable instruction, via step S406. When the corresponding reconfigurable data have been searched out as the result, part or the entire hardware region of the hardware circuit 20 is reconfigured by the reconfiguration device 56 on the basis of the searched-out reconfigurable data, via step S410. Besides, the received intermediate print data are converted into print data by the hardware circuit 20, and the printing is done by the print mechanism 64 on the basis of the print data subjected to the data processing by the hardware circuit 20, via steps S414 and S416.

In this way, in this embodiment, the printer management server 300 transmits the reconfigurable data to the printer 200 in accordance with the print request, while the host terminal 100 transmits the intermediate print data to the printer 200 in accordance with the print request. Upon receiving the reconfigurable data and the intermediate print data, the printer 200 reconfigures the hardware region of the hardware circuit 20 on the basis of the received reconfigurable data, and it converts the received intermediate print data into the print data by the hardware circuit 20, so as to perform the printing on the basis of the print data subjected to the data processing by the hardware circuit 20.

Thus, after the hardware region of the hardware circuit 20 of the printer 200 has been reconfigured in accordance with the print request, the intermediate print data relevant to the print request are subjected to the data processing by the hardware circuit 20, and hence, the print data processing relevant to the print request can be executed comparatively appropriately. As compared with the prior art, accordingly, this embodiment can efficiently subject intermediate print data relevant to individual print requests, to data processing even when the plurality of print requests exist simultaneously.

Moreover, the host terminal 100 and the printer 200 need not hold the reconfigurable data. Therefore, the memory capacities of the host terminal 100 and printer 200 are not oppressed considerably, and this embodiment can relieve a memory load as compared with the prior art.

Further, even when optimal sharing proportions are set for individual host terminals 100 in a case where the plurality of host terminals 100 of different processabilities utilize a single printer 200, the printer 200 can cope with the different formats of intermediate print data which are transmitted from the individual host terminals 100, merely in such a way that the printer management server 300 holds a plurality of sets of reconfigurable data suited to the different formats of the intermediate print data which the respective host terminals 100 transmit to the printer 200. Accordingly, the circuit of the printer 200 becomes smaller in scale than in case of providing a hardware circuit 20 which realizes print data processing functions capable of coping with the respective formats.

In the second embodiment, the host terminal 100 corresponds to a print request apparatus in Aspect/Aspects 16 through 18, 37, 39, 40, 68, 70, 71, or 103 through 105, while the intermediate-print-data transmission unit 13a, the I/F 38 and step S306 correspond to data-to-be-print-processed transmission means in Aspect 17, 18, 20, or 37. Also, step S306 corresponds to a data-to-be-print-processed transmission step in Aspect 68, 104, 105, or 107, while the reconfigurable data correspond to circuit configuration information in Aspect/Aspects 16 through 18, 20, 23, 39, 40, 42, 70, 71, 73, 103 through 105, 107, or 110.

Besides, in the second embodiment, the intermediate print data correspond to data to-be-print-processed in Aspect 17, 18, 20, 23, 37, 42, 56, 68, 73, 87, 104, 105, 107, or 110, while the print data correspond to print-processed data in Aspect 17, 18, 104, or 105. Also, the reconfigurable data ID corresponds to identification information in Aspect 20, 56, 87, or 107, while the reconfigurable instruction corresponds to a reconfiguration instruction in Aspect 20, 56, 87, or 107.

In the second embodiment, the printer 200 corresponds to print equipment in Aspect/Aspects 16 through 18, 20, 37, 39, 40, 56, 68, 70, 71, 103 through 105, or 107, while the hardware circuit 20 corresponds to a circuit device in Aspect/Aspects 16 through 18, 103, or 105. Also, the reconfigurable-data reception unit 21, the I/F 58 and step S420 correspond to circuit-configuration-information reception means in Aspects 16 through 18, step S420 corresponds to a circuit-configuration-information reception step in Aspects 103 through 105, and the hardware-region reconfiguration unit 22 and step S410 correspond to hardware-region reconfiguration means in Aspects 16 through 18.

Besides, in the second embodiment, step S410 corresponds to a hardware-region reconfiguration step in Aspects 103 through 105, while the intermediate-print-data reception unit 23, the I/F 58 and step S402 correspond to data-to-be-print-processed reception means in Aspect 17, 18, 20, or 56. Also, step S402 corresponds to a data-to-be-print-processed reception step in Aspect 87, 104, 105, or 107, the print control unit 24 and step S416 correspond to print control means in Aspect 17, or 18, and step S416 corresponds to a print control step in Aspect 104, or 105.

Besides, in the second embodiment, the reconfigurable-instruction transmission unit 29, the I/F 58 and step S418 correspond to reconfiguration-instruction transmission means in Aspect 20, or 56, step S418 corresponds to a reconfiguration-instruction transmission step in Aspect 87, or 107, and the printer management server 300 corresponds to a print-equipment management apparatus in Aspect/Aspects 16 through 18, 20, 37, 39, 40, 42, 56, 68, 70, 71, 87, 103 through 105, or 107. Also, the reconfigurable-data storage unit 90 and the storage device 82 correspond to circuit-configuration-information storage means in Aspect 17, 18, 20, 40, 71, 104, 105, or 107, while the reconfigurable-instruction reception unit 91, the I/F 78 and step S500 correspond to reconfiguration-instruction reception means in Aspect 20.

Besides, in the second embodiment, step S500 corresponds to a reconfiguration-instruction reception step in Aspect 107, the reconfigurable-data search unit 92 and step S502 corresponds to circuit-configuration-information search means in Aspect 20, and step S502 corresponds to a circuit-configuration-information search step in Aspect 107. Also, the reconfigurable-data transmission unit 93, the I/F 78 and step S506 correspond to circuit-configuration-information transmission means in Aspect/Aspects 16 through 18, 20, 39, or 40, while step S506 corresponds to a circuit-configuration-information transmission step in Aspect/Aspects 70, 71, 103 through 105, or 107.

By the way, in the first embodiment, the host terminal 100 has been configured so as to simultaneously transmit the reconfigurable data and the intermediate print data to the printer 200, but it can also be configured so as to transmit the intermediate print data after having transmitted the reconfigurable data, without being restricted to the configuration of the first embodiment. In particular, a configuration as stated below can be adopted.

The host terminal 100 transmits the reconfigurable data to the printer 200, and it transmits the intermediate print data upon receiving a predetermined notification.

When the printer 200 has received the reconfigurable data, it reconfigures the hardware region of the hardware circuit 20 on the basis of the received reconfigurable data, and when it has completed the reconfiguration of the hardware region, it transmits the predetermined notification to the host terminal 100. Here, regarding a decision on the completion of the reconfiguration, in a case where the hardware circuit 20 is configured of an LSI having an error check function, for example, an EPGA (Field Programmable Gate Array), the completion of the reconfiguration is decided when no error has developed as the result of the reconfiguration of the hardware region. Various schemes, such as an CRC (Cyclic Redundancy Check) scheme, exist as error checking schemes.

More particularly, the host terminal 100 can also be configured so as to verify the completion of the reconfiguration of the hardware region by performing poling.

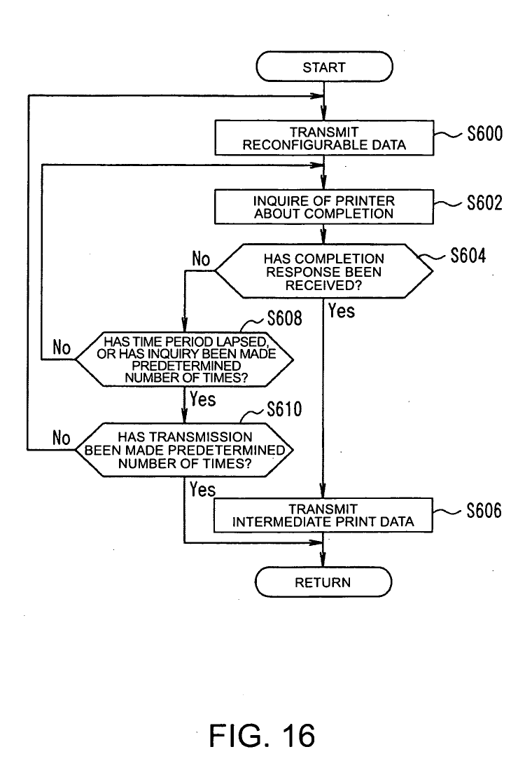

The CPU 30 of the host terminal 100 activates a predetermined program stored in the predetermined area of the ROM 32, so as to execute a reconfigurable-data transmission process shown in the flow chart of FIG. 16, instead of the processing of steps S110 and S112.

FIG. 16 is the flow chart showing the reconfigurable-data transmission process.

When the reconfigurable-data transmission process is executed in the CPU 30, it first proceeds to step S600 as shown in FIG. 16.

At step S600, the reconfigurable data read out at step S108 are transmitted to the printer 200, whereupon the routine proceeds to step S602 at which the host terminal 100 inquires of the printer 200 at a predetermined time (for example, every second) as to if the reconfiguration of the hardware region has been completed, followed by step S604.

At step S604, it is decided whether or not a completion response indicating the completion of the reconfiguration of the hardware region has been received from the printer 200. Subject to the decision that the completion response has been received (“Yes”), the routine proceeds to step S606 at which the intermediate print data generated at step S102 are transmitted to the printer 200. Then, the series of processing steps are ended, and the original process is returned to.

On the other hand, when it has been decided at step S604 that the completion response has not been received from the printer 200 (“No”), the routine proceeds to step S608 at which whether or not a predetermined time period has lapsed since the transmission of the reconfigurable data, or the number of times of the inquiry has exceeded a predetermined number of times is decided. Subject to the decision that the predetermined time period has lapsed, or that the number of times of the inquiry has exceeded the predetermined number of times (“Yes”), the routine proceeds to step S610.

At step S610, it is decided whether or not the number of times of the transmission of the reconfigurable data has exceeded a predetermined number of times. Subject to the decision that the number of times of the transmission has exceeded the predetermined number of times (“Yes”), the series of processing steps are ended, and the original process is returned to.

On the other hand, when it has been decided at step S610 that the number of times of the transmission of the reconfigurable data has not exceeded the predetermined number of times (“No”), the routine proceeds to step S600.

Also, when it has been decided at step S608 that the predetermined time period has not lapsed since the transmission of the reconfigurable data, and that the number of times of the inquiry has not exceeded the predetermined number of times (“No”), the routine proceeds to step S602.

Thus, the intermediate print data are subjected to data processing by the hardware circuit 20 after waiting for the completion of the reconfiguration of the hardware region of the hardware circuit 20, and hence, the print data processing relevant to the print request can be executed comparatively reliably.

In this case, the host terminal 100 corresponds to a print request apparatus in Aspect 4, 48, 79, or 91, the printer 200 corresponds to print equipment in Aspect 4, 48, or 91, and the intermediate print data correspond to data to-be-print-processed in Aspect 4, or 91.

Besides, in the first embodiment, the host terminal 100 has been configured so as to simultaneously transmit the reconfigurable data and the intermediate print data to the printer 200, but it can also be configured so as to transmit the reconfigurable data and the intermediate print data at independent times, without being restricted to the configuration of the first embodiment. In particular, a configuration as stated below can be adopted.

The host terminal 100 transmits the reconfigurable data and the intermediate print data at the times independent of each other.

When the printer 200 has received the intermediate print data, it holds the received intermediate print data in the storage device 62. Besides, when the printer 200 has received the reconfigurable data, it reconfigures the hardware region of the hardware circuit 20 on the basis of the received reconfigurable data, and when it has completed the reconfiguration of the hardware region, it converts the intermediate print data of the storage device 62 into print data by the hardware circuit 20.

Thus, the intermediate print data are subjected to data processing by the hardware circuit 20 after waiting for the completion of the reconfiguration of the hardware region of the hardware circuit 20, and hence, the print data processing relevant to the print request can be executed comparatively reliably.

In this case, the printer 200 corresponds to print equipment in Aspect 5, 49, or 92, the hardware circuit 20 corresponds to a circuit device in Aspect 5, 49, 80, or 92, and the intermediate print data correspond to data to-be-print-processed in Aspect 5, 49, 80, or 92.

Besides, in the first embodiment, the host terminal 100 has been configured so as to transmit the reconfigurable data to the printer 200 when the request for printing has been inputted by the user, but it can also be configured so as to transmit the reconfigurable data to the printer 200 when settings concerning printing have been performed by the user, without being restricted to the configuration of the first embodiment.

Thus, the hardware region of the hardware circuit 20 of the printer 200 is reconfigured at a time at which the user has performed the settings concerning printing, so that intermediate print data relevant to individual print requests can be efficiently subjected to data processing even when the plurality of print requests exist simultaneously.

In this case, the reconfigurable-data storage unit 10 and the storage device 42 correspond to circuit-configuration-information storage means in Aspect 7, 29, 60, or 94, the printer 200 corresponds to print equipment in Aspect 7, 29, 60, or 94, and the reconfigurable data correspond to circuit configuration information in Aspect 7, 29, 60, or 94.

Besides, in the first embodiment, the reconfigurable data have been formed containing the information for use in the configuration of the circuit which realizes the print data processing function specialized for the data processing of the intermediate print data, but they can also be formed containing information for use in the configuration of a circuit which realizes a print data processing function that sets the degree of parallelism in the case of the parallel data processing of a plurality of sets of intermediate print data or the parallel data processing of the parallel-processable parts of a single set of intermediate print data, without being restricted to the formation of the first embodiment. In this case, a configuration as stated below can be further adopted.

The host terminal 100 acquires status information indicating the scale (for example, the number of gates) of the hardware region of the hardware circuit 20, from the printer 200, it sets the degree of parallelism of the reconfigurable data on the basis of the acquired status information, and it transmits the reconfigurable data of the updated degree of parallelism, to the printer 200.

The printer 200 transmits its status information to the host terminal 100 in compliance with an acquisition request from the host terminal 100. The status information is managed by, for example, an MIB database.

By way of example, in a case where parallel processing circuits are configured owing to the reserved part of a circuit scale and where the intermediate print data of first-fifth pages and sixth-tenth pages are separately processed, print data can be generated at a higher speed than in a case where the intermediate print data for the 10 pages are sequentially processed from the first page to the tenth page.

Thus, the degree of parallelism of the printer 200 can be adjusted in the host terminal 100, so that the intermediate print data can be subjected to the data processing more efficiently. Moreover, the degree of parallelism can be set in accordance with the scale of the hardware region of the printer 200, so that the intermediate print data can be subjected to the data processing more efficiently.

In this case, the host terminal 100 corresponds to a print request apparatus in Aspect 10, 31, 32, or 97, the printer 200 corresponds to print equipment in Aspect 10, 32, 51, 63, or 97, and the reconfigurable data correspond to circuit configuration information in Aspect 9, 10, 31, 32, 51, 62, 63, 82, 96, or 97. Also, the intermediate print data correspond to data to-be-print-processed in Aspect 9, 31, 51, 62, 82, or 96.

Besides, in the first embodiment, the reconfigurable data have been formed containing the information for use in the configuration of the circuit which realizes the print data processing function specialized for the data processing of the intermediate print data, but they can also be formed containing information for use in the configuration of a circuit which realizes a print data processing function to be borne by the printer 200 in a case where the host terminal 100 and the printer 200 share the data processing of the document data and the intermediate print data, without being restricted to the formation of the first embodiment. In this case, a configuration as stated below can be further adopted.

The host terminal 100 acquires status information indicating its processing load, and status information indicating the processing load of the printer 200, it updates the reconfigurable data on the basis of the acquired status information items, and it transmits the updated reconfigurable data to the printer 200.

The printer 200 transmits its status information to the host terminal 100 in compliance with an acquisition request from the host terminal 100. The status information is managed by, for example, an MIB database.

Incidentally, the sharing processing can be performed, not only in the combination of the host terminal 100 and the printer 200, but also in the combination of any desired plurality of constituents among the host terminal 100, the printer 200 and the other devices.

Thus, the print data processing function suited to the sharing proportion of the printer 200 can be configured in the host terminal 100, so that the intermediate print data can be subjected to the data processing more efficiently. Moreover, the print data processing function is configured in accordance with the processing loads of the host terminal 100 and printer 200, so that the intermediate print data can be subjected to the data processing more efficiently.

In this case, the host terminal 100 corresponds to a print request apparatus in Aspect 12, 33, 34, or 99, or to another device in Aspect 11, 12, 33, 34, 52, 64, 65, 83, 98, or 99, while the printer 200 corresponds to print equipment in Aspect 11, 12, 33, 34, 52, 64, 65, 83, 98, or 99. Also, the reconfigurable data correspond to circuit configuration information in Aspect 11, 12, 33, 34, 52, 64, 65, 83, 98, or 99, while the document data and the intermediate print data correspond to data to-be-print-processed in Aspect 11, 33, 52, 64, 83, or 98.

Besides, in the first embodiment, the host terminal 100 has been configured so as to decide whether or not the reconfigurable data identical to those to be transmitted to the printer 200 have already been transmitted to the printer 200, on the basis of the transmission history information of the storage device 42, but it can also be configured so as to inquire of the printer 200 as to if the reconfigurable data identical to those to be transmitted to the printer 200 exist in the printer 200, and to decide whether or not the reconfigurable data identical to those to be transmitted to the printer 200 have already been transmitted to the printer 200, on the basis of the result of the inquiry, without being restricted to the configuration of the first embodiment.

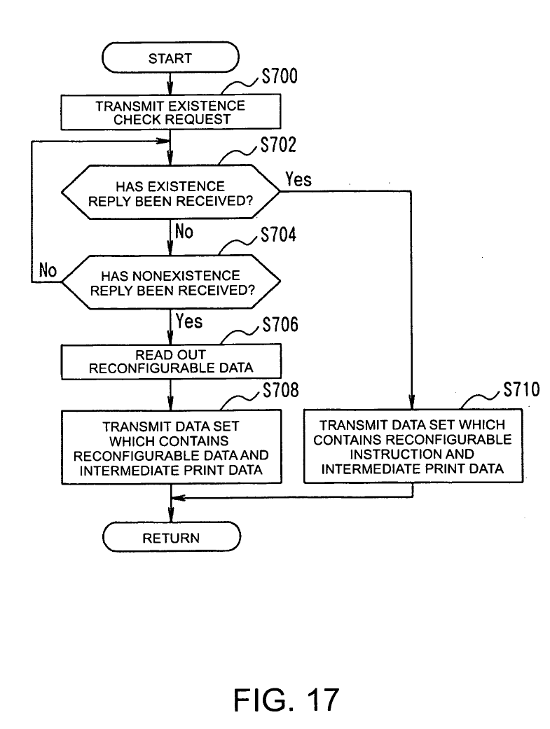

The CPU 30 of the host terminal 100 activates a predetermined program stored in the predetermined area of the ROM 32, so as to execute a reconfigurable-data transmission process shown in the flow chart of FIG. 17, instead of the processing of steps S106 and S114.

FIG. 17 is the flow chart showing the reconfigurable-data transmission process.

When the reconfigurable-data transmission process is executed in the CPU 30, it first proceeds to step S700 as shown in FIG. 17.

At step S700, an existence check request containing a reconfigurable data ID is transmitted to the printer 200, whereupon the routine proceeds to step S702 at which whether or not an existence reply, indicating that reconfigurable data identical to those to be transmitted to the printer 200 exist in the printer 200, has been received is decided. Subject to the decision that the existence reply has not been received (“No”), the routine proceeds to step S704.

At step S704, whether or not a nonexistence reply, indicating that the reconfigurable data identical to those to be transmitted to the printer 200 do not exist in the printer 200, has been received is decided. Subject to the decision that the nonexistence reply has been received (“Yes”), the routine proceeds to step S706 at which the reconfigurable data are read out of the storage device 42, followed by step S708.

At step S708, a data set which contains the reconfigurable data read out at step S706 and the intermediate print data generated at step S102 is transmitted to the printer 200. Then, the series of processing steps are ended, and the original process is returned to.

On the other hand, when it has been decided at step S704 that the nonexistence reply has not been received (“No”), the routine proceeds to step S702.

Also, when it has been decided at step S702 that the existence reply has been received (“Yes”), the routine proceeds to step S710 at which a data set that contains a reconfigurable instruction containing the reconfigurable ID, and the intermediate print data generated at step S102 is transmitted to the printer 200. Then, the series of processing steps are ended, and the original process is returned to.

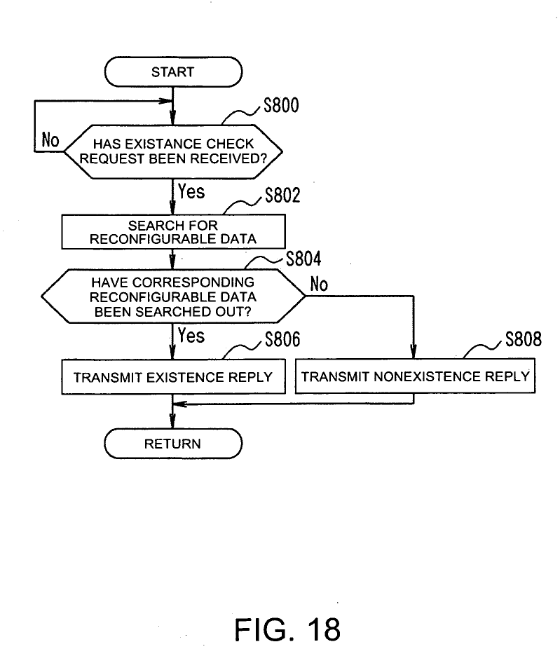

The CPU 50 of the printer 200 activates a predetermined program stored in the predetermined area of the ROM 52, so as to execute a reconfigurable-data existence reply process shown in the flow chart of FIG. 18.

FIG. 18 is the flow chart showing the reconfigurable-data existence reply process.

When the reconfigurable-data existence reply process is executed in the CPU 50, it first proceeds to step S800 as shown in FIG. 18.

At step S800, whether or not the existence check request has been received is decided. Subject to the decision that the existence check request has been received (“Yes”), the routine proceeds to step S802, but in the other case (“No”), the routine stands-by at step S800 until the existence check request is received.

At step S802, the storage device 62 is searched for the corresponding reconfigurable data on the basis of the reconfigurable data ID contained in the received existence check request. The routine proceeds to step S804 at which whether or not the corresponding reconfigurable data have been searched out is decided. Subject to the decision that the corresponding reconfigurable data have been searched out (“Yes”); the routine proceeds to step S806.

At step S806, the existence reply is transmitted to the host terminal 100. Then, the series of processing steps are ended, and the original process is returned to.

On the other hand, when it has been decided at step S804 that the corresponding reconfigurable data have not been searched out (“No”), the routine proceeds to step S808 at which the nonexistence reply is transmitted to the host terminal 100. Then, the series of processing steps are ended, and the original process is returned to.

By the way, in the configuration illustrated in FIGS. 17 and 18, the host terminal 100 has been configured so as to transmit the data set containing the reconfigurable instruction and the intermediate print data, to the printer 200 when the existence reply has been received, but it can also be configured so as not to transmit the reconfigurable instruction, without being restricted to the illustrated configuration. In particular, when the printer 200 has searched out the corresponding reconfigurable data, it transmits the existence reply to the host terminal 100, and it reconfigures the hardware region of the hardware circuit 20 on the basis of the searched-out reconfigurable data. When the host terminal 100 has received the existence reply, it transmits the data set containing the intermediate print data, to the printer 200.

In this case, the I/F 38 and step S700 correspond to circuit-configuration-information inquiry means in Aspect 14, or 36, step S700 corresponds to a circuit-configuration-information inquiry step in Aspect 67, or 101, and the I/F 38 and steps S702-S710 correspond to circuit-configuration-information transmission means in Aspect 14, or 36. Also, steps S702-S710 correspond to a circuit-configuration-information transmission step in Aspect 67, or 101, the I/F 58 and steps S800-S808 correspond to circuit-configuration-information reply means in Aspect 14, or 54, and steps S800-S808 correspond to a circuit-configuration-information reply step in Aspect 85, or 101.

Besides, in the second embodiment, the host terminal 100 has been configured so as to transmit the reconfigurable instruction to the printer 200, but it can also be configured so as to transmit the reconfigurable instruction to the printer management server 300, without being restricted to the configuration of the second embodiment.

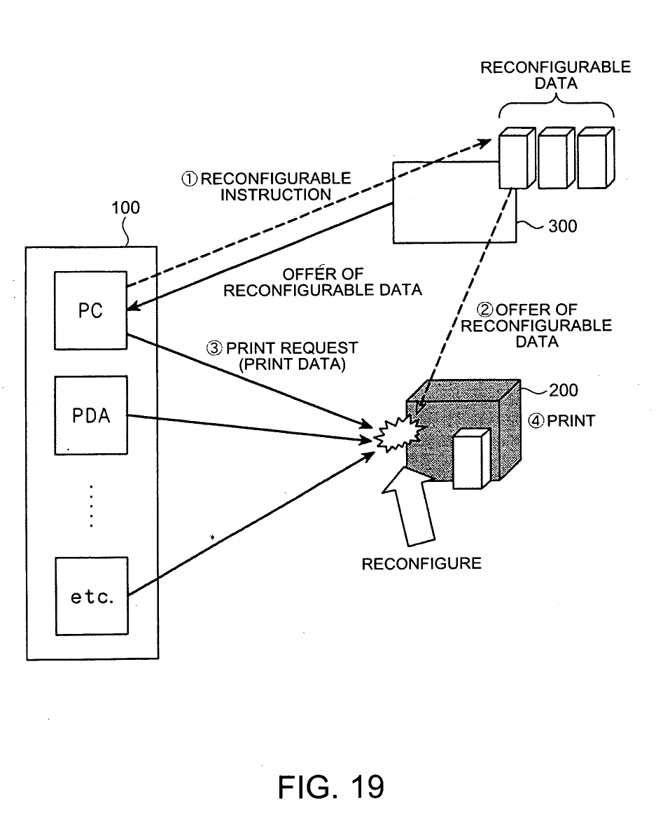

FIG. 19 is a diagram showing the case where the host terminal 100 transmits the reconfigurable instruction to the printer management server 300.

As shown in FIG. 19, the host terminal 100 transmits the reconfigurable instruction containing a reconfigurable data ID, to the printer management server 300 in accordance with a print request.

When the printer management server 300 has received the reconfigurable instruction, it searches the storage device 82 for the corresponding reconfigurable data on the basis of the reconfigurable data ID contained in the received reconfigurable instruction, and it transmits the searched-out reconfigurable data to the printer 200.

When the printer 200 has received the reconfigurable data, it reconfigures the hardware region of the hardware circuit 20 on the basis of the received reconfigurable data.

In this case, the host terminal 100 corresponds to a print request apparatus in Aspect 19, 38, or 106, the printer 200 corresponds to print equipment in Aspect 19, 41, 72, or 106, and the printer management server 300 corresponds to a print-equipment management apparatus in Aspect 19, 38, 41, 69, or 106. Also, the reconfigurable-data storage unit 90 and the storage device 82 correspond to circuit-configuration-information storage means in Aspect 19, 41, 72, or 106, while the reconfigurable data correspond to circuit configuration information in Aspect 19, 38, 41, 69, 72, or 106.

Besides, the reconfigurable data ID corresponds to identification information in Aspect 19, 38, 41, 69, 72, or 106, while the reconfigurable instruction corresponds to a reconfiguration instruction in Aspect 19, 38, 41, 69, 72, or 106.

Besides, in the second embodiment, the printer management server 300 and the host terminal 100 have been configured so as to transmit the reconfigurable data and the intermediate print data to the printer 200 at substantially the same time, but they can also be configured so as to transmit the intermediate print data after the transmission of the reconfigurable data, without being restricted to the configuration of the second embodiment. In particular, a configuration as stated below can be adopted.

The printer management server 300 transmits the reconfigurable data to the printer 200.

When the host terminal 100 has received a predetermined notification, it transmits the intermediate print data.

When the printer 200 has received the reconfigurable data, it reconfigures the hardware region of the hardware circuit 20 on the basis of the received reconfigurable data, and when it has completed the reconfiguration of the hardware region, it transmits the predetermined notification to the host terminal 100.

Thus, the intermediate print data are subjected to data processing by the hardware circuit 20 after waiting for the completion of the reconfiguration of the hardware region of the hardware circuit 20, and hence, the print data processing relevant to the print request can be executed comparatively reliably.

In this case, the host terminal 100 corresponds to a print request apparatus in Aspect 21, or 108, the printer 200 corresponds to print equipment in Aspect 21, or 108, and the intermediate print data correspond to data to-be-print-processed in Aspect 21, or 108.

Besides, in the second embodiment, the printer management server 300 and the host terminal 100 have been configured so as to transmit the reconfigurable data and the intermediate print data to the printer 200 at substantially the same time, but they can also be configured so as to transmit the reconfigurable data and the intermediate print data at independent times, without being restricted to the configuration of the second embodiment. In particular, a configuration as stated below can be adopted.

The printer management server 300 transmits the reconfigurable data to the printer 200.

The host terminal 100 transmits the intermediate print data.

When the printer 200 has received the intermediate print data, it holds the received intermediate print data in the storage device 62. Besides, when the printer 200 has received the reconfigurable data, it reconfigures the hardware region of the hardware circuit 20 oh the basis of the received reconfigurable data, and when it has completed the reconfiguration of the hardware region, it converts the intermediate print data of the storage device 62 into print data by the hardware circuit 20.

Thus, the intermediate print data are subjected to data processing by the hardware circuit 20 after waiting for the completion of the reconfiguration of the hardware region of the hardware circuit 20, and hence, the print data processing relevant to the print request can be executed comparatively reliably.

In this case, the printer 200 corresponds to print equipment in Aspect 22, or 109, the hardware circuit 20 corresponds to a circuit device in Aspect 22, or 109, and the intermediate print data correspond to data to-be-print-processed in Aspect 22, or 109.

Besides, in the second embodiment, the reconfigurable data have been formed containing the information for use in the configuration of the circuit which realizes the print data processing function specialized for the data processing of the intermediate print data, but they can also be formed containing information for use in the configuration of a circuit which realizes a print data processing function that sets the degree of parallelism in the case of the parallel data processing of a plurality of sets of intermediate print data or the parallel data processing of the parallel-processable parts of a single set of intermediate print data, without being restricted to the formation of the second embodiment.

Thus, the degree of parallelism of the printer 200 can be adjusted in the host terminal 100, so that the intermediate print data can be subjected to the data processing more efficiently.

In this case, the reconfigurable data correspond to circuit configuration information in Aspect 24, 43, 74, or 111, while the intermediate print data correspond to data to-be-print-processed in Aspect 24, 43, 74, or 111.

Besides, in the second embodiment, the reconfigurable data have been formed containing the information for use in the configuration of the circuit which realizes the print data processing function specialized for the data processing of the intermediate print data, but they can also be formed containing information for use in the configuration of a circuit which realizes a print data processing function to be borne by the printer 200 in a case where the host terminal 100 and the printer 200 share the data processing of the document data and the intermediate print data, without being restricted to the formation of the second embodiment.

Incidentally, the sharing processing can be performed, not only in the combination of the host terminal 100 and the printer 200, but also in the combination of any desired plurality of constituents among the host terminal 100, the printer 200, the printer management server 300 and the other devices.

Thus, the print data processing function suited to the sharing proportion of the printer 200 can be configured in the host terminal 100, so that the intermediate print data can be subjected to the data processing more efficiently.

In this case, the host terminal 100 corresponds to another device in Aspect 25, 44, 75, or 112, the printer 200 corresponds to print equipment in Aspect 25, 44, 75, or 112, and the reconfigurable data correspond to circuit configuration information in Aspect 25, 44, 75, or 112. Also, the document data and the intermediate print data correspond to data to-be-print-processed in Aspect 25, 44, 75, or 112.

Besides, in each of the first and second embodiments, the data set has been formed containing, not only the intermediate print data, but also the reconfigurable data or the reconfigurable instruction, but it can also be formed in another combination, without being restricted to the formation of the embodiment.

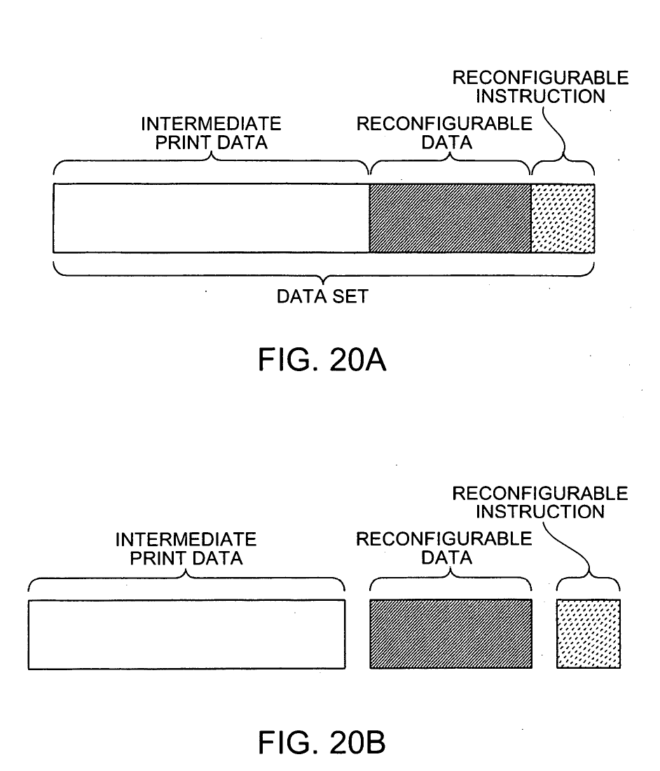

FIG. 20 is a diagram showing the data structures of the data set.

First, as shown in FIG. 20(a), a data set can be formed containing intermediate print data, reconfigurable data and a reconfigurable instruction.

Secondly, as shown in FIG. 20(b), intermediate print data, reconfigurable data and a reconfigurable instruction can be respectively formed as separate items.

Besides, although the configuration of the hardware circuit 20 has not been especially described in each of the first and second embodiments, an FPGA, a PLD (Programmable Logic Device), or a CPLD (Complex Programmable Logic Device), for example, can be utilized as the hardware circuit 20.

The “FPGA” is an LSI which can be programmed, and it is a circuit which can be simulated by feeding the design drawing of a microprocessor or an ASIC. The circuit is slower in operation and higher in price than a dedicated LSI, but it is faster than a circuit simulated by software.

The “CPLD” is a device in which a plurality of small-scale programmable logics each being called “simple PLD (SPLD)” such as PAL/GAL are integrated. A plurality of logic blocks (macrocells) are arranged on the single CPLD device, and the macrocells can be interconnected at high speed by a central general-purpose interconnection line. The CPLD has the merits that it is well suited to processing of wide and complicated gating and can perform the processing at high speed, and that the speed of the device can be predicted by fixing pins even before the initiation of a design. A designer can easily shorten a time period for inputting, simulation and verification, by using a CPLD development tool, so that a product can be put into the market fast, in addition to the low development cost thereof.

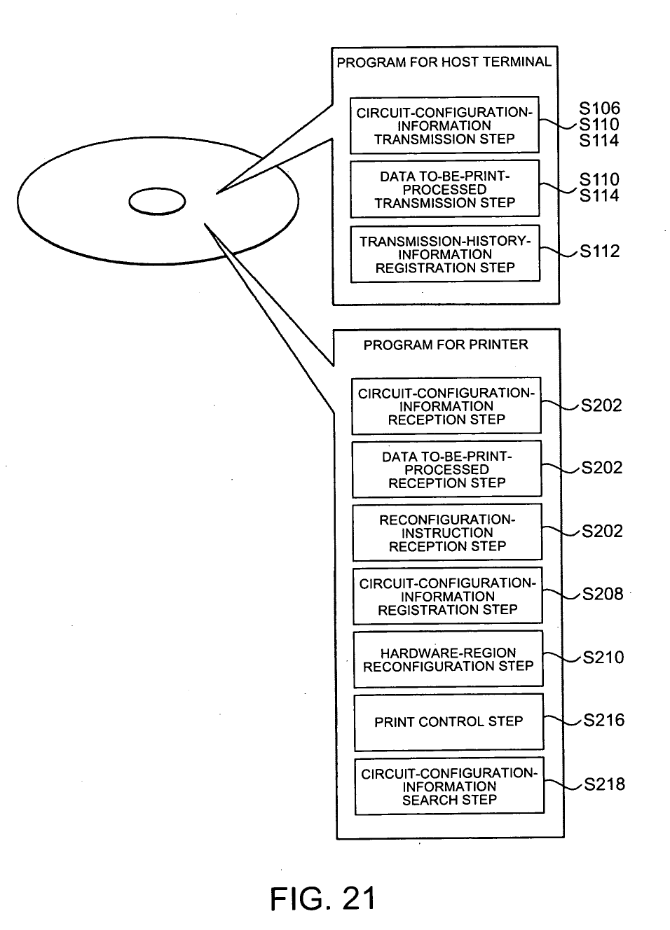

Besides, in the first embodiment, the processes illustrated in the flow charts of FIGS. 5 and 8 have been described as to the case where both are executed by running the control programs stored in the ROMs 32 and 52 beforehand, but they may well be executed in such a way that, as shown in FIG. 21, programs indicating the steps of these processes are loaded from a storage medium storing the programs therein, into the RAMs 34 and 54, without being restricted to the described case.

FIG. 21 is a diagram showing the storage medium and its data structures.

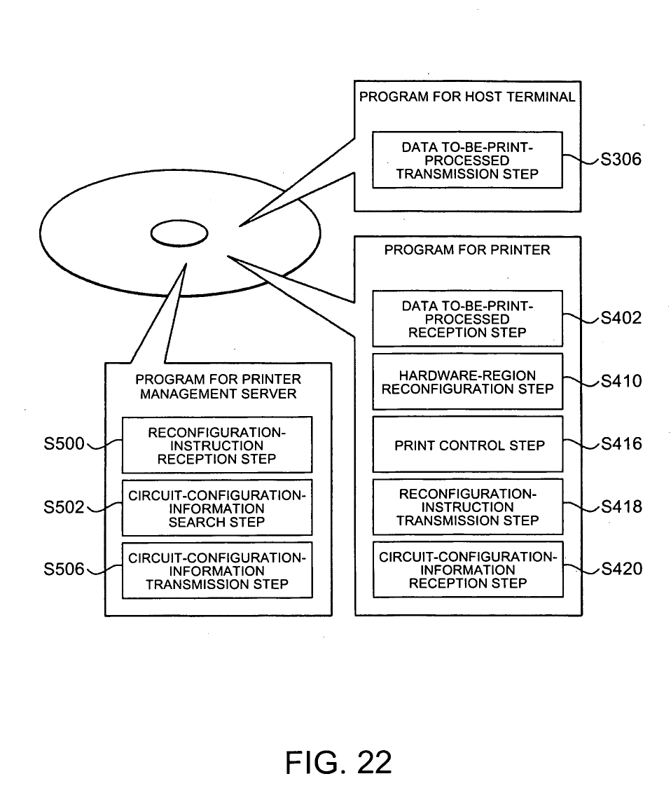

Besides, in the second embodiment, the processes illustrated in the flow charts of FIGS. 11, 12 and 14 have been described as to the case where all are executed by running the control programs stored in the ROMs 32, 52 and 72 beforehand, but they may well be executed in such a way that, as shown in FIG. 22, programs indicating the steps of these processes are loaded from a storage medium storing the programs therein, into the RAMs 34, 54 and 74, without being restricted to the described case.

FIG. 22 is a diagram showing the storage medium and its data structures.

Here, the “storage medium” is a semiconductor storage medium such as RAM or ROM, a magnetic storage type storage medium such as FD or HD, a storage medium of optical reading scheme such as CD, CDV, LD or DVD, or a storage medium of magnetic storage type/optical reading scheme such as MO, and it shall cover any sort of storage medium as long as it is a storage medium which is readable by a computer irrespective of electronic, magnetic, optical and the like reading methods.

Besides, in each of the first and second embodiments, each of the print system, print request apparatus, print-equipment management apparatus, print equipment, print-equipment management program as well as print control program, and print method according to the invention has been applied as to the case where printing is done by dynamically altering the hardware functions of the printer 200 in compliance with the print request from the host terminal 100, but it is also applicable to any other case within a scope not departing from the spirit of the invention, without being restricted to the described case.

1. ***A print system comprising:
a print request apparatus which makes a request for printing; and
print equipment communicably connected to the print request apparatus and which performs the printing in compliance with the print request from the print request apparatus, wherein:
said print request apparatus includes:
a circuit-configuration-information transmitter transmitting circuit configuration information for use in configuring a circuit which realizes a print data processing function to said print equipment in accordance with the print request; and
said print equipment includes a circuit device which has:
a rewritable hardware region;
a circuit-configuration-information receiver receiving the circuit configuration information; and
a hardware-region reconfigurer reconfiguring the hardware region on the basis of the circuit configuration information received by said circuit-configuration-information receiver.

2. A print system comprising:
a print request apparatus which makes a request for printing; and
print equipment communicably connected to the print request apparatus and which performs the printing in compliance with the print request from the print request apparatus, wherein:
said print request apparatus includes:
a circuit-configuration-information storage unit storing therein circuit configuration information for use in configuring a circuit which realizes a print data processing function;
a circuit-configuration-information transmitter transmitting the circuit configuration information of said circuit-configuration-information storage unit to said print equipment in accordance with the print request; and
a data-to-be-print-processed transmitter transmitting data to-be-print-processed to said print equipment in accordance with the print request; and
said print equipment includes:
a circuit device which has a rewritable hardware region;
a circuit-configuration-information receiver receiving the circuit configuration information;
a hardware-region reconfigurer reconfiguring the hardware region on the basis of the circuit configuration information received by said circuit-configuration-information receiver;
a data-to-be-print-processed receiver receiving the data to-be-print-processed; and
a print controller performing the printing on the basis of print-processed data subjected to data processing by said circuit device.

3. A print system comprising:
a print request apparatus which makes a request for printing; and
print equipment communicably connected to the print request apparatus and which performs the printing in compliance with the print request from the print request apparatus, wherein:
said print request apparatus includes:
a circuit-configuration-information storage unit storing therein circuit configuration information for use in configuring a circuit which realizes a print data processing function;
a circuit-configuration-information transmitter transmitting the circuit configuration information of said circuit-configuration-information storage unit to said print equipment in accordance with the print request; and
a data-to-be-print-processed transmitter transmitting data to-be-print-processed to said print equipment in accordance with the print request;
said print equipment includes:
a circuit device which has a rewritable hardware region;
a circuit-configuration-information receiver receiving the circuit configuration information;
a hardware-region reconfigurer reconfiguring the hardware region on the basis of the circuit configuration information received by said circuit-configuration-information receiver;
a data-to-be-print-processed receiver receiving the data to-be-print-processed; and
a print controller performing the printing on the basis of print-processed data subjected to data processing by said circuit device; and
said print controller subjects the data to-be-print-processed received by said data-to-be-print-processed receiver to the data processing by said circuit device after the reconfiguration by said hardware-region reconfigurer has been performed.

4. A print system as defined in claim 2, wherein:
said hardware-region reconfigurer transmits a predetermined notification to said print request apparatus when the reconfiguration of the hardware region has been completed; and
said data-to-be-print-processed transmitter transmits the data to-be-print-processed to said print equipment when the predetermined notification has been received.

5. A print system as defined in claim 2, wherein:
said print equipment further includes a data-to-be-print-processed holder holding therein the data to-be-print-processed received by said data-to-be-print-processed receiver, and said print equipment subjects the data to-be-print-processed held in said data-to-be-print-processed holder to the data processing by said circuit device when the reconfiguration by said hardware-region reconfigurer has been completed.

6. A print system as defined in claim 2, wherein:
said circuit-configuration-information transmitter transmits the circuit configuration information of said circuit-configuration-information storage unit to said print equipment when a request for printing has been inputted by an input interface.

7. A print system as defined in claim 2, wherein:
said circuit-configuration-information transmitter transmits the circuit configuration information of said circuit-configuration-information storage unit to said print equipment when settings concerning printing have been performed by an input interface.

8. A print system as defined in claim 2, wherein:
the circuit configuration information contains information for use in configuring a circuit which realizes a print data processing function specialized for subjecting the data to-be-print-processed to data processing.

9. A print system as defined in claim 2, wherein:
the circuit configuration information contains information for use in configuring a circuit which realizes a print data processing function that sets a degree of parallelism in at least one of:
a case where a plurality of sets of such data to-be-print-processed are subjected to data processing in parallel; and
a case where parallel-processable parts of a single set of such data to-be-print-processed are subjected to data processing in parallel.

10. A print system as defined in claim 9, wherein:
said print request apparatus further includes a status-information acquirer acquiring status information which indicates a scale of the hardware region, and a circuit-configuration-information updater setting the degree of parallelism of the circuit configuration information on the basis of the status information acquired by said status-information acquirer; and
said circuit-configuration-information transmitter transmits the circuit configuration information updated by said circuit-configuration-information updater to said print equipment.

11. A print system as defined in claim 2, wherein:
the circuit configuration information contains information for use in configuring a circuit which realizes a print data processing function that is to be borne by said print equipment in a case where said print equipment and another device share the data processing of the data to-be-print-processed.

12. A print system as defined in claim 11, wherein:
said print request apparatus further includes a status-information acquirer acquiring status information which indicates a processing load of said print equipment, and status information which indicates a processing load of said other device, and a circuit-configuration-information updater updating the circuit configuration information on the basis of the status information items acquired by said status-information acquirer; and
said circuit-configuration-information transmitter transmits the circuit configuration information updated by said circuit-configuration-information updater to said print equipment.

13. A print system as defined in claim 2, wherein:
said print request apparatus further includes a transmission-history-information register registering transmission history information which indicates a transmission history of the circuit configuration information transmitted to said print equipment in a transmission-history-information storage unit;
said circuit-configuration-information transmitter transmits a reconfiguration instruction containing identification information of the corresponding circuit configuration information to said print equipment when said print request apparatus has determined that the same circuit configuration information as that to be transmitted to said print equipment has already been transmitted to said print equipment based on the transmission history information of said transmission-history-information storage unit;
said print equipment further includes a circuit-configuration-information register registering the circuit configuration information received by said circuit-configuration-information receiver in second circuit-configuration-information storage unit, a reconfiguration-instruction receiver receiving the reconfiguration instruction, and a circuit-configuration-information searcher searching said second circuit-configuration-information storage unit for the corresponding circuit configuration information based on the identification information which is contained in the reconfiguration instruction received by said reconfiguration-instruction receiver; and
said hardware-region reconfigurer reconfigures the hardware region based on at least one of:
the circuit configuration information received by said circuit-configuration-information receiver; and
the circuit configuration information searched out by said circuit-configuration-information searcher.

14. A print system as defined in claim 2, wherein:
said print request apparatus further includes a circuit-configuration-information inquirer inquiring of said print equipment as to the circuit configuration information which said print equipment holds;
said circuit-configuration-information transmitter transmits a reconfiguration instruction containing identification information of the corresponding circuit configuration information to said print equipment when said print request apparatus has determined that the same circuit configuration information as that to be transmitted to said print equipment has already been transmitted to said print equipment based on a result of the inquiry of said circuit-configuration-information inquirer;
said print equipment further includes:
a circuit-configuration-information register registering the circuit configuration information received by said circuit-configuration-information receiver in second circuit-configuration-information storage unit;
a reconfiguration-instruction receiver receiving the reconfiguration instruction;
a circuit-configuration-information searcher searching said second circuit-configuration-information storage unit for the corresponding circuit configuration information based on the identification information which is contained in the reconfiguration instruction received by said reconfiguration-instruction receiver; and
a circuit-configuration-information replier replying presence or absence of the circuit configuration information to the inquiry from said print request apparatus based on registered contents of said second circuit-configuration-information storage unit; and
said hardware-region reconfigurer reconfigures the hardware region based on at least one of:
the circuit configuration information received by said circuit-configuration-information receiver; and
the circuit configuration information searched out by said circuit-configuration-information searcher.

15. A print system as defined in claim 2, wherein:
the circuit configuration information contains information for use in configuring the circuit which realizes the print data processing function, and information for use in configuring a circuit which realizes a print management function; and
said hardware-region reconfigurer reconfigures at least part of the hardware region based on the circuit configuration information.

16. A print system comprising:
a print request apparatus which makes a request for printing;
print equipment communicably connected to the print request apparatus and which performs the printing in compliance with the print request from the print request apparatus; and
a print-equipment management apparatus communicably connected to the print request apparatus and the print equipment and which manages a print data processing function, wherein:
said print-equipment management apparatus includes:
a circuit-configuration-information transmitter transmitting circuit configuration information for use in configuring a circuit which realizes the print data processing function to said print equipment in accordance with the print request; and
said print equipment includes:
a circuit device which has a rewritable hardware region;
a circuit-configuration-information receiver receiving the circuit configuration information; and
a hardware-region reconfigurer reconfiguring the hardware region based on the circuit configuration information received by said circuit-configuration-information receiver.

17. A print system comprising:
a print request apparatus which makes a request for printing;
print equipment communicably connected to the print request apparatus and which performs the printing in compliance with the print request from the print request apparatus; and
a print-equipment management apparatus communicably connected to the print request apparatus and the print equipment and which manages a print data processing function, wherein:
said print-equipment management apparatus includes:
a circuit-configuration-information storage unit storing therein circuit configuration information for use in configuring a circuit which realizes the print data processing function; and
a circuit-configuration-information transmitter transmitting the circuit configuration information of said circuit-configuration-information storage unit to said print equipment in accordance with the print request;
said print request apparatus includes:
a data-to-be-print-processed transmitter transmitting data to-be-print-processed to said print equipment in accordance with the print request; and
said print equipment includes a circuit device which has:
a rewritable hardware region;
a circuit-configuration-information receiver receiving the circuit configuration information;
a hardware-region reconfigurer reconfiguring the hardware region based on the circuit configuration information received by said circuit-configuration-information receiver;
a data-to-be-print-processed receiver receiving the data to-be-print-processed; and
a print controller performing the printing based on print-processed data subjected to data processing by said circuit device, wherein the data to-be-print-processed received by said data-to-be-print-processed receiver are subjected to the data processing by said circuit device after the reconfiguration by said hardware-region reconfigurer has been performed.

18. A print system comprising:
a print request apparatus which makes a request for printing;
print equipment communicably connected to the print request apparatus and which performs the printing in compliance with the print request from the print request apparatus; and
a print-equipment management apparatus communicably connected to the print request apparatus and the print equipment and which manages a print data processing function, wherein:
said print-equipment management apparatus includes:
a circuit-configuration-information storage unit storing therein circuit configuration information for use in configuring a circuit which realizes the print data processing function; and
a circuit-configuration-information transmitter transmitting the circuit configuration information of said circuit-configuration-information storage unit to said print equipment in accordance with the print request;
said print request apparatus includes:
a data-to-be-print-processed transmitter transmitting data to-be-print-processed to said print equipment in accordance with the print request;
said print equipment includes a circuit device which has:
a rewritable hardware region;
a circuit-configuration-information receiver receiving the circuit configuration information;
a hardware-region reconfigurer reconfiguring the hardware region based on the circuit configuration information received by said circuit-configuration-information receiver;
a data-to-be-print-processed receiver receiving the data to-be-print-processed; and
a print controller performing the printing based on print-processed data subjected to data processing by said circuit device; and
said print controller subjects the data to-be-print-processed received by said data-to-be-print-processed receiver to the data processing by said circuit device after the reconfiguration by said hardware-region reconfigurer has been performed.

19. A print system as defined in claim 17, wherein:
said print request apparatus further includes a reconfiguration-instruction transmitter transmitting a reconfiguration instruction which contains identification information of the circuit configuration information to said print-equipment management apparatus in accordance with the print request;
said print-equipment management apparatus further includes:
a reconfiguration-instruction receiver receiving the reconfiguration instruction; and
a circuit-configuration-information searcher searching said circuit-configuration-information storage unit for the corresponding circuit configuration information based on the identification information which is contained in the reconfiguration instruction received by said reconfiguration-instruction receiver; and
said circuit-configuration-information transmitter transmits the circuit configuration information searched out by said circuit-configuration-information searcher to said print equipment.

20. A print system as defined in claim 17, wherein:
said data-to-be-print-processed transmitter transmits the identification information of the circuit configuration information as is contained in the data to-be-print-processed to said print equipment;
said print equipment further includes:
a reconfiguration-instruction transmitter transmitting to said print-equipment management apparatus the reconfiguration instruction which contains the identification information acquired from the data to-be-print-processed received by said data-to-be-print-processed receiver;
said print-equipment management apparatus further includes:
a reconfiguration-instruction receiver receiving the reconfiguration instruction; and
a circuit-configuration-information searcher searching said circuit-configuration-information storage unit for the corresponding circuit configuration information based on the identification information which is contained in the reconfiguration instruction received by said reconfiguration-instruction receiver; and
said circuit-configuration-information transmitter transmits the circuit configuration information searched out by said circuit-configuration-information searcher to said print equipment.

21. A print system as defined in claim 17, wherein:
said hardware-region reconfigurer transmits a predetermined notification to said print request apparatus when the reconfiguration of the hardware region has been completed; and
said data-to-be-print-processed transmitter transmits the data to-be-print-processed to said print equipment when the predetermined notification has been received.

22. A print system as defined in claim 17, wherein:
said print equipment further includes a data-to-be-print-processed holder holding therein the data to-be-print-processed received by said data-to-be-print-processed receiver, and said print equipment subjects the data to-be-print-processed held in said data-to-be-print-processed holder to the data processing by said circuit device when the reconfiguration by said hardware-region reconfigurer has been completed.

23. A print system as defined in claim 17, wherein:
the circuit configuration information contains information for use in configuring a circuit which realizes a print data processing function specialized for subjecting the data to-be-print-processed to data processing.

24. A print system as defined in claim 17, wherein:
the circuit configuration information contains information for use in configuring a circuit which realizes a print data processing function that sets a degree of parallelism in at least one of:
a case where a plurality of sets of such data to-be-print-processed are subjected to data processing in parallel; and
a case where parallel-processable parts of a single set of such data to-be-print-processed are subjected to data processing in parallel.

25. A print system as defined in claim 17, wherein:
the circuit configuration information contains information for use in configuring a circuit which realizes a print data processing function that is to be borne by said print equipment in a case where said print equipment and another device share the data processing of the data to-be-print-processed.

26. A print request apparatus which is communicably connected with print equipment that performs printing in compliance with a print request, comprising:
a circuit-configuration-information transmitter transmitting circuit configuration information for use in configuring a circuit which realizes a print data processing function to said print equipment in accordance with the print request.

27. A print-equipment management apparatus which is communicably connected with print equipment that performs printing in compliance with a print request from a print request apparatus, comprising:
a circuit-configuration-information transmitter transmitting circuit configuration information for use in configuring a circuit which realizes a print data processing function to said print equipment in accordance with the print request.

28. Print equipment which is communicably connected with a print request apparatus that makes a request for printing, comprising:
a circuit device which has a rewritable hardware region;
a circuit-configuration-information receiver receiving circuit configuration information for use in configuring a circuit which realizes a print data processing function; and
a hardware-region reconfigurer reconfiguring the hardware region based on the circuit configuration information received by said circuit-configuration-information receiver.

29. A print-equipment management program which is run by a computer that is communicably connected with print equipment for performing printing in compliance with a print request, and that operates as a print request apparatus, comprising:
a program for causing the computer to execute processing which includes a circuit-configuration-information transmission step of transmitting circuit configuration information for use in configuring a circuit that realizes a print data processing function to the print equipment in accordance with the print request.

30. A print-equipment management program which is run by a computer that is communicably connected with print equipment for performing printing in compliance with a print request from a print request apparatus, and that operates as a print-equipment management apparatus, comprising:
a program for causing the computer to execute processing which includes a circuit-configuration-information transmission step of transmitting circuit configuration information for use in configuring a circuit that realizes a print data processing function to the print equipment in accordance with the print request.

31. A print control program which is run by a computer that is communicably connected with a print request apparatus for making a print request, that includes a circuit device having a rewritable hardware region, and that operates as print equipment, comprising:
a program for causing the computer to execute processing which includes:
a circuit-configuration-information reception step of receiving circuit configuration information for use in configuring a circuit that realizes a print data processing function; and
a hardware-region reconfiguration step of reconfiguring the hardware region based on the circuit configuration information received at said circuit-configuration-information reception step.

32. A print method wherein a print request apparatus which makes a request for printing, and print equipment which includes a circuit device having a rewritable hardware region and which performs the printing in compliance with the print request from the print request apparatus are connected in communicable fashion, so as to perform the printing, comprising:
a circuit-configuration-information transmission step of transmitting circuit configuration information for use in configuring a circuit which realizes a print data processing function to the print equipment in accordance with the print request, said circuit-configuration-information transmission step being implemented by the print request apparatus;
a circuit-configuration-information reception step of receiving the circuit configuration information; and
a hardware-region reconfiguration step of reconfiguring the hardware region based on the circuit configuration information received at said circuit-configuration-information reception step;
wherein said circuit-configuration-information reception step and said hardware-region reconfiguration step are implemented by the print equipment.

33. A print method wherein a print request apparatus which makes a request for printing, print equipment which includes a circuit device having a rewritable hardware region and which performs the printing in compliance with the print request from the print request apparatus, and a print-equipment management apparatus which manages a print data processing function are connected in communicable fashion, so as to perform the printing, comprising:
a circuit-configuration-information transmission step of transmitting circuit configuration information for use in configuring a circuit which realizes the print data processing function to the print equipment in accordance with the print request, said circuit-configuration-information transmission step being implemented by the print-equipment management apparatus;
a circuit-configuration-information reception step of receiving the circuit configuration information; and
a hardware-region reconfiguration step of reconfiguring the hardware region based on the circuit configuration information received at said circuit-configuration-information reception step;
wherein said circuit-configuration-information reception step and said hardware-region reconfiguration step being implemented by the print equipment.
